(19) United States
(12) Patent Application Publication
(10) Pub. No.: US 2003/0216871 A1
(43) Pub. Date: Nov. 20, 2003

(54) Calculating a characteristic property of a molecule by correlation analysis

(76) Inventors: Artem Tcherkassov, Vancouver (CA); Ridong Chen, Naperville, IL (US)

Correspondence Address: Philip D. Reilly, Morrison & Foerster LLP, 755 Page Mill Road, Palo Alto, CA, 94304-1018, US

(21) Appl. No.: 10/208,074

(22) Filed: Jul. 29, 2002

Related U.S. Application Data
(60) Provisional application No. 60/308,666, filed on Jul. 31, 2001.

(51) Int. Cl. G06F 19/00; G01N 31/00

(52) U.S. Cl. 702/27

(57) ABSTRACT

Methods, including computer implemented methods for calculating a characteristic property of a molecule from the 3D-structure of the molecule by correlation analysis, in which the characteristic property is equal to a contribution from the substituent parts of the molecule and a contribution from some measured property of the molecule such as the hydrophobicity and the contribution to the characteristic property from substituent parts of the molecule is equal to a function of the distance of the substituent part to a reaction center multiplied by a weight factor and substantially the same functional form of the distance function is used for calculating the contribution for each substituent part.

### CROSS-REFERENCE TO RELATED APPLICATIONS.

This application claims the benefit of U.S. provisional application No. 60/308,666, filed Jul. 31, 2001, with inventors Artem Tcherkassov and Ridong Chen, which application is incorporated herein by reference. This application is related to an application filed on the same date, with the same inventors, titled, “Calculating a Biological Characteristic Property of a Molecule By Correlation Analysis,” with attorney docket number 53260-20001.00, which application is incorporated herein by reference.

### BACKGROUND

The elucidation of the relationships between structure and activity of molecules is one of the major challenges in the chemical and pharmaceutical sciences. One approach to this problem is to apply quantitative structure-activity relationships (“QSAR”), which is a rapidly growing area, integrating methods of modern chemistry, biochemistry, pharmacology, molecular modeling, proteomics, and bio- and chem- informatics. In QSAR modeling, the activity of a molecule is estimated using the substituent parts of the molecule and the observed activity of molecules with similar or analogous structural motifs.

Application of conventional methods of QSAR have allowed interpretation of reactivity and bioactivity data and physico-chemical properties of molecules. Correlation analysis, which in part is based on the principles of linearity of free energy relationships (“LFER”), is one method that has proved fruitful in this approach. Conventional correlation analysis is described in, for example, Hansch, C.; et al. Substituents Constants for Correlation Analysis in Chemistry and Biology; Wiley—Interscience: N.Y., 1979; Wells, P. R. Linear Free Energy Relationships; Academic Press: London, 1968; Chapman, N. B., Shorter, J. Correlation Analysis in Chemistry; Plenum Press, N.Y. 1978; and R. W. Parr, et al. Density-functional theory of atoms and molecules. Oxford University Press, N.Y., 1989.

Conventional correlation analysis calculates the activity of a molecule as the sum of contributions from different atoms or groups of atoms in a molecule but does not take account of the 3D-structure of the molecule and separates the contributions from each atom or group of atoms into polar, steric, inductive and resonance effects.

Quantitative description of polar influence of substituents first became possible within the framework of the approach developed by Hammett on the basis of the dissociation constants of substituted benzoic acids. The difference between the logarithms of dissociation constant K of substituted benzoic acid and the corresponding K⁰ of unsubstituted standard compound has been expressed by empirical equation:

$$log \frac{K}{{K}^{0}} = p σ \qquad ( 1 )$$

in which two new quantities have been introduced: σ is universal constant specific for a substituent in the benzene ring and ρ is reaction series constant reflecting the sensitivity of the reaction center to variation of substituent influence.

Later, the Hammett equation was modified many times, but the vast majority of these modifications related to the chemistry of aromatic compounds. For the series of aliphatic compounds, the Hammett relation, as a rule, did not hold. Taft suggested that in this case the steric substituent effects are significant and should be separated as:

$$log \frac{K}{{K}^{0}} = ρ {\sum }_{i} {σ}^{*} + δ {\sum }_{i} {E}_{s} \qquad ( 2 )$$

where σ* is a substituent constant depending only on the inductive influence of the substituent, Eₛ is the substituent constant reflecting the steric effect of the substituent and δ is a reaction series constant reflecting the sensitivity of the reaction center to variations of substituent steric influence. Taft's inductive and steric constants are among the most reliable and widespread substituent parameters used in conventional QSAR.

A large number of polar and steric substituent constants have been determined, and these constants are used in many different QSAR schemes that are used for analysis of molecular reactivity, bioactivity, and physicochemical properties and reaction mechanisms studies.

In terms of mechanism of action, the steric effect is believed to be due to a variety of factors including an increase of the bulk of a substituent leading to the mechanical shielding of the reaction center from an attacking reagent (steric hindrance of motions), an increase of steric repulsion in a transition state (steric strain) of a reaction, and to steric inhibition of solvation. Thus, the methods of calculation of substituents steric constants usually operate by different descriptors of effective atomic, group or molecular sizes. For the inductive effect, there is no unanimously opinion as to the mechanism of action. The inductive effect includes polar electrostatic interactions between charged parts (atoms) of a molecule and polarization of bonds. The resonance effect is attributed to stabilization of a system (molecule, transition state, etc.) occurring due to the realization of multiple electronic states (resonance configurations).

Although conventional QSAR methods have proved useful in elucidating structure activity relationships and predicting the activity of molecules based on their structural motifs, conventional QSAR relies on an ad hoc mixture of contributions from polar, inductive, steric and resonance effects, each of which may be treated in a different manner depending on the application. In addition, conventional QSAR does not fully take into account the three dimensional structure of a molecule and thus may not include useful and important structural information contributing to the activity of a molecule.

### SUMMARY

The inventors have identified new methods that treat the contributions from substituent parts of a molecule in a straightforward, consistent matter and take into account the full 3-D structure of a molecule when calculating the activity.

In this patent, we describe various methods that may be used to calculate the activity of a molecule based on its 3-D structure and give examples of the application of these methods demonstrating the utility of the methods. In this section, we summarize various aspects of the methods described in this patent and below in the Detailed Description section we present a more comprehensive description of these methods, their uses and implementations.

One of the methods described in this patent is a method for calculating a characteristic property of a molecule that includes one or more substituent parts, where the method includes the steps of (i) selecting one or more of the substituent parts as contributing substituent parts; (ii) for each of the contributing substituent parts, calculating the distance from the substituent part to a reaction center; (iii) for each of the contributing substituent parts, calculating the contribution of that substituent part to the characteristic property of the molecule; and (iv) calculating the characteristic property of the molecule by summing the contributions from the contributing substituent parts of the molecule plus a contribution equal to a measured property of the molecule multiplied by a weight factor. In this method, the contribution from a substituent part is equal to a function of the distance of the substituent part to the reaction center multiplied by a weight factor for the substituent part, and the same or substantially the same functional form for the function of the distance is used to calculate the contribution from each of the contributing substituent parts.

In one version, the methods described in this patent, the methods may be used to calculate characteristic properties that are chemical characteristic properties. Examples of chemical properties that may be calculated using the methods described in this patent include but are not limited to pKa, reaction rate constants, equilibrium constants, solubility, ionization potentials, atomization energy, evaporation energy, and bond energy. In another version of the methods described in this patent, the methods may be used to calculate a characteristic property that is a property related to the free energy of the molecule.

In one version of the methods described in this patent, the methods may be used to calculate the characteristic property of organic molecules, inorganic molecules, neutral molecules, radicals, anions, cations, ionic salts, metallo-organic compounds, or coordination compounds.

Regarding the substituent parts of the molecule, in one version of the methods described in this patent, the substituent parts of the molecule may be atoms contained in the molecule or groups of connected atoms contained in the molecule.

Regarding the reaction center, generally the reaction center may be any point in space. In one version of the methods described in this patent, the reaction center may be a substituent part of the molecule which may be an atom contained in the molecule or may be a group of connected atoms contained in the molecule.

Regarding the contributing substituent parts of the molecule, generally any number of the substituent parts may make up the contributing substituent parts. In one version of the methods described in this patent, the contributing substituent parts include all substituent parts of the molecule except one. In another version of the methods described in this patent, the contributing substituent parts include all substituent parts in the molecule except the substituent part that is the reaction center.

Regarding the function of the distance used in the calculation of the contribution from a substituent part, generally this function may be of any functional form provided that the same or substantially the same functional form is used for calculating the contribution for each substituent part. In one version of the methods described in this patent, the function of the distance is an inverse function of the distance. In another version, the function of the distance goes as the inverse of the square of the distance. In another version, the function of the distance goes as the inverse of the cube of the distance. In another version, the function of the distance goes as the sum of the inverse of the square of the distance and the inverse of the cube of the distance.

Regarding the weight factor used in the calculation of the contribution from a substituent part, generally the weight factor may be calculated as a regression coefficient for a multivariate regression analysis calculated for a series of molecules. In one version of the methods described in this patent, the dependent variables for the multivariate regression analysis are the values of the characteristic property for the series of molecules and the independent variables are the distant dependent contribution for each type of substituent part present in the series of molecules. For a particular molecule in the series of molecules, the value of the independent variable corresponding to a particular type of substituent part is equal to a sum of the function of the distance from the reaction center to the particular substituent part, where the sum is over all occurrences of that particular molecule. In one version of the methods described in this patent, the series of molecules include molecules that are analogs of the molecule for which the characteristic property is being calculated. In another version of the methods described in this patent, the series of molecules include molecules which include an atom or group of atoms that is the same as the reaction center of the molecule for which the characteristic property is being calculated.

Regarding how the reaction center may be selected, in one version of the methods described in this patent, the reaction center is selected by performing a multivariable regression analysis for two or more different possible reaction centers, calculating a characteristic of the multivariable regression analysis for each reaction center, and determining which reaction center corresponds to the multivariable regression analysis characteristic that satisfies a predetermined criteria. In one version of the methods described in this patent, the multivariable regression analysis characteristic is the global regression coefficient of the regression analysis and the predetermined criteria selects the reaction center with the highest global regression coefficient. In another version of the methods described in this patent, the multivariable regression analysis characteristic is the global standard error of the regression analysis and the predetermined criteria selects the reaction center with the lowest global standard error.

Regarding the measured property of the molecule the weighted contribution of which is included in the calculation of the characteristic property, generally the measured property of the molecule can be any property of the molecule that can be measured. In one version of the methods described in this patent, the measured property may be the hydrophobicity of the molecule. In one version, the value of the hydrophobicity is equal to the log of the octanol/water partition coefficient. In one version of the methods described in this patent, the weight factor used in the calculation of the contribution from the measured property is calculated as a regression coefficient for a multivariate regression analysis calculated for a series of molecules.

Another of the methods described in this patent is a method for calculating the pKa of a molecule that includes one or more substituent parts, where the method includes the steps of (i) selecting one or more of the substituent parts as contributing substituent parts; (ii) for each of the contributing substituent parts, calculating the distance from the substituent part to a reaction center; (iii) for each of the contributing substituent parts, calculating the contribution of that substituent part to the characteristic property of the molecule; and (iv) calculating the characteristic property of the molecule by summing the contributions from the contributing substituent parts of the molecule. In this method, the types of molecules for which pKa may be calculated, the nature of the substituent and contributing substituent parts, the nature of the reaction center, and the calculation of the contribution from a substituent part including the form of the distant dependent function and the calculation of the weight factor may all be as described above.

In addition to the methods describe above, other methods, devices, and compositions described in this patent include a computing device configured to calculate characteristic properties of molecules by one of the methods described in this patent; a computer-readable article of manufacture containing a computer program capable of being implemented in a computer to carry out one or more of the methods described in this patent; a molecule for which the structure was identified to include one or more substituent parts chosen to affect a characteristic property of the molecule, where the effect of the one or more substituent parts is calculated by one or more of the methods described in this patent; and a molecule synthesized after determining a likely characteristic property of the molecule, where the effect of the characteristic property of the molecule is calculated by one or more of the methods described in this patent.

### BRIEF DESCRIPTION OF THE SEVERAL VIEWS OF THE DRAWING(S)

FIG. 1. Predicted vs. Experimental Activity of Mitomycins, Expressed as log (1/C) Against Human Tumor Cells in Culture.

FIG. 2. Predicted vs. Experimental Dissociation Constants of Molecules Containing a Carboxylic Group

FIG. 3. Predicted vs. Experimental pKa parameters of Organic Amines

### DETAILED DESCRIPTION

The inventors have discovered new methods for calculating a characteristic property of a molecule by correlation analysis and in this section, we describe (1) specific aspects of the methods, (2) implementation of the methods in a computer system, (3) general uses of the methods, and (4) examples of results calculated using the methods.

Correlation Analysis Methods

The methods described in this patent may be used to calculate a characteristic property of a molecule. The characteristic properties that may be calculated and the classes of molecule to which the method may be applied are described in detail below. In the method, the molecule is conceptually separated into substituent parts, a reaction center is identified, and the distance of the substituent parts from the reaction center is calculated. The contribution from each substituent part is then calculated as a weight factor multiplied by a function of the distance of the substituent part from the reaction center. We describe in detail below the various forms of distant dependent function that may be used and the various methods that may be used for identifying the reaction center and calculating the weight factor.

In addition to the contributions of the substituent parts as described above, the characteristic property includes a contribution from one or more measured properties of the molecule. The contribution from a measured property is equal to the value of the measured property multiplied by a weight factor. We describe in detail below measured properties of the molecule that may be used and methods that may be used for calculating the weight factor.

In terms of an equation, the method may be written as

$$CP = {\sum }_{j = 1}^{n} {W}_{j} f ( {r}_{j} ) + {\sum }_{k = 1}^{m} {w}_{k} M {P}_{k} \qquad ( 3 )$$

where CP is the value of the characteristic property of the molecule, the sum over j is a sum over the substituent parts of the molecule, Wⱼ is the weight factor associated with substituent j, rⱼ is the distance from substituent j to the reaction center, f(r₁) is a function of the distance from substituent j to the reaction center, the sum over k is a sum over the measure properties of the molecule, wₖ is the weight factor associated with the measured property k, and MPₖ is the value of measured property k.

In one version of the methods described in this patent, CP is the value of the characteristic property measured relative to some constant value, which in this patent we denote by CP⁰. In one version, CP⁰ may be the value of the characteristic property for a standard compound. In another version, CP⁰ may be the value of the intercept of a multiple regression analysis, as will be described in detail elsewhere in this patent.

As will be described in detail below, generally any characteristic property of a molecule, including chemical and biological properties, may be calculated using the method outlined above. In addition to this general method, which we will refer to in this patent as the “general method,” this patent describes certain chemical characteristic properties that may be calculated using the method outlined above but without including the contribution from the measured properties, i.e., without including the second term on the right hand side of equation 3. In this patent, unless the context make obvious otherwise, we will refer to this method used to calculate certain chemical characteristic properties as the “chemical characteristics method” Unless the context makes obvious otherwise, a reference in this patent to the “methods described in this patent,” or some such language refers to both the general method including the measured properties term and the chemical characteristics method that does not include the measured properties term.

Molecules for Which Characteristic Properties May be Calculated

Generally, the methods (both general method and chemical characteristics method) of the invention may be used to calculate the characteristic properties of any molecule or molecular fragment, including but not limited to organic molecules, inorganic molecules, neutral molecules, radicals, anions, cations, ionic salts and metallo-organic and coordination compounds. In one version of the methods described in this patent, the methods may be used to calculate the characteristic properties of peptides, proteins, and non-peptide small molecules. The methods described in this patent may be used to calculate the characteristic properties of molecules of arbitrary size. In another version of the methods described in this patent, the methods may be used to calculate characteristic properties for aniline mustards, nonsteroidal anti-inflammatory drugs (NSAID), and mytomycins. In another version of the methods described in this patent, the methods may be used to calculate characteristic properties for amines, or carboxylic acids.

As will be described in detail below, the methods described in this patent include a function of the distances of substituent parts from a reaction center. To facilitate this calculation, the 3D structure of the molecule may be obtained by any method capable of providing the 3D structure, including, but not limited to theoretical modeling calculations, experimental, x-ray diffraction data, and other experimental data, such as NMR data. In one version of the methods described in this patent, the 3D structure is obtained by using the Hyperchem software package available from HyperCube, Inc.

Characteristic Properties That May be Calculated

Generally, any characteristic properties that can be measured may be calculated by the general methods described in this patent, including but not limited to chemical, physical, and biological characteristics properties.

Examples of chemical characteristic properties that may be calculated by this general method include, but are not limited to, pKa, any property related to the free energy of the molecule, reaction rate constants, equilibrium constants, solubility, ionization potentials, atomization energy, evaporation energy, and bond energy. In one version, adiabatic ionization energies or vertical ionization energies can be calculated. Physical properties that can be calculated by this general method include, but are not limited to melting temperature, boiling temperature, and sublimation temperature.

Examples of biological characteristic properties are described in detail in the patent application filed on the same date as the application for this patent, with the same inventors, titled, “Calculating a Biological Characteristic Property of a Molecule By Correlation Analysis.”

Methods of Calculating Characteristic Property

In one version of the methods described in this patent, the characteristic property is calculated as the sum of contributions from substituent parts of the molecule. As described below in detail, not all substituent parts of the molecule need be included in this calculation. In this version the characteristic property is calculated as equal to a sum of contributions from each contributing substituent part and the contribution of each substituent part is substantially equal to the product of a weight factor multiplied by a function of the distance of the substituent part to a reaction center.

This version of the methods described in this patent is shown in equation form in Equation 3 above.

Substituent Parts

As part of the methods described in this patent, a molecule is conceptually separated into substituent parts and the characteristic property is calculated as the sum of contribution from some number of the substituent parts. The substituent parts contributing to the calculation of the characteristic property are referred to in this patent as the “contributing substituent parts.” Generally, the substituent parts of a molecule may be any portion of the molecule, including but not limited to, individual atoms in the molecule, groups of atoms in the molecule, individual portions of high electron density in the molecule (for example, lone pairs). In one version of the methods described in this patent, the substituent parts are individual atoms or groups of atoms. A person well versed with the use of correlation analysis to calculate the properties of molecules will understand how to identify atoms and groups that may be used as substituent parts. Generally, however, any portion of the molecule, including atoms and groups may be used as substituent parts.

Non-limiting examples of atoms and groups that may be used as substituent parts include all possible atoms, alkyl groups, alkenyl groups, aromatic groups, metallo-organic groups, and hetero-aromatic groups. A person familiar with the technology of correlation analysis will be able in a straight forward manner to identify other groups that may be used.

Generally, any number of the substituent parts may be contributing substituent parts. In one version, all of the substituent parts except one are contributing substituent parts. In another version in which the reaction center is a substituent part, all of the substituent parts except the reaction center are contributing substituent parts. In a version in which the contribution of a substituent part diminishes as the distance to the reaction center increases, substituent parts distant from the reaction center may make insignificant contribution to the calculated property and may be omitted from the contributing substituent parts. Such distant substituent parts may, however, also be included in the contributing substituent parts.

Reaction Center

In the methods described in this patent, having determined the contributing substituent parts of the molecule, one then calculates the distance from the contributing substituent parts to a reaction center. Generally, the reaction center can be any point in space. As will be described below in detail, in one version of the methods described in this patent an optimal reaction center may be identified by varying the position of the reaction center, calculating the weight factors for the substituent parts by multivariable regression analysis using the various reaction centers, and identifying the optimal reaction center as that center yielding the best regression analysis fit. In one version, the reaction center may be identified as one of the substituent parts of the molecule.

Functional Forms

The inventors have discovered that it is possible to take into account the structure of a molecule when calculating a characteristic property if the contribution of each contributing substituent part is proportional to a function of the distance of the substituent part to the reaction center. The function of the distance used to calculate the contribution for each substituent has the same or substantially the same functional form; the function of the distance may, however, generally be of any functional form. By substantially the same functional form, we mean a functional form that is not identical to the other functional forms but for which the difference in functional form does not qualitatively affect the results of the calculations. As a nonlimiting example, functional forms of 1/r² and 1/^{r(2-δ) may be considered substantially the same for small δ.}

In one version of the methods described in this patent, the functional form is a function of the inverse of the distance. In another version, the functional form goes as the inverse of the square of the distance (i.e., f(r) proportional to 1/r²). In another version, the functional form goes as the inverse of the cube of the distance (i.e., f(r) proportional to 1/r³). In another version, the functional form goes as 1/r²+1/r³.

In the 1/r² version, for example, equation (3) becomes:

$$CP = {\sum }_{j = 1}^{n} \frac{{W}_{j}}{{r}_{j}^{2}}$$

Calculation of the Weight Factors

As part of the methods described in this patent, the contribution to the characteristic property of a molecule by a substituent part is given by a function of the distance of that substituent part from a reaction center multiplied by a weight factor. Generally the weight factor may be calculated as a regression coefficient for a multivariate regression analysis calculated for a series of molecules. Below we describe one specific version of the methods that may be used to calculate the weight factors, but first we describe in more general terms methods that may be used. A description of the implementation of multivariate regression analysis may be found in for example Essentials of Statistics, Stephen A. Book, New York, McGraw Hill, 1978, page 315 et seq.

In one version of the methods described in this patent, the dependent variables for the multivariate regression analysis are the values of the characteristic property for the series of molecules and the independent variables are the distant dependent contribution for each type of substituent part present in the series of molecules. For a particular molecule in the series of molecules, the value of the independent variable corresponding to a particular type of substituent part is equal to a sum of the function of the distance from the reaction center to the particular substituent part, where the sum is over all occurrences of that particular substituent part. In one version of the methods described in this patent, the series of molecules include molecules that are analogs of the molecule for which the characteristic property is being calculated. In another version of the methods described in this patent, the series of molecules include molecules which include an atom or group of atoms that is the same as the reaction center of the molecule for which the characteristic property is being calculated.

One specific example of the multivariable regression analysis that may be used to calculate the weight factors is as follows. This example calculates the weight factors for a version of the methods described in this patent in which the function of the distance used in calculating the contribution of the substituent parts goes as one over the inverse of the distance. In a more general version of the methods described in this patent in which the function of the distance may be any function, f(r), the following example will still apply except that the R-matrix contains terms of the form

$${\sum }_{k} f ( {r}_{rc - {m}_{k}} )$$

rather than

$${\sum }_{k} \frac{1}{{r}_{rc - {m}_{k}}^{2}} .$$

This example is presented in three steps: first, calculation of the geometries of the series of molecules used to calculate the weights; second, the calculations of the “R-matrix;” and third, the multivariable regression analysis, also called the partial least squares analysis, used to calculate the weights as the regression coefficients.

1. Input. Structural files for optimized geometries of molecules of reaction series are prepared, where each contributing substituent part is specified with its number and 3 spatial coordinates.

If a reaction series contains M molecules, then the input of M structural files should be prepared. For each molecule j, its, reaction center (rcⱼ) is specified by placing the corresponding atomic number into [rcₗ, . . . , rcⱼ, . . . , rc_{M}]-vector.

2. R-Matrix. The next step of the procedure is composition of the R-matrix containing sums of the

$${\sum }_{k} \frac{1}{{r}_{rc - {m}_{k}}^{2}}$$

terms, related to certain types of substituent parts.

When there are K types of substituent parts present in M molecules of the reaction series, the [M×K] R-matrix is formed. For each structural file the program sorts the atoms according to specified types of substituent parts and calculates the sums

$${\sum }_{k} \frac{1}{{r}_{rc - {m}_{k}}^{2}} ,$$

where r is the direct distance between substituent parts of m-type in molecule j and the reaction center and k sums over the substituent parts of type m in the molecule j:

$$R = [ \begin{matrix}{( {\sum }_{k} \frac{1}{{r}_{rc - {m}_{k}}^{2}} )}_{1 , 1} {( {\sum }_{k} \frac{1}{{r}_{rc - {m}_{k}}^{2}} )}_{1 , 2} ⋯ {( {\sum }_{k} \frac{1}{{r}_{rc - {m}_{k}}^{2}} )}_{1 , K} \\ … \\ {( {\sum }_{k} \frac{1}{{r}_{rc - {m}_{k}}^{2}} )}_{j , 1} {( {\sum }_{k} \frac{1}{{r}_{rc - {m}_{k}}^{2}} )}_{j , 2} ⋯ {( {\sum }_{k} \frac{1}{{r}_{rc - {m}_{k}}^{2}} )}_{j , K} \\ … \\ {( {\sum }_{k} \frac{1}{{r}_{rc - {m}_{k}}^{2}} )}_{M , 1} {( {\sum }_{k} \frac{1}{{r}_{rc - {m}_{k}}^{2}} )}_{M , 2} ⋯ {( {\sum }_{k} \frac{1}{{r}_{rc - {m}_{k}}^{2}} )}_{M , K}\end{matrix} ]$$

In the absence of contributing substituent parts of m-type in the molecule n, the corresponding matrix element is set equal to 0:

3. Partial Least Square (PLS)-analysis. The final step in this procedure is estimation whether the dataset can be treated as set dependent parameters of multiparameter regression with an intercept equal to CP⁰. For example, when the method of the invention is applied to free energy (ΔG is the free energy measured relative to some standard free energy G⁰), the experimental parameters of free energy changes are taken as the vector ΔG:

$$Δ G = [ \begin{matrix}Δ {G}_{1} \\ Δ {G}_{2} \\ ⋯ \\ Δ {G}_{M}\end{matrix} ] ,$$

the equation can be written in matrix notation as the following:

R_{g}=ΔG

where g is solution vector

$$[ \begin{matrix}{g}_{1} \\ {g}_{2} \\ … \\ {g}_{K}\end{matrix} ] ,$$

containing K values of what will be the weight

factors (Wⱼ) which here are designated gᵢ, corresponding to all types of contributing substituent parts.

When M>K (i.e. the number of molecules in reaction series is greater then the number of types of contributing substituent parts) the system is consistent and R_{g}=ΔG can be solved.

An approximate solution of equation can be achieved by multivariable regression, when the columns of R-matrix are considered as sets of independent variables and set ΔG values as dependent parameters. If such regression can be estimated with high accuracy, its linear coefficients can be taken as the weight factors, corresponding to the types of contributing substituent parts.

Additional Measured Properties That May Contribute to the Calculated Characteristic Property and Calculation of Weights for the Additional Measured Properties

As presented in Equation 3 above and the supporting description, in one aspect of the methods described in this patent, the characteristic property is calculated as a contribution from the contributing substituent parts plus a contribution from one or more measured properties of the molecule. In one version of these methods, there is a contribution from one measured property of the molecule. Generally, any property of the molecule may be included as a measured property. Properties that may be measured properties include but are not limited to biological properties, chemical properties, and physical properties of the molecule. In one version, the hydrophobicity of the molecule is one measured property that may be used. In one version, the hydrophobicity may be calculated as the logarithm of the octanol-8/water partition coefficient.

Implementation of the Methods

The methods described in this patent may be implemented using any device capable of implementing the methods. Examples of devices that may be used include but are not limited to electronic computational devices, including computers of all types. When the methods described in this patent are implemented in a computer, the computer program that may be used to configure the computer to carry out the steps of the methods may be contained in any computer readable medium capable of containing the computer program. Examples of computer readable medium that may be used include but are not limited to diskettes, CD-ROMs, DVDs, ROM, RAM, and other memory and computer storage devices. The computer program that may be used to configure the computer to carry out the steps of the methods may also be provided over an electronic network, for example, over the internet, world wide web, an intranet, or other network.

In one example, the methods described in this patent may be implemented in a system comprising a processor and a computer readable medium that includes program code means for causing the system to carry out the steps of the methods described in this patent. The processor may be any processor capable of carrying out the operations needed for implementation of the methods. The program code means may be any code that when implemented in the system can cause the system to carry out the steps of the methods described in this patent. Examples of program code means include but are not limited to instructions to carry out the methods described in this patent written in a high level computer language such as C++, Java, or Fortran; instructions to carry out the methods described in this patent written in a low level computer language such as assembly language; or instructions to carry out the methods described in this patent in a computer executable form such as compiled and linked machine language.

Uses of the Methods

The methods described in this patent may be used in a variety of ways including but not limited to the prediction of a characteristic property of a molecule that has not been synthesized or for which the property has not been measured; investigation of the effect of structural modification on the characteristic property of a molecule, which may be used to identify candidate molecules for use in specific circumstances, including but not limited to uses as pharmaceuticals. The methods described in this patent may be used to predict the characteristic properties of any molecule or molecule fragment for which the structure is known or may be obtained. The methods may be used to predict the efficacy of a molecule or molecular fragment for various uses including but not limited to use as a pharmaceutical, herbicide, insecticide, nutraceutical, cosmetic, or fungicide.

### EXAMPLES

The following examples demonstrate implementation of various methods described in this patent and demonstrate the operability and utility of these methods. The general approach in these examples is to compose a matrix [M×K]r⁻² of a series of molecules (M) containing a number of different types of contributing substituent parts (K). The interatomic distances, r, are determined by using the Hyperchem software package, which allows simple estimation of standard geometries of the corresponding molecules. The resulting r⁻² matrices are then analyzed with the appropriate multivariable regression analysis to determine the weight parameters. The implementation of this method is referred to in these examples as the 3D-CAN(TM) method. In these examples the contributing substituent parts are referred to as “atomic types” or some similar phrase, and the weight factors are referred to as “operational parameters,” “operational atomic parameters,” or similar phrase and are designated edᵢ, 1dᵢ, gᵢ, icᵢ, cox1ᵢ; and cox2ᵢ in the various examples. Methods described in these examples that include a contribution from a measured property of the molecule are referred to as “modified 3D-CAN(TM)” or similar phrase.

The examples below demonstrate specific implementation of methods that may be used in the selection of a reaction center.

As used in these examples, an atom designation of C4 for example represents a 4-coordinate carbon atom (i.e., sp³ hybridized), C3 represents a 3-coordinate carbon atom (i.e., sp² hybridized), N3 represents a 3-coordinate nitrogen atom (i.e., sp² hybridized), etc.

### Example 1

### Application of the Modified 3D CAN(TM) to Quantification of Mitomycin Series of Anti-Cancer Compounds

In order to evaluate the applicability of the developed approach for quantification of bioactivity data we have considered anti tumor activity of substituted mytomycins. A number of attempts have been previously made to study structure-activity relationships of mytomycins—clinical antitumor agents of the quinone series.

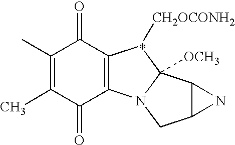

No satisfying results have previously been obtained. The best correlation could be estimated between activity of compounds 1-30 (See table F) and the corresponding values of their logP and redox potentials. The coefficient of the correlation has been established as 0.84.

We have considered a number of derivatives of Mitomycin C (1-19) and Mitomycin A (20-30) and processed their activities (expressed in concentration C which is average IC50 from assays) against human tumor cells in culture (S. P. Gupta, Chem. Review, 94, No. 6, 1519 (1994)). The corresponding experimental log(1/C) and logP values have been processed within the modified 3D CAN(TM) schemata, where the parameters are modeled as the following:

$$log ( \frac{1}{C} ) = const + {\sum }_{i \neq rc}^{N - 1} \frac{{g}_{i}}{{r}_{rc - i}^{2}} + α log P$$

where N is the number of atoms in the molecule, r_{rc-i} is the distance between atom i and the reaction center (rc) and gᵢ is the ability of an atom of a certain type to contribute into overall ΔΔG=ΔG−ΔG⁰−value. logP is the empirical measure of hydrophobicity

Since the equation above contains intraatomic distance to the atom selected as a reaction center, 3D CAN(TM) allows scanning multiple potential reaction centers to established the appropriate one, based on the quality of the regression. Several common atoms were tested as a potential reaction center of the series.

For the mytomycins series we have considered numerous common atoms as a potential reaction centers (rc). For example, when the carbon atom of the quinolone o-methyl group has been considered as the reaction center, the quality of the regression is poor as can be seen in the following table:

Regression Statistics

| | |
|---|---|
| Multiple R | 0.890038 |
| R Square | 0.792167 |
| Adjusted R Square | 0.536372 |
| Standard Error | 0.542012 |
| Observations | 30 |

The corresponding atomic operational parameters also have poor quality (see Table 1):

TABLE 1
Operational Parameters for Atomic Group
Using the Quinolone Carbon as RC

| Atomic type | Coefficients | Standard Error |
|---|---|---|
| Const | −7.09212 | 14.77619 |
| H | 22.58408 | 11.8968 |
| C4 | −31.9739 | 16.13538 |
| C═ | −25.7366 | 14.09525 |
| C aromatic | −9.3124 | 6.767811 |
| N3 | −102.108 | 14.5592 |
| —O— | −64.1973 | 9.511758 |
| O═ | 377.0665 | 119.1042 |
| F | 5.937482 | 30.53861 |
| Br | 11.06703 | 34.05972 |
| I | 17.64792 | 27.12964 |
| —S— | −16.3543 | 9.743814 |
| —N═ | 173.6192 | 61.12753 |
| N nitro | −645.49 | 205.5137 |
| N indole | 18.09392 | 33.21112 |
| N pyridine | −27.5241 | 27.39797 |

The best quality regression parameters were obtained when an atom in the center ring of mytomycin (marked with a star in the structure above) was considered as the rc. The parameters of the corresponding regression, estimated in this approximation are presented in following table:

Regression Statistics

| | |
|---|---|
| Multiple R | 0.956692 |
| R Square | 0.91526 |
| Adjusted R Square | 0.810965 |
| Standard Error | 0.346095 |
| Observations | 30 |

When the hydrophobicity is not taken into account, the quality of the correlation is lower:

Regression Statistics

| | |
|---|---|
| Multiple R | 0.949617 |
| R Square | 0.901772 |
| Adjusted R Square | 0.796527 |
| Standard Error | 0.359069 |
| Observations | 30 |

The estimated atomic operational contributions determined by regression are given in Table 2 and the operational R matrix of the modified 3D CAN(TM) (matrix of parameters) is given as Table 3.

TABLE 2
Operational atomic parameters g, derived for the presented
atomic types by equation from log(1/C) against human tumor.

| | Coefficients | Standard Error |
|---|---|---|
| const | −3.22439 | 14.49385 |
| H | 27.2439 | 11.9157 |
| C4 | −41.5106 | 16.90643 |
| C═ | −39.3292 | 16.5488 |
| C aromatic | −15.2638 | 7.724581 |
| N3 | −95.8146 | 14.6992 |
| —O— | −54.2981 | 11.46341 |
| O═ | 420.8054 | 118.7589 |
| F | 8.571243 | 29.49205 |
| Br | 2.105548 | 33.4149 |
| I | 3.576405 | 27.91911 |
| —S— | −18.4213 | 9.501031 |
| —N═ | 207.4299 | 63.43391 |
| N nitro | −714.328 | 203.7863 |
| N indole | 17.87198 | 32.01148 |
| N pyridine | −28.297 | 26.41347 |
| logP | 0.211075 | 0.146731 |

TABLE 3
The operational R matrix of the modified 3D CAN(TM) (matrix of parameters)

| Compound/ | | | | | | | | | | |
|---|---|---|---|---|---|---|---|---|---|---|
| Atomic | | | | C | | | | | | |
| type | H | C4 | C═ | aromatic | N3 | —O— | O═ | F | Br | I |
| 1 | 2.1452 | 1.3313 | 1.0476 | 0.0000 | 0.3369 | 0.1745 | 0.2157 | 0.0000 | 0.0000 | 0.0000 |
| 2 | 2.2659 | 1.4152 | 1.0556 | 0.0000 | 0.3282 | 0.1867 | 0.2148 | 0.0000 | 0.0000 | 0.0000 |
| 3 | 2.2092 | 1.3681 | 1.0852 | 0.0000 | 0.3376 | 0.1746 | 0.2196 | 0.0000 | 0.0000 | 0.0000 |
| 4 | 2.2637 | 1.4374 | 1.0477 | 0.0000 | 0.3374 | 0.1916 | 0.2195 | 0.0000 | 0.0000 | 0.0000 |
| 5 | 2.2376 | 1.3901 | 1.1043 | 0.0000 | 0.3370 | 0.1892 | 0.2213 | 0.0000 | 0.0000 | 0.0000 |
| 6 | 2.2929 | 1.3999 | 1.0482 | 0.0812 | 0.3375 | 0.1744 | 0.2157 | 0.0000 | 0.0000 | 0.0000 |
| 7 | 2.2096 | 1.3344 | 1.0479 | 0.1538 | 0.3369 | 0.1745 | 0.2194 | 0.0000 | 0.0000 | 0.0000 |
| 8 | 2.2197 | 1.3333 | 1.0481 | 0.1536 | 0.3508 | 0.1742 | 0.2195 | 0.0000 | 0.0000 | 0.0000 |
| 9 | 2.1954 | 1.3344 | 1.0483 | 0.1532 | 0.3369 | 0.1745 | 0.2195 | 0.0140 | 0.0000 | 0.0000 |
| 10 | 2.1952 | 1.3344 | 1.0484 | 0.1536 | 0.3369 | 0.1745 | 0.2195 | 0.0000 | 0.0126 | 0.0000 |
| 11 | 2.1965 | 1.3342 | 1.0481 | 0.1540 | 0.3368 | 0.1744 | 0.2192 | 0.0000 | 0.0000 | 0.0113 |
| 12 | 2.1953 | 1.3344 | 1.0483 | 0.1542 | 0.3367 | 0.1745 | 0.2194 | 0.0000 | 0.0000 | 0.0122 |
| 13 | 2.2078 | 1.3342 | 1.0480 | 0.1535 | 0.3368 | 0.1884 | 0.2195 | 0.0000 | 0.0000 | 0.0000 |
| 14 | 2.1945 | 1.3338 | 1.0483 | 0.1542 | 0.3365 | 0.1747 | 0.2441 | 0.0000 | 0.0000 | 0.0000 |
| 15 | 2.1949 | 1.3341 | 1.0483 | 0.1535 | 0.3366 | 0.1886 | 0.2196 | 0.0000 | 0.0000 | 0.0113 |
| 16 | 2.1932 | 1.3324 | 1.0478 | 0.1525 | 0.3365 | 0.1884 | 0.2411 | 0.0000 | 0.0000 | 0.0000 |
| 17 | 2.2053 | 1.3330 | 1.0481 | 0.1908 | 0.3365 | 0.1744 | 0.2193 | 0.0000 | 0.0000 | 0.0000 |
| 18 | 2.1513 | 1.3501 | 1.1238 | 0.0000 | 0.3370 | 0.1749 | 0.2186 | 0.0000 | 0.0000 | 0.0000 |
| 19 | 2.1722 | 1.3334 | 1.1414 | 0.0000 | 0.3558 | 0.1745 | 0.2152 | 0.0000 | 0.0000 | 0.0000 |
| 20 | 2.1814 | 1.3796 | 1.0562 | 0.0000 | 0.2871 | 0.2147 | 0.2170 | 0.0000 | 0.0000 | 0.0000 |
| 21 | 2.2248 | 1.4370 | 1.0559 | 0.0000 | 0.2869 | 0.2147 | 0.2183 | 0.0000 | 0.0000 | 0.0000 |
| 22 | 2.3145 | 1.4789 | 1.0561 | 0.0000 | 0.2868 | 0.2153 | 0.2169 | 0.0000 | 0.0000 | 0.0000 |
| 23 | 2.3140 | 1.4785 | 1.0563 | 0.0000 | 0.2868 | 0.2152 | 0.2175 | 0.0000 | 0.0000 | 0.0000 |
| 24 | 2.2195 | 1.3776 | 1.0558 | 0.0895 | 0.2868 | 0.2151 | 0.2164 | 0.0000 | 0.0000 | 0.0000 |
| 25 | 2.2381 | 1.4093 | 1.0558 | 0.0000 | 0.2869 | 0.2376 | 0.2170 | 0.0000 | 0.0000 | 0.0000 |
| 26 | 2.2359 | 1.3998 | 1.0558 | 0.0562 | 0.2869 | 0.2323 | 0.2171 | 0.0000 | 0.0000 | 0.0000 |
| 27 | 2.2476 | 1.4230 | 1.0563 | 0.0000 | 0.2870 | 0.2422 | 0.2171 | 0.0000 | 0.0000 | 0.0000 |
| 28 | 2.2615 | 1.4309 | 1.0556 | 0.0000 | 0.2871 | 0.2428 | 0.2165 | 0.0000 | 0.0000 | 0.0000 |
| 29 | 2.2319 | 1.3992 | 1.0561 | 0.0496 | 0.2870 | 0.2149 | 0.2168 | 0.0000 | 0.0000 | 0.0000 |
| 30 | 2.2327 | 1.4170 | 1.0559 | 0.0000 | 0.2869 | 0.2224 | 0.2169 | 0.0000 | 0.0000 | 0.0000 |

| Compound/ | | | | | | |
|---|---|---|---|---|---|---|
| Atomic | | | | | | |
| type | —S— | —N═ | N nitro | N indole | N pyridine | logP |
| 1 | 0.0000 | 0.0000 | 0.0000 | 0.0000 | 0.0000 | −0.38 |
| 2 | 0.0000 | 0.0000 | 0.0000 | 0.0000 | 0.0000 | 0.1 |
| 3 | 0.0000 | 0.0000 | 0.0000 | 0.0000 | 0.0000 | 0.24 |
| 4 | 0.0000 | 0.0000 | 0.0000 | 0.0000 | 0.0000 | 0.21 |
| 5 | 0.0000 | 0.0000 | 0.0000 | 0.0000 | 0.0000 | 1.9 |
| 6 | 0.0000 | 0.0000 | 0.0000 | 0.0000 | 0.0177 | 1.23 |
| 7 | 0.0000 | 0.0000 | 0.0000 | 0.0000 | 0.0000 | 1.3 |
| 8 | 0.0000 | 0.0000 | 0.0000 | 0.0000 | 0.0000 | 0.07 |
| 9 | 0.0000 | 0.0000 | 0.0000 | 0.0000 | 0.0000 | 1.44 |
| 10 | 0.0000 | 0.0000 | 0.0000 | 0.0000 | 0.0000 | 2.16 |
| 11 | 0.0000 | 0.0000 | 0.0000 | 0.0000 | 0.0000 | 2.42 |
| 12 | 0.0000 | 0.0000 | 0.0000 | 0.0000 | 0.0000 | 2.42 |
| 13 | 0.0000 | 0.0000 | 0.0000 | 0.0000 | 0.0000 | 0.63 |
| 14 | 0.0000 | 0.0000 | 0.0137 | 0.0000 | 0.0000 | 1.02 |
| 15 | 0.0000 | 0.0000 | 0.0000 | 0.0000 | 0.0000 | 1.75 |
| 16 | 0.0000 | 0.0000 | 0.0126 | 0.0000 | 0.0000 | 0.51 |
| 17 | 0.0000 | 0.0000 | 0.0000 | 0.0146 | 0.0000 | 2.45 |
| 18 | 0.0365 | 0.0177 | 0.0000 | 0.0000 | 0.0000 | 1.52 |
| 19 | 0.0000 | 0.0220 | 0.0000 | 0.0000 | 0.0000 | 0.56 |
| 20 | 0.0000 | 0.0000 | 0.0000 | 0.0000 | 0.0000 | 0.26 |
| 21 | 0.0000 | 0.0000 | 0.0000 | 0.0000 | 0.0000 | 0.83 |
| 22 | 0.0000 | 0.0000 | 0.0000 | 0.0000 | 0.0000 | 1.35 |
| 23 | 0.0000 | 0.0000 | 0.0000 | 0.0000 | 0.0000 | 2.47 |
| 24 | 0.0000 | 0.0000 | 0.0000 | 0.0000 | 0.0000 | 1.94 |
| 25 | 0.0000 | 0.0000 | 0.0000 | 0.0000 | 0.0000 | −1.1 |
| 26 | 0.0000 | 0.0000 | 0.0000 | 0.0000 | 0.0000 | 1.74 |
| 27 | 0.0000 | 0.0000 | 0.0000 | 0.0000 | 0.0000 | −1.08 |
| 28 | 0.0000 | 0.0000 | 0.0000 | 0.0000 | 0.0000 | −0.46 |
| 29 | 0.0160 | 0.0000 | 0.0000 | 0.0000 | 0.0000 | 2.38 |
| 30 | 0.0299 | 0.0000 | 0.0000 | 0.0000 | 0.0000 | 0.36 |

TABLE 4
Predicted and Experimental Values of Active Concentration
(log1/C) of Mitomycins 1-30 Against Human Tumor

| Compound | R | Prediction | Experimenter | resid |
|---|---|---|---|---|
| 1 | NH2 | 7.711772 | 7.7 | −0.01177 |
| 2 | HOC3H6NH | 7.071587 | 6.98 | −0.09159 |
| 3 | HC═CCH2—NH | 8.102683 | 8.46 | 0.357317 |
| 4 | tetrahydrofuryl-NH | 7.245377 | 7.13 | −0.11538 |
| 5 | 2-furyl-C2H4—NH | 7.565948 | 7.34 | −0.22595 |
| 6 | 2-pyridyl-C2H4—NH | 7.38 | 7.38 | −1.3E−14 |
| 7 | C6H5NH | 8.862808 | 8.78 | −0.08281 |
| 8 | 4-H2N—C6H4—NH | 7.642204 | 7.83 | 0.187796 |
| 9 | 4-F—C6H4—NH | 8.67 | 8.67 | −2E−14 |
| 10 | 4-Br—C6H4—NH | 8.72 | 8.72 | 1.78E−14 |
| 11 | 3-I—C6H4—NH | 8.7268 | 8.9 | 0.1732 |
| 12 | 4-I—C6H4—NH | 8.771307 | 8.77 | −0.00131 |
| 13 | 4-OH—C6H4—NH | 7.965666 | 7.88 | −0.08567 |
| 14 | 4-NO2—C6H4—NH | 9.015853 | 9.07 | 0.054147 |
| 15 | 3-I-4-OH—C6H3—NH | 7.931492 | 7.76 | −0.17149 |
| 16 | 4-OH-3-NO2—C6H3—NH | 7.76895 | 7.71 | −0.05895 |
| 17 | 5-indolyl-NH | 8.75 | 8.75 | −8.9E−15 |
| 18 | 4-methyl-thiazolyl-NH | 8.679922 | 8.69 | 0.010078 |
| 19 | 3-pyrazolyl-NH | 7.388116 | 7.38 | −0.00812 |
| 20 | CH3O | 9.602933 | 9.52 | −0.08293 |
| 21 | c-C3H5—O | 9.080572 | 9.2 | 0.119428 |
| 22 | c-C3H5—CH2—O | 9.304672 | 9.43 | 0.125328 |
| 23 | c-C4H7—CH2—O | 9.787183 | 9.66 | −0.12718 |
| 24 | C6H5—CH2—O | 9.481265 | 9.21 | −0.27126 |
| 25 | HO—C2H4—O | 8.397708 | 8.31 | −0.08771 |
| 26 | C6H5—O—C2H4—O | 8.808812 | 9.48 | 0.671188 |
| 27 | HO—C2H4—O—C2H4—O | 7.88795 | 7.32 | −0.56795 |
| 28 | CH3—O—C2H4—O—C2H4—O | 7.786789 | 8.24 | 0.453211 |
| 29 | C6H5—S—C2H4—O | 9.480943 | 9.16 | −0.32094 |
| 30 | HO—C2H4—SS—C2H4—O | 8.490691 | 8.65 | 0.159309 |

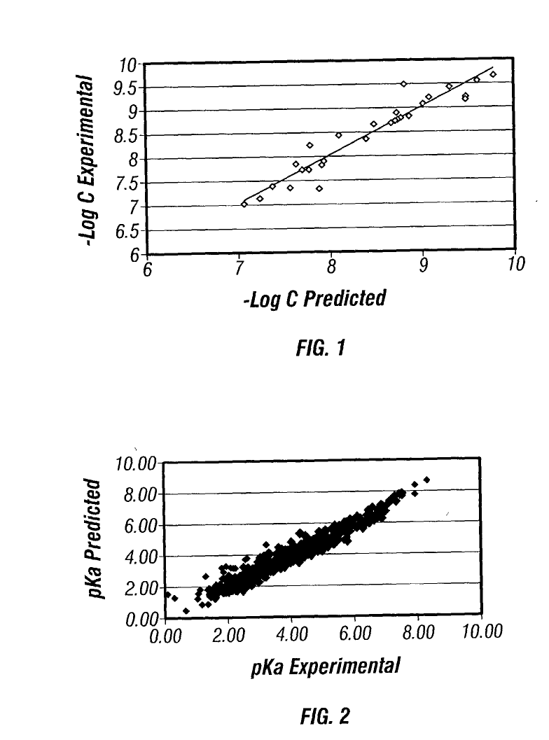

Table 4 above (presented graphically in FIG. 1) demonstrates that the modified 3D CAN(TM) allows us to quantify the set of bioactivity parameters of substituted mytomycins with accuracy, considerably higher then has been previously reported by other authors.

### Example 2

### The use of 3D-CAN(TM) Approach for Quantification of Dissociation Constants of Molecules Containing Carboxylic Group

Values of ionization constants of 827 various carboxylic acids (including small polypeptides) have been extrapolated to 25° C. and zero ionic strength (Kortum, G.; Vogel, W.; Alldrussow, K. Dissociation Constants of Organic Acids in Aqueous Solution. Butter Worth: London, 1961, Perrin, D. D.; Dempsey, B.; Seijeant, E. P. pKₐ Prediction for Organic Acids and Bases. Chapman & Hall, London: New York, 1981). The structures of acids molecules have been optimized within MM+ routine of Hyperchem software package allowing simple estimation of the standard geometries in the gas phase.

We have assumed ionizable oxygen as the reaction center, and have composed [827×21] R-matrix for 827 compounds containing 21 types of substituent atoms. The following atomic types: H, C sp³, C sp², C sp, C_{aromatic}, N sp³, N sp (CN group), O sp², O sp³, F, Cl, Br, I, S sp³, S4 (from —SO₂—) Si, Se, N⁺, O⁻, N⁺sp² have been specified. Nitro groups in nitro-substituted compounds were considered as subatomic unit and the corresponding r parameters have been taken as the distances between reaction center and nitrogen of NO₂. Ionized carboxylic groups have been considered as having full negative charge on one of oxygen atoms, while the other is in O sp² configuration.

The procedure of composition of R-matrix has been performed by MATLAB-routine, which exports atomic types and coordinates from Hyperchem structural file, arranges atoms according to the types specified and calculates intramolecular distances. After atoms-reaction centers have been indicated for all molecules of a reaction series, the routine has composed the corresponding R-matrix.

The columns of such [827×21] matrix of the reaction series have been taken as the sets of independent variables and the corresponding thermodynamic pK-s have been considered as dependent parameters of following polynomial equation:

$${pK}_{RCOOH} = {\sum }_{i}^{N - 1} \frac{{δ}_{i}^{a}}{{r}_{i}^{2}} + const$$

where δᵢ^{a} is introduced atomic operational parameter, reflecting the ability of atoms of one type to contribute to pK value of N-atomic caboxylic acid RCOOH where R represents the molecular environment of the carboxylic group.

A multilinear regression has then been established with high accuracy (Const =4.84+/−0.12; N=827; R(mult)=0.9703; S=0.1035). The estimated dissociation constants of the carboxylic acids are presented in the Table 5. The interrelation between estimated and experimental pK values is present graphically in FIG. 2. The structures of the various carboxylic acids are presented in Scheme 1.

TABLE 5
Experimental (25 C, I = 0) and estimated dissociation
constants of compounds containing carboxylic groups.

| Nr | Name | pK corr | pK calc | Δ |
|---|---|---|---|---|
| 1 | HCOOH | 3.75 | 4.10 | −0.35 |
| 2 | CH₃COOH | 4.76 | 4.30 | 0.46 |
| 3 | C₂H₅COOH | 4.87 | 4.58 | 0.29 |
| 4 | C₃H₇COOH | 4.82 | 4.68 | 0.14 |
| 5 | iso C₃H₇COOH | 4.84 | 4.72 | 0.12 |
| 6 | C₄H₉COOH | 4.80 | 4.77 | 0.03 |
| 7 | iso-C₄H₉COOH | 4.74 | 4.78 | −0.03 |
| 8 | t-C₄H₉COOH | 4.97 | 4.86 | 0.11 |
| 9 | sec-C₄H₉COOH | 4.88 | 4.84 | 0.04 |
| 10 | C₅H₁₀COOH | 4.88 | 4.80 | 0.08 |
| 11 | (CH₃)₂CH—C₂H₄COOH | 4.80 | 4.79 | 0.01 |
| 12 | C₃H₇CH(CH₃)COOH | 4.86 | 4.92 | −0.06 |
| 13 | C₂H₅CH(CH₃)CH₂COOH | 4.91 | 4.86 | 0.05 |
| 14 | C₂H₅C(CH₃)₂COOH | 5.13 | 4.97 | 0.16 |
| 15 | (C₂H₅)₂CHCOOH | 4.71 | 4.94 | −0.23 |
| 16 | C₆H₁₃COOH | 4.89 | 4.79 | 0.10 |
| 17 | t-C₄H₉C₂H₄COOH | 4.86 | 4.92 | −0.06 |
| 18 | C₃H₇CH(C₂H₅)COOH | 4.78 | 5.01 | −0.24 |
| 19 | C₇Hi₅COOH | 4.89 | 4.86 | 0.03 |
| 20 | C₈HₙCOOH | 4.95 | 4.88 | 0.07 |
| 21 | HOOCCOOH | 1.27 | 2.68 | −1.41 |
| 22 | ⁻OOCCOOH | 4.28 | 5.37 | −1.09 |
| 23 | HOOCCH₂COOH | 2.84 | 3.01 | −0.17 |
| 24 | ⁻OOCH₂COOH | 5.66 | 4.95 | 0.71 |
| 25 | HOOCC₂H₄COOH | 4.21 | 4.08 | 0.12 |
| 26 | ⁻OOCC₂H₄COOH | 5.64 | 5.52 | 0.11 |
| 27 | HOOCC₃H₆COOH | 4.34 | 4.31 | 0.03 |
| 28 | ⁻OOCC₃H₆COOH | 5.41 | 5.16 | 0.25 |
| 29 | HOOCC₄H₈COOH | 4.43 | 4.35 | 0.08 |
| 30 | ⁻OOCC₄H₈COOH | 5.41 | 5.12 | 0.29 |
| 31 | HOOCC₅H,₀COOH | 4.48 | 4.38 | 0.10 |
| 32 | ⁻OOCC₅H₁₀COOH | 5.42 | 5.36 | 0.07 |
| 33 | HOOCC₆H₁₂COOH | 4.52 | 4.52 | 0.00 |
| 34 | ⁻OOCC₆H₁₂COOH | 5.40 | 5.27 | 0.14 |
| 35 | HOOCC₇H₁₄COOH | 4.55 | 4.60 | −0.05 |
| 36 | ⁻OOCC₇H₁₂COOH | 5.41 | 5.12 | 0.30 |
| 37 | HOOCCH(CH₃)COOH | 3.05 | 3.32 | −0.27 |
| 38 | ⁻OOCCH(CH₃)COOH | 5.76 | 6.01 | −0.26 |
| 39 | HOOCCH(C₂H₅)COOH | 2.99 | 3.07 | −0.08 |
| 40 | ⁻OOCCH(C₂H₅)COOH | 5.83 | 6.05 | −0.22 |
| 41 | HOOCCH(C₃H₇)COOH | 3.00 | 2.93 | 0.07 |
| 42 | ⁻OOCCH(C₃H₇)COOH | 5.84 | 6.15 | −0.30 |
| 43 | HOOCCH(iso-C₃H₇)COOH | 2.94 | 3.16 | −0.22 |
| 44 | ⁻OOCCH(iso-C₃H₇)COOH | 5.88 | 6.23 | −0.35 |
| 45 | HOOCC(CH₃)₂COOH | 3.17 | 3.26 | −0.09 |
| 46 | ⁻OOCC(CH₃)₂COOH | 6.06 | 5.66 | 0.40 |
| 47 | HOOCC(CH₃)(C₂H₅)COOH | 2.86 | 2.67 | 0.19 |
| 48 | ⁻OOCC(CH₃)(C₂H₅)COOH | 6.41 | 6.49 | −0.08 |
| 49 | HOOCC(C₂H₅)₂COOH | 2.21 | 3.13 | −0.92 |
| 50 | ⁻OOCC(C₂H₅)₂COOH | 7.29 | 7.67 | −0.38 |
| 51 | HOOCC(C₂H₅)(C₃H₇)COOH | 2.15 | 3.12 | −0.98 |
| 52 | ⁻OOCC(C₂H₅)(C₃H₇)COOH | 7.43 | 7.77 | −0.33 |
| 53 | HOOCC(C₃H₇)₂COOH | 2.07 | 3.17 | −1.10 |
| 54 | ⁻OOCC(C₃H₇)₂COOH | 7.51 | 7.85 | −0.34 |
| 55 | ⁻OOCCH(CH₃)CH₂COOH | 5.73 | 5.46 | 0.27 |
| 56 | HOOCCH(CH₃)CH(CH₃)COOH meso | 3.77 | 3.72 | 0.05 |
| 57 | ⁻OOCCH(CH₃)CH(CH₃)COOH meso | 5.94 | 5.84 | 0.10 |
| 58 | HOOCCH(CH₃)CH(CH₃)COOH rac | 3.94 | 3.81 | 0.13 |
| 59 | ⁻OOCCH(CH₃)CH(CH₃)COOH rac | 6.20 | 6.27 | −0.07 |
| 60 | HOOCCH(C₂H₅)CH₂COOH | 4.08 | 4.18 | −0.10 |
| 61 | HOOCC(C₂H₅)₂CH₂COOH | 3.84 | 4.21 | −0.37 |
| 62 | HOOCCH(C₂H₅)CH(C₂H₅)COOH meso | 3.63 | 3.33 | 0.30 |
| 63 | ⁻OOCCH(C₂H₅)CH(C₂H₅)COOH meso | 6.46 | 6.79 | −0.33 |
| 64 | HOOCCH(C₂H₅)CH(C₂H₅)COOH rac | 3.51 | 3.59 | −0.08 |
| 65 | ⁻OOCCH(C₂H₅)CH(C₂H₅)COOH rac | 6.60 | 6.44 | 0.15 |
| 66 | HOOCCH(C₂H₅)C(C₂H₅)₂COOH | 2.74 | 2.28 | 0.46 |
| 67 | HOOCCH₂CH(CH₃)CH₂COOH | 4.25 | 4.44 | −0.19 |
| 68 | ⁻OOCCH₂CH(CH₃)CH₂COOH | 5.41 | 5.62 | −0.21 |
| 69 | HOOCCH₂CH(C₂H₅)CH₂COOH | 4.29 | 4.52 | −0.24 |
| 70 | ⁻OOCCH₂CH(C₂H₅)CH₂COOH | 5.33 | 5.29 | 0.04 |
| 71 | HOOCCH₂C(CH₃)₂CH₂COOH | 3.70 | 3.77 | −0.07 |
| 72 | ⁻OOCCH₂C(CH₃)₂CH₂COOH | 6.34 | 6.11 | 0.23 |
| 73 | HOOCCH₂CH(C₃H₇)CH₂COOH | 4.31 | 4.59 | −0.28 |
| 74 | ⁻OOCCH₂CH(C₃H₇)CH₂COOH | 5.39 | 5.85 | −0.47 |
| 75 | HOOCCH₂CH(iso-C₃H₇)CH₂COOH | 4.30 | 4.68 | −0.38 |
| 76 | ⁻OOCCH₂CH(iso-C₃H₇)CH₂COOH | 5.51 | 5.53 | −0.02 |
| 77 | HOOCCH₂C(C₂H₅)(CH₃)CH₂COOH | 3.62 | 3.94 | −0.32 |
| 78 | ⁻OOCCH₂C(C₂H₅)(CH₃)CH₂COOH | 6.70 | 6.52 | 0.18 |
| 79 | HOOCCH₂C(C₂H₅)₂CH₂COOH | 3.62 | 3.90 | −0.28 |
| 80 | ⁻OOCCH₂C(C₂H₅)₂CH₂COOH | 7.12 | 7.24 | −0.12 |
| 81 | HOOCCH₂C(C₃H₇)(CH₃)CH₂COOH | 3.63 | 3.13 | 0.50 |
| 82 | HOOCCH₂C(C₃H₇)(C₂H₅)CH₂COOH | 3.51 | 3.46 | 0.05 |
| 83 | HOOCCH₂C(C₃H₇)₂CH₂COOH | 3.69 | 4.37 | −0.68 |
| 84 | ⁻OOCCH₂C(C₃H₇)₂CH₂COOH | 7.31 | 7.36 | −0.05 |
| 85 | H₂OCHCOOH | 4.25 | 4.31 | −0.07 |
| 86 | CH₃HC═CHCOOH trans | 4.69 | 4.40 | 0.29 |
| 87 | CH₃HC═CHCOOH cis | 4.48 | 4.56 | −0.08 |
| 88 | H₂C═CHCH₂COOH | 4.34 | 4.54 | −0.20 |
| 89 | H₂C═C(CH₃)COOH | 4.73 | 4.43 | 0.30 |
| 90 | H₃CC═CCOOH | 2.65 | 2.69 | −0.04 |
| 91 | H₅C₂CH═CHCOOH | 4.69 | 4.48 | 0.21 |
| 92 | H₂C═CHC₂H₄COOH | 4.67 | 4.62 | 0.05 |
| 93 | H₃CCH═CH(CH₃)COOH cis | 4.36 | 4.67 | −0.31 |
| 94 | H₃CCH═CH(CH₃)COOH trans | 5.06 | 4.52 | 0.54 |
| 95 | (H₃C)₂C═CHCOOH | 5.12 | 4.65 | 0.47 |
| 96 | H₇C₃CH═CHCOOH | 4.70 | 4.53 | 0.18 |
| 97 | H₅C₂CH═CHCH₂COOH trans | 4.52 | 4.66 | −0.15 |
| 98 | H₃CCH═CHC₂H4COOH trans | 4.72 | 4.65 | 0.06 |
| 99 | H₂C═CHC₃H₆COOH | 4.72 | 4.70 | 0.02 |
| 100 | H₅C₂C(CH₃)═CHCOOH trans | 5.13 | 4.68 | 0.45 |
| 101 | H₅C₂C(CH₃)═CHCOOH cis | 5.15 | 4.81 | 0.34 |
| 102 | iso-H₇C₃—CH═CHCOOH | 4.70 | 4.56 | 0.14 |
| 103 | (H₃C)₂C═CHCH₂COOH | 4.60 | 4.69 | −0.09 |
| 104 | (H₃C)₂C═CHC₂H₄COOH | 4.80 | 4.72 | 0.08 |
| 105 | HOOCCH═CHCOOH cis | 2.00 | 2.69 | −0.69 |
| 106 | ⁻QOCCH═CHCOOH cis | 6.26 | 5.63 | 0.63 |
| 107 | HOOCCH═CHCOOH trans | 3.02 | 3.83 | −0.81 |
| 108 | ⁻OOCCH═CHCOOH trans | 4.45 | 5.16 | −0.71 |
| 109 | HOOCCH₂—CH═CHCOOH | 3.77 | 4.11 | −0.34 |
| 110 | ⁻OOCCH₂—CH═CHCOOH | 5.08 | 5.56 | −0.48 |
| 111 | ⁻OOCC(CH₃)═CHCOOH cis | 6.29 | 5.77 | 0.52 |
| 112 | ⁻OOCC(CH₃)═CHCOOH trans | 4.89 | 5.44 | −0.54 |
| 113 | H₂C═C(COO⁻)CH₂COOH | 5.64 | 5.75 | −0.11 |
| 114 | C₃H₅(cyclo)COOH | 4.83 | 4.57 | 0.26 |
| 115 | C₄H₇(cyclo)COOH | 4.79 | 4.68 | 0.10 |
| 116 | C₅H₉(cyclo)COOH | 4.99 | 4.91 | 0.07 |
| 117 | C₆H₁₁(cyclo)COOH | 4.90 | 4.89 | 0.00 |
| 118 | C₆H₁₀(cyclo), 1-CH₃, 1-COOH | 5.13 | 5.06 | 0.07 |
| 119 | C₆H₁₀(cyclo)-2-CH₃, 1-COOH trans | 5.74 | 5.08 | 0.66 |
| 120 | C₆H₁₀(cyclo)-2-CH₃, 1-COOH ecvat | 5.04 | 5.32 | −0.29 |
| 121 | C₆H₁₀(cyclo)-3-CH₃, 1-COOH trans | 5.02 | 4.91 | 0.12 |
| 122 | C₆H₁₀(cyclo)-3-CH₃, 1-COOH ecvat | 4.88 | 5.11 | −0.23 |
| 123 | C₆H₁₀(cyclo)-4-CH₃, 1-COOH trans | 4.88 | 4.98 | −0.10 |
| 124 | C₆H₁₀(cyclo)-4-CH₃, 1-COOH ecvat | 5.04 | 4.98 | 0.06 |
| 125 | C₆H₁₁(cyclo)CH₂COOH | 4.80 | 4.83 | −0.03 |
| 126 | C₆H₁₁(cyclo)C₂H₄COOH | 4.91 | 4.78 | 0.13 |
| 127 | C₆H₁₁(cyclo)C₃H₆COOH | 4.95 | 4.85 | 0.10 |
| 128 | C₃H₄(cyclo)-1-COOH, 1-COOH | 1.82 | 2.95 | −1.13 |
| 129 | C₃H₄(cyclo)-1-COO⁻, 1-COOH | 5.43 | 5.45 | −0.02 |
| 130 | C₃H₄(cyclo)-2-COOH, 1-COOH axial | 3.66 | 3.88 | −0.22 |
| 131 | C₃H₄(cyclo)-2-COCH, 1-COOH axial | 5.14 | 5.04 | 0.10 |
| 132 | C₃H₄(cyclo)-2-COOH, 1-COOH ecvat | 3.33 | 3.40 | −0.07 |
| 133 | C₃H₄(cyclo)-2-COO⁻, 1-COOH ecvat | 5.47 | 5.05 | 0.42 |
| 134 | C₄H₆(cyclo)-1-COOH, 1-COOH | 3.13 | 3.70 | −0.58 |
| 135 | C₄H₆(cyclo)-1-COO⁻, 1-COOH | 5.88 | 5.81 | 0.07 |
| 136 | C₄H₆(cyclo)-2-COOH, 1-COOH axial | 3.79 | 4.19 | −0.40 |
| 137 | C₄H₆(cyclo)-2-COO⁻, 1-COOH axial | 5.61 | 5.45 | 0.16 |
| 138 | C₄H₆(cyclo)-2-COOH, 1-COOH ecvat | 3.90 | 3.52 | 0.38 |
| 139 | C₄H₆(cyclo)-2-COO⁻, 1-COOH ecvat | 5.89 | 6.19 | −0.30 |
| 140 | C₄H₆(cyclo)-3-COOH, 1-COOH axial | 3.81 | 4.25 | −0.44 |
| 141 | C₄H₆(cyclo)-3-COO⁻, 1-COOH axial | 5.28 | 5.00 | 0.28 |
| 142 | C₄H₆(cyclo)-3-COOH, 1-COOH ecvat | 4.03 | 3.74 | 0.29 |
| 143 | C₄H₆(cyclo)-3-COO⁻, 1-COOH ecvat | 5.31 | 5.08 | 0.23 |
| 144 | C₅H₈(cyclo)-1-COOH, 1-COOH | 3.23 | 3.01 | 0.22 |
| 145 | C₅H₈(cyclo)-2-COOH, 1-COOH axial | 3.96 | 4.25 | −0.29 |
| 146 | C₅H₈(cyclo)-2-COO⁻, 1-COOH axial | 5.85 | 5.47 | 0.38 |
| 147 | C₅H₈(cyclo)-2-COOH, 1-COOH ecvat | 4.43 | 4.32 | 0.11 |
| 148 | C₅H₈(cyclo)-2-COO⁻, 1-COOH ecvat | 6.57 | 6.46 | 0.10 |
| 149 | C₅H₈(cyclo)-3-COOH, 1-COOH axial | 4.32 | 4.42 | −0.10 |
| 150 | C₅H₈(cyclo)-3-COO⁻, 1-COOH axial | 5.42 | 5.27 | 0.15 |
| 151 | C₅H₈(cyclo)-3-COOH, 1-COOH ecvat | 4.26 | 4.05 | 0.21 |
| 152 | C₅H₈(cyclo)-3-COO⁻, 1-COOH ecvat | 5.51 | 5.28 | 0.23 |
| 153 | C₅H₈(cyclo)-2-CH₂COOH, 1-COOH axial | 4.44 | 4.42 | 0.02 |
| 154 | C₅H₈(cyclo)-2-CH₂COO⁻, 1-COOH axial | 5.74 | 5.80 | −0.06 |
| 155 | C₅H₈(cyclo)-2-CH₂COOH, 1-COOH ecvat | 4.45 | 4.76 | −0.31 |
| 156 | C₅H₈(cyclo)-2-CH₂COO⁻, 1-COOH ecvat | 5.86 | 5.87 | −0.01 |
| 157 | C₅H₈(cyclo)-1-CH₂COOH, 1-CH₂COOH | 3.80 | 4.19 | −0.39 |
| 158 | C₅H₈(cyclo)-1-CH₂COO⁻1-CH₂COOH | 6.77 | 6.86 | −0.09 |
| 159 | C₅H₈(cyclo)-2-CH₂COOH, 1-CH₂COOH axial | 4.48 | 4.61 | −0.13 |
| 160 | C₅H₈(cyclo)-2-CH₂COO⁻, 1-CH₂COOH axial | 5.50 | 5.76 | −0.26 |
| 161 | C₅H₈(cyclo), 2-CH₂COOH, 1-CH₂COOH ecvat | 4.47 | 4.32 | 0.15 |
| 162 | C₅H₈(cyclo), 2-CH₂COO⁻, 1-CH₂COOH ecvat | 5.49 | 5.08 | 0.41 |
| 163 | C₅H₈(cyclo), 3-CH₂COOH, 1-CH₂COOH ecvat | 3.79 | 3.48 | 0.32 |
| 164 | C₅H₇(cyclo), 3-CH₃, 1-CH₂COOH, 1-CH₂COOH | 6.74 | 6.37 | 0.37 |
| 165 | C₆H₁₀(cyclo), 1-COOH, 1-COOH | 3.45 | 3.03 | 0.42 |
| 166 | C₆H₁₀(cyclo), 2-COOH, 1-COOH axial | 4.25 | 4.42 | −0.17 |
| 167 | C₆H₁₀(cyclo), 2-COO⁻, 1-COOH axial | 6.01 | 6.20 | −0.18 |
| 168 | C₆H₁₀(cyclo), 2-COOH, 1-COOH ecvat | 4.38 | 4.29 | 0.09 |
| 169 | C₆H₁₀(cyclo), 2-COO⁻, 1-COOH ecvat | 6.86 | 6.27 | 0.59 |
| 170 | C₆H₁₀(cyclo), 3-COOH, 1-COOH axial | 4.37 | 4.33 | 0.04 |
| 171 | C₆H₁₀(cyclo), 3-COO⁻, 1-COOH axial | 5.81 | 5.62 | 0.19 |
| 172 | C₆H₁₀(cyclo), 3-COOH, 1-COOH ecvat | 4.19 | 3.93 | 0.26 |
| 173 | C₆H₁₀(cyclo), 3-COO⁻, 1-COOH ecvat | 5.59 | 5.55 | 0.04 |
| 174 | C₆H₁₀(cyclo), 4-COOH, 1-COOH axial | 4.27 | 4.62 | −0.35 |
| 175 | C₆H₁₀(cyclo), 4-COO⁻, 1-COOH axial | 5.50 | 5.34 | 0.16 |
| 176 | (1) | 4.00 | 4.34 | −0.34 |
| 177 | (2) | 5.88 | 6.02 | −0.14 |
| 178 | (3) | 3.94 | 4.07 | −0.13 |
| 179 | (4) | 6.88 | 6.87 | 0.01 |
| 180 | C₆H₁₀(cyclo), 1-CH₂COOH, 1-CH₂COOH | 3.49 | 3.36 | 0.12 |
| 181 | C₆H₁₀(cyclo), 1-CH₂COOH, 1-CH₂COOH | 6.96 | 6.77 | 0.20 |
| 182 | C₆H₁₀(cyclo), 2-CH₂COOH, 1-CH₂COOH | 4.43 | 4.48 | −0.05 |
| | axial | | | |
| 183 | C₆H₁₀(cyclo), 2-CH₂COO⁻, 2-CH₂COOH | 5.49 | 5.70 | −0.21 |
| | axial | | | |
| 184 | C₆H₁₀(cyclo), 2-CH₂COOH, 1-CH₂COOH | 4.47 | 4.63 | −0.16 |
| | ecvat | | | |
| 185 | C₆H₁₀(cyclo), 2-CH₂COO⁻, 1-CH₂COOH | 5.52 | 5.62 | −0.10 |
| | ecvat | | | |
| 186 | C₆H₁₀(cyclo), 2-CH₂COOH, 2-CH₃, 1-CH₂COOH | 6.89 | 6.71 | 0.17 |
| 187 | C₆H₁₀(cyclo), 2-CH₂COOH, 3-CH₃, 1-CH₂COOH | 3.49 | 3.42 | 0.07 |
| 188 | C₆H₁₀(cyclo), 2-CH₂COO⁻, 3-CH₃, 1-CH₂COOH | 6.08 | 6.34 | −0.26 |
| 189 | C₆H₁₀(cyclo), 4-CH₃, 1-CH₂COOH, 1-CH₂COOH | 3.49 | 3.17 | 0.32 |
| 190 | C₆H₁₀(cyclo), 4-CH₃1-CH₂COO⁻, 1-CH₂COOH | 6.10 | 6.14 | −0.04 |
| 191 | (5) | 5.01 | 5.13 | −0.12 |
| 192 | (6) | 6.78 | 6.75 | 0.03 |
| 193 | (7) | 4.00 | 4.21 | −0.21 |
| 194 | (8) | 5.70 | 5.87 | −0.18 |
| 195 | (9) | 3.98 | 3.99 | −0.01 |
| 196 | (10) | 6.47 | 6.39 | 0.08 |
| 197 | (11) | 4.07 | 4.48 | −0.41 |
| 198 | (12) | 5.73 | 5.48 | 0.25 |
| 199 | (13) | 4.14 | 4.45 | −0.31 |
| 200 | (14) | 7.48 | 7.73 | −0.25 |
| 201 | (15) | 4.57 | 4.35 | 0.22 |
| 202 | (16) | 6.82 | 6.86 | −0.04 |
| 203 | (17) | 4.11 | 3.92 | 0.19 |
| 204 | (18) | 5.81 | 5.38 | 0.43 |
| 205 | (19) | 4.30 | 3.80 | 0.50 |
| 206 | (20) | 7.14 | 7.37 | −0.23 |
| 207 | (21) | 4.51 | 4.23 | 0.28 |
| 208 | (22) | 6.72 | 6.49 | 0.22 |
| 209 | (23) | 4.14 | 3.93 | 0.21 |
| 210 | (24) | 6.24 | 6.14 | 0.10 |
| 211 | (25) | 4.84 | 4.37 | 0.47 |
| 212 | (26) | 7.05 | 7.13 | −0.08 |
| 213 | (27) | 4.20 | 3.96 | 0.24 |
| 214 | (28) | 7.92 | 7.79 | 0.13 |
| 215 | (29) | 4.71 | 4.33 | 0.38 |
| 216 | (30) | 6.86 | 7.13 | −0.28 |
| 217 | (31) | 4.61 | 4.32 | 0.29 |
| 218 | (32) | 6.96 | 6.75 | 0.21 |
| 219 | (33) | 4.57 | 4.89 | −0.32 |
| 220 | (34) | 6.25 | 6.06 | 0.19 |
| 221 | (35) | 4.20 | 3.93 | 0.27 |
| 222 | (36) | 7.92 | 8.36 | −0.44 |
| 223 | (37) | 4.77 | 4.46 | 0.31 |
| 224 | (38) | 6.96 | 6.72 | 0.23 |
| 225 | (39) | 4.30 | 3.92 | 0.38 |
| 226 | (40) | 6.15 | 5.84 | 0.30 |
| 227 | (41) | 4.51 | 4.88 | −0.37 |
| 228 | (42) | 6.09 | 6.40 | −0.32 |
| 229 | (43) | 4.74 | 4.91 | −0.17 |
| 230 | (44) | 6.31 | 6.01 | 0.30 |
| 231 | (45) | 4.50 | 4.75 | −0.25 |
| 232 | (46) | 5.70 | 5.96 | −0.26 |
| 233 | (47) | 3.82 | 4.34 | −0.52 |
| 234 | (48) | 5.32 | 5.28 | 0.04 |
| 235 | (49) | 2.34 | 2.50 | −0.16 |
| 236 | (50) | 8.31 | 8.65 | −0.35 |
| 237 | (51) | 3.60 | 4.49 | −0.89 |
| 238 | (52) | 5.29 | 5.64 | −0.36 |
| 239 | (53) | 3.86 | 4.27 | −0.41 |
| 240 | (54) | 5.59 | 5.39 | 0.20 |
| 241 | FCH₂COOH | 2.59 | 3.74 | −1.15 |
| 242 | ClCH₂COOH | 2.82 | 2.62 | 0.20 |
| 243 | BrCH₂COOH | 2.90 | 2.49 | 0.41 |
| 244 | ICH₂COOH | 3.18 | 3.25 | −0.07 |
| 245 | N≡CCH₂COOH | 2.45 | 1.75 | 0.70 |
| 246 | Cl₂CHCOOH | 1.37 | 1.83 | −0.47 |
| 247 | Cl₃CCOOH | 0.63 | 0.50 | 0.13 |
| 248 | CH₃CH(Cl)COOH | 2.91 | 2.72 | 0.18 |
| 249 | ClC₂H₄COOH | 4.17 | 3.89 | 0.28 |
| 250 | CH₃CH(Br)COOH | 3.00 | 2.88 | 0.12 |
| 251 | BrC₂H₄COOH | 4.06 | 3.84 | 0.23 |
| 252 | CH₃CH(I)COOH | 3.16 | 3.64 | −0.48 |
| 253 | IC₂H₄COOH | 4.16 | 4.14 | 0.02 |
| 254 | CH₃CH(CN)COOH | 2.37 | 2.40 | −0.04 |
| 255 | N≡CC₂H₄COOH | 3.99 | 3.66 | 0.33 |
| 256 | F₃CCH₂COOH | 2.95 | 3.33 | −0.38 |
| 257 | (CH₃)₂C(Cl)COOH | 3.02 | 3.20 | −0.18 |
| 258 | N≡CC₃H₆COOH | 4.44 | 4.03 | 0.41 |
| 259 | (CH₃)₂C(CN)COOH | 2.42 | 2.42 | 0.00 |
| 260 | F₃CC₂H₄COOH | 4.16 | 4.19 | −0.03 |
| 261 | C₂H₅CH(CH₂Br)COOH | 3.97 | 4.17 | −0.20 |
| 262 | F₃CC₃H₆COOH | 4.49 | 4.37 | 0.12 |
| 263 | F₂CHC₃F₆COOH | 2.65 | 2.55 | 0.11 |
| 264 | F₇C₃C₂H₄COOH | 4.18 | 3.95 | 0.23 |
| 265 | F₂CHC₅F,oCOOH | 2.68 | 2.18 | 0.50 |
| 266 | F₂CHC₇F₁₄COOH | 2.60 | 2.07 | 0.53 |
| 267 | H₂C═CFCOOH | 2.55 | 3.72 | −1.16 |
| 268 | F₂C═CHCOOH | 3.17 | 3.49 | −0.33 |
| 269 | F₂C═CFCOOH | 1.79 | 3.15 | −1.36 |
| 270 | ClCH═CHCOOH trans | 3.70 | 3.63 | 0.07 |
| 271 | ClCH═CHCOOH cis | 3.32 | 3.54 | −0.22 |
| 272 | Cl₂C═CHCOOH | 1.15 | 0.88 | 0.27 |
| 273 | CH₃CH═CClCOOH | 3.22 | 3.53 | −0.31 |
| 274 | H₂C═CHCHClCOOH | 2.54 | 2.98 | −0.44 |
| 275 | F₃CCH═CHCOOH | 3.35 | 3.24 | 0.11 |
| 276 | C₃F₇CH═CHCOOH | 3.23 | 2.91 | 0.32 |
| 277 | C₆H₁₁(cyclo)—CH(CN)COOH | 2.37 | 2.70 | −0.33 |
| 278 | C₆Hio(cyclo),2-CN, 1-COOH axial | 3.86 | 4.09 | −0.23 |
| 279 | HOOCCH(Br)CH₂COOH | 2.75 | 2.43 | 0.−32 |
| 280 | ⁻OOCCH(Br)CH₂COOH | 4.44 | 4.47 | −0.03 |
| 281 | HOOCCH(Cl)CH(Cl)COOH rac | 1.43 | 1.44 | −0.02 |
| 282 | ⁻OOCCH(Cl)CH(Cl)COOH rac | 2.78 | 3.07 | −0.29 |
| 283 | HOOCCH(Cl)CH(Cl)COOH meso | 1.52 | 1.56 | −0.04 |
| 284 | ⁻OOCCH(Cl)CH(Cl)COOH meso | 2.96 | 2.72 | 0.24 |
| 285 | HOOCCH(Br)CH(Cl)COOH meso | 1.46 | 1.61 | −0.16 |
| 286 | ⁻OOCCH(Cl)CH(Br)COOH meso | 2.79 | 3.14 | −0.35 |
| 287 | HOOCCH(Br)CH(Cl)COOH rac | 1.43 | 1.52 | −0.09 |
| 288 | ⁻OOCCH(Cl)CH(Br)COOH rac | 2.63 | 2.73 | −0.10 |
| 289 | HOOCCH(Br)CH(Br)COOH meso | 1.42 | 1.85 | −0.43 |
| 290 | ⁻OOCCH(Br)CH(Br)COOH meso | 3.27 | 3.47 | −0.19 |
| 291 | HOOCCH(Br)CH(Br)COOH rac | 1.51 | 1.40 | 0.11 |
| 292 | ⁻OOCCH(Br)CH(Br)COOH rac | 2.74 | 2.66 | 0.08 |
| 293 | HOCH₂COOH | 3.83 | 3.87 | −0.04 |
| 294 | C₂H₅OCH₂COOH | 3.70 | 4.01 | −0.31 |
| 295 | C₅H₉(cyclo)OCH₂COOH | 3.70 | 3.76 | −0.06 |
| 296 | C₆H₁₁(cyclo)OCH₂COOH | 3.54 | 3.74 | −0.20 |
| 297 | C₆H₁₁(cyclo)—CH₂OCH₂COOH | 3.90 | 4.17 | −0.27 |
| 298 | C₆H₁₀(cyclo), 1-OCH₂COOH, 2-CH₃ | 3.80 | 3.87 | −0.08 |
| 299 | C₆H₁₀(cyclo), 1-OCH₂COOH, 3-CH₃axial | 3.81 | 3.78 | 0.03 |
| 300 | C₆H₁₀(cyclo), 1-OCH₂COOH, 3-CH₃ecvat | 3.85 | 4.20 | −0.34 |
| 301 | (55) | 4.75 | 4.34 | 0.41 |
| 302 | C₆H₅OCH₂COOH | 3.17 | 3.31 | −0.14 |
| 303 | C₆H₄(2-CH₃)OCH₂COOH | 3.23 | 3.45 | −0.22 |
| 304 | C₆H₄(3-CH₃)OCH₂COOH | 3.20 | 3.35 | −0.15 |
| 305 | C₆H₄(4-CH₃)OCH₂COOH | 3.22 | 3.34 | −0.12 |
| 306 | C₆H₃(2-CH₃, 6-CH₃)OCH₂COOH | 3.36 | 3.55 | −0.19 |
| 307 | C₆H₄(2-OCH₃)OCH₂COOH | 3.23 | 3.04 | 0.19 |
| 308 | C₆H₄(3-OCH₃)OCH₂COOH | 3.14 | 3.25 | −0.10 |
| 309 | C₆H₄(4-OCH₃)OCH₂COOH | 3.21 | 3.34 | −0.13 |
| 310 | CH₃CH(OH)COOH | 3.86 | 3.47 | 0.39 |
| 311 | C₆H₁₁(cyclo)OCH(CH₃)COOH | 3.64 | 3.98 | −0.34 |
| 312 | C₆H₁₀(cyclo) 2-CH₃, 1-OCH(CH₃)COOH | 3.65 | 4.10 | −0.45 |
| 313 | CH₃C(CH₃)(OH)COOH | 4.11 | 4.28 | −0.18 |
| 314 | C₂H₅C(CH₃)(OH)COOH | 4.06 | 3.69 | 0.38 |
| 315 | CH₃CH(OH)CH(CH₃)COOH | 4.72 | 4.37 | 0.35 |
| 316 | (C₂H₅)₂C(OH)COOH | 3.87 | 3.86 | 0.01 |
| 317 | CH₃CH(OH)C₂H₄COOH | 4.76 | 4.50 | 0.26 |
| 318 | CH₃C(OH)(CH₃)C₂H4COOH | 4.94 | 4.58 | 0.36 |
| 319 | HOCH₂(CH(OH))₄COOH | 3.23 | 2.85 | 0.38 |
| 320 | (CH₃)₂CHCH(OH)C₂H₄CH(CH₃)CH₂COOH | 5.17 | 4.88 | 0.29 |
| 321 | C₆H₁₀(cyclo), 2-OH, 1-COOH axial | 4.68 | 4.64 | 0.04 |
| 322 | C₆H₁₀(cyclo), 2-OH, 1-COOH ecvat | 4.80 | 4.47 | 0.33 |
| 323 | C₆H₁₀(cyclo), 3-OH, 1-COOH axial | 4.81 | 4.60 | 0.20 |
| 324 | C₆H₁₀(cyclo), 3-OH, 1-COOH ecvat | 4.60 | 4.51 | 0.09 |
| 325 | C₆H₁₀(cyclo), 4-OH, 1-COOH axial | 4.68 | 4.71 | −0.04 |
| 326 | C₆H₁₀(cyclo), 4-OH, 1-COOH ecvat | 4.84 | 4.66 | 0.17 |
| 327 | ⁻OOCCH(OH)CH₂COOH | 5.14 | 4.86 | 0.28 |
| 328 | HOOCCH(OH)CH(OH)COOH rac | 3.04 | 3.22 | −0.19 |
| 329 | ⁻OOCCH(OH)CH(OH)COOH rac | 4.37 | 4.15 | 0.22 |
| 330 | HOOCCH(OH)CH(OH)COOH meso | 3.22 | 3.04 | 0.18 |
| 331 | ⁻OOCCH(OH)CH(OH)COOH meso | 4.82 | 4.31 | 0.51 |
| 332 | HOOCCH₂C(OH)(COOH)CH₂COOH | 3.13 | 2.72 | 0.41 |
| 333 | HOOCCH₂C(OH)(COOH)CH₂COOH | 4.76 | 4.44 | 0.32 |
| 334 | HOOCCH₂C(OH)(COOH)CH₂COOH | 6.40 | 6.05 | 0.34 |
| 335 | H₃N⁺CH₂COOH | 2.35 | 2.15 | 0.20 |
| 336 | CH₃N⁺H₂CH₂COOH | 2.35 | 2.34 | 0.01 |
| 337 | C₂H₅N⁺H₂CH₂COOH | 2.34 | 2.37 | −0.03 |
| 338 | C₃H₇N⁺H₂CH₂COOH | 2.35 | 2.30 | 0.05 |
| 339 | C₄H₉N⁺H₂CH₂COOH | 2.35 | 2.47 | −0.12 |
| 340 | Iso-C₄H₉N⁺H₂CH₂COOH | 2.35 | 2.50 | −0.15 |
| 341 | HC(O)NHCH₂COOH | 3.43 | 3.67 | −0.24 |
| 342 | H₃CC(O)NHCH₂COOH | 3.67 | 3.74 | −0.07 |
| 343 | ClCH₂C(O)NHCH₂COOH | 3.38 | 3.43 | −0.05 |
| 344 | C₂H₅C(O)NHCH₂COOH | 3.72 | 3.78 | −0.07 |
| 345 | H₂NC(O)NHCH₂COOH | 3.88 | 3.54 | 0.33 |
| 346 | C₂H₅OC(O)NHCH₂COOH | 3.68 | 3.49 | 0.19 |
| 347 | H₃N⁺CH(CH₃)COOH | 2.34 | 2.24 | 0.10 |
| 348 | CH₃N⁺H₂CH(CH₃)COOH | 2.22 | 2.49 | −0.27 |
| 349 | C₂H₅N⁺H₂CH(CH₃)COOH | 2.22 | 2.36 | −0.14 |
| 350 | C₃H₇N⁺H₂CH(CH₃)COOH | 2.21 | 2.61 | −0.40 |
| 351 | CH₃C(O)NHCH(CH₃)COOH | 3.72 | 3.53 | 0.19 |
| 352 | H₂NC(O)NHCH(CH₃)COOH | 3.89 | 3.96 | −0.07 |
| 353 | H₃N⁺C₂H₄COOH | 3.55 | 3.54 | 0.01 |
| 354 | CH₃C(O)NHC₂H₄COOH | 4.45 | 4.22 | 0.23 |
| 355 | H₃N⁺C(O)NHC₂H₄COOH | 4.49 | 4.15 | 0.34 |
| 356 | H₃N⁺CH(C₂H₅)COOH | 2.29 | 2.32 | −0.04 |
| 357 | CH₃C(O)NHCH(C₂H₅)COOH | 3.72 | 3.61 | 0.11 |
| 358 | H₃N⁺C(O)NHCH(C₂H₅)COOH | 3.89 | 4.02 | −0.14 |
| 359 | H₃N⁺C₃H₆COOH | 4.03 | 3.98 | 0.05 |
| 360 | H₃N⁺C(O)NHC₃H₆COOH | 4.68 | 4.34 | 0.35 |
| 361 | H₃N⁺C(CH₃)₂COOH | 2.36 | 2.14 | 0.22 |
| 362 | H₃N⁺C(O)NHC(CH₃)₂COOH | 4.46 | 4.17 | 0.29 |
| 363 | H₃N⁺CH(C₃H₇)COOH | 2.32 | 2.25 | 0.07 |
| 364 | H₃N⁺CH(C₂H₅)CH₂COOH | 4.02 | 3.83 | 0.19 |
| 365 | H₃K⁺C₄H₈COOH | 4.20 | 3.92 | 0.28 |
| 366 | H₃N⁺CH(iso-C₃H₇)COOH | 2.29 | 2.29 | −0.01 |
| 367 | H₃N⁺CH(C₄H₉)COOH | 2.34 | 2.27 | 0.07 |
| 368 | H₃N⁺C₅H₁₀COOH | 4.43 | 4.40 | 0.03 |
| 369 | H₃N⁺CH(iso-C₄H₉)COOH | 2.33 | 2.38 | −0.05 |
| 370 | H₃N⁺CH(sec-C₄H₉)COOH | 2.32 | 2.55 | −0.23 |
| 371 | H₃N⁺C₁₁H₂₂COOH | 4.65 | 4.84 | −0.19 |
| 372 | C₆H₁₀(cyclo), 1-N⁺H₃, 1-COOH | 2.66 | 2.54 | 0.11 |
| 373 | C₆H₁₀(cyclo), 1-N⁺H₃, 2-COOH | 3.59 | 3.41 | 0.18 |
| 374 | C₅H₁₀(cyclo), 1-N⁺H₃, 3-COOH axial | 3.85 | 4.08 | −0.23 |
| 375 | C₆H₁₀(cyclo), 1-N⁺H₃, 3-COOH ecvat | 3.70 | 4.10 | −0.40 |
| 376 | C₆H₁₀(cyclo), 1-N⁺H₃, 4-COOH axial | 4.39 | 4.24 | 0.15 |
| 377 | C₆H₁₀(cyclo), 1-N⁺H₃, 4-COOH ecvat | 4.83 | 4.22 | 0.60 |
| 378 | H₃N⁺C₃H₆CH(N⁺H₃)COOH | 1.94 | 2.08 | −0.14 |
| 379 | H₃N⁺CH(C₃H6NHC(═N⁺H₂)NH₂)COOH | 1.82 | 1.97 | −0.15 |
| 380 | (56) | 1.82 | 1.67 | 0.15 |
| 381 | H₃N⁺CH(C₃H₆NHC(O)NH₂)COOH | 2.43 | 2.17 | 0.26 |
| 382 | H₃N⁺CH(C₄H₈N⁺H₃)COOH | 2.18 | 2.12 | 0.06 |
| 383 | H₃N⁺CH(CH₂COOH)COOH | 1.98 | 1.74 | 0.24 |
| 384 | H₃N⁺CH(CH₂COO⁻)COOH | 3.96 | 3.55 | 0.41 |
| 385 | H₃N⁺CH(C₂H₄COOH)COOH | 2.10 | 2.12 | −0.02 |
| 386 | H₃N⁺CH(C₂H₄COO⁻)COOH | 4.07 | 4.20 | −0.13 |
| 387 | C₂H₅COOCH(N⁺H₃)C₂H₄COOH | 3.85 | 3.76 | 0.08 |
| 388 | H₃N⁺CH(C₂H₄COOC₂H₅)COOH | 2.15 | 2.07 | 0.08 |
| 389 | HOOCCH₂N⁺H₂CH₂COOH | 2.54 | 2.47 | 0.07 |
| 390 | HOOCCH₂N⁺H(CH3)CH₂COOH | 2.17 | 1.92 | 0.24 |
| 391 | C₆H₅N(CH₂COOH)₂ | 2.42 | 2.47 | −0.05 |
| 392 | C₆H₅N(CH₂COO⁻)CH₂COOH | 5.03 | 4.86 | 0.17 |
| 393 | N⁺H(CH₂COO⁻)(CH₂COOH)CH₂COOH | 2.94 | 2.61 | 0.33 |
| 394 | HOOCC₂H₄N⁺H₂CH₂COOH | 3.58 | 3.35 | 0.22 |
| 395 | HOOCC₂H₄N⁺H₂C₂H₄COOH | 4.06 | 3.62 | 0.44 |
| 396 | HOOCC₂H₄N(CH₂COOH)C₂H₄N⁺H(C₂H₄COOH)CH₂ | 2.97 | 2.29 | 0.67 |
| | COOH | | | |
| 397 | HOOCC₂H₄N(CH₂COO⁻) | 3.76 | 3.22 | 0.54 |
| | C₂H₄N⁺H(C₂H₄COOH)CH₂COOH | | | |
| 398 | HOOCC₂H₄N(CH₂COO⁻)C₂H₄N⁺H(CH₂COO⁻) | 5.76 | 4.83 | 0.93 |
| | C₂H₄COOH | | | |
| 399 | (HOOCC₂H₄)₂NC₂H₄N⁺H(C₂H₄COOH)C₂H₄COOH | 2.97 | 3.30 | −0.33 |
| 400 | HOOCC₂H₄(⁻OOCC₂H₄) | 3.40 | 3.23 | 0.16 |
| | NC₂H₄N⁺H(C₂H₄COOH)C₂H₄COOH | | | |
| 401 | CH₃C(O)COOH | 2.49 | 3.24 | −0.75 |
| 402 | CH₃C(O)CH₂COOH | 3.63 | 4.15 | −0.52 |
| 403 | CH₃C(O)C₂H₄COOH | 4.71 | 4.46 | 0.25 |
| 404 | CH₃C(O)CH₂C(O)COOH | 2.59 | 3.04 | −0.45 |
| 405 | CH₃C(O)C₃H₆COOH | 4.76 | 4.47 | 0.29 |
| 406 | HOOCCH₂C(O)COOH | 2.55 | 2.89 | −0.34 |
| 407 | ⁻OOCC(O)CH₂COOH | 4.37 | 4.37 | 0.00 |
| 408 | C₆H₄(2-F)OCH₂COOH) | 3.09 | 3.28 | −0.19 |
| 409 | C₆H₄(3-F)OCH₂COOH | 3.08 | 3.28 | −0.20 |
| 410 | C₆H₄(4-F)OCH₂COOH | 3.13 | 3.29 | −0.16 |
| 411 | C₆H₄(2-Cl)OCH₂COOH | 3.05 | 2.96 | 0.09 |
| 412 | C₆H₄(3-Cl)OCH₂COOH— | 3.07 | 3.11 | −0.04 |
| 413 | C₆H₄(4-Cl)OCH₂COOH | 3.10 | 3.16 | −0.06 |
| 414 | C₆H₃(2-CH₃, 4-Cl)OCH₂COOH | 3.28 | 3.29 | 0.00 |
| 415 | C₆H₂(2-CH₃, 4-Cl, 6-Cl)OCH₂COOH | 3.13 | 2.83 | 0.30 |
| 416 | C₆H₃(2-Cl, 4-Cl)OCH₂COOH | 3.18 | 3.41 | −0.23 |
| 417 | C₆H₄(2-Br)OCH₂COOH | 3.12 | 2.84 | 0.29 |
| 418 | C₆H₄(3-Br)OCH₂COOH | 3.10 | 3.09 | 0.01 |
| 419 | C₆H₄(4-Br)OCH₂COOH | 3.13 | 3.14 | −0.01 |
| 420 | C₆H₄(2-I)OCH₂COOH | 3.17 | 2.84 | 0.34 |
| 421 | C₆H₄(3-I)OCH₂COOH | 3.13 | 3.17 | −0.04 |
| 422 | C₆H₄(4-I)OCH₂COOH | 3.16 | 3.22 | −0.06 |
| 423 | C₆H₄(2-CN)OCH₂COOH | 2.97 | 3.28 | −0.31 |
| 424 | C₆H₄(3-CN)OCH₂COOH | 3.03 | 2.92 | 0.12 |
| 425 | C₆H₄(4-CN)OCH₂COOH | 2.93 | 3.04 | −0.11 |
| 426 | C₆H₄(2-NO₂)OCH₂COOH | 2.90 | 2.82 | 0.07 |
| 427 | C₆H₄(3-NO₂)OCH₂COOH | 2.95 | 3.14 | −0.19 |
| 428 | C₆H₄(4-NO₂)OCH₂COOH | 2.89 | 3.20 | −0.30 |
| 429 | C₆H₃(3-NO₂, 4-Cl)OCH₂COOH | 2.96 | 2.95 | 0.01 |
| 430 | CH₃CH(OH)C(O)OCH(CH₃)COOH | 2.98 | 3.04 | −0.07 |
| 431 | ClCH₂CH(OH)COOH | 3.12 | 3.00 | 0.12 |
| 432 | CH₃CH(OH)CH(Cl)COOH | 2.59 | 2.80 | −0.21 |
| 433 | CH₃CH(Cl)CH(OH)COOH | 3.08 | 3.10 | −0.02 |
| 434 | ClCH₂C(CH3)(OH)COOH | 3.20 | 3.55 | −0.35 |
| 435 | HOOCCH(Cl)CH(OH)COOH | 2.32 | 2.00 | 0.32 |
| 436 | CH₃C(O)OC(CH₂COOH)₂COOH | 2.49 | 2.23 | 0.26 |
| 437 | C₆H₅CH(OH)CH(Cl)COOH | 2.61 | 2.41 | 0.20 |
| 438 | (57) | 1.95 | 3.28 | −1.33 |
| 439 | (58) | 3.29 | 4.14 | −0.84 |
| 440 | (59) | 1.97 | 2.19 | −0.22 |
| 441 | (60) | 3.99 | 4.44 | −0.45 |
| 442 | H₂NC(O)CH₂COOH | 3.64 | 3.88 | −0.24 |
| 443 | H₂NC(O)C₂H₄COOH | 4.54 | 4.16 | 0.38 |
| 444 | H₂NC(O)C₃H₆COOH | 4.60 | 4.38 | 0.22 |
| 445 | H₂NC(O)C₄H₈COOH | 4.63 | 4.43 | 0.20 |
| 446 | C₆H₁₁(cyclo)SCH₂COOH | 3.49 | 3.92 | −0.43 |
| 447 | HOOCCH₂SCH₂COOH | 3.35 | 3.41 | −0.06 |
| 448 | ⁻OOCCH₂SCH₂COOH | 4.57 | 4.47 | 0.10 |
| 449 | HOOCCH₂SSCH₂COOH | 3.12 | 3.14 | −0.01 |
| 450 | ⁻OOCCH₂SSCH₂COOH | 4.27 | 4.00 | 0.27 |
| 451 | HOOCCH₂SCH₂SCH₂COOH | 3.36 | 3.48 | −0.12 |
| 452 | ⁻OOCCH₂SCH₂SCH₂COOH | 4.41 | 4.09 | 0.33 |
| 453 | HOOCCH₂SC₂H₄SCH₂COOH | 3.43 | 3.48 | −0.05 |
| 454 | ⁻OOCCH₂SC₂H₄SCH₂COOH | 4.42 | 4.06 | 0.36 |
| 455 | HOOCCH₂SC₃H₆SCH₂COOH | 3.48 | 3.75 | −0.26 |
| 456 | ⁻OOCCH₂SC₃H₆SCH₂COOH | 4.45 | 4.27 | 0.19 |
| 457 | HOOCCH₂SC₄H₈SCH₂COOH | 3.51 | 3.62 | −0.11 |
| 458 | ⁻OOCCH₂SC₄H₈SCH₂COOH | 4.49 | 4.24 | 0.26 |
| 459 | HOOCCH₂SC₅H,₀SCH₂COOH | 3.53 | 3.89 | −0.36 |
| 460 | ⁻OOCCH₂SC₅H₁₀SCH₂COOH | 4.48 | 4.20 | 0.29 |
| 461 | HOOCCH(CH₃)SCH₂COOH | 4.61 | 3.96 | 0.65 |
| 462 | CH₃SCH(CH₃)COOH | 3.76 | 3.98 | −0.22 |
| 463 | C₂H₅SCH(CH₃)COOH | 3.80 | 4.06 | −0.27 |
| 464 | C₃H₇SCH(CH₃)COOH | 3.82 | 4.12 | −0.30 |
| 465 | Iso-C₃H₇SCH(CH₃)COOH | 3.78 | 4.18 | −0.40 |
| 466 | ⁻OOCCH(CH₃)SCH(CH₃)COOH rac | 4.69 | 4.58 | 0.11 |
| 467 | ⁻OOCCH(CH₃)SCH(CH₃)COOH meso | 4.64 | 4.40 | 0.24 |
| 468 | HOOCCH(CH₃)SSCH(CH₃)COOH rac | 3.15 | 3.94 | −0.79 |
| 469 | HOOCCH(CH₃)SSCH(CH₃)COOH meso | 3.14 | 3.78 | −0.64 |
| 470 | HOOCCH(CH₃)SCH₂SCH(CH₃)COOH | 3.38 | 3.62 | −0.25 |
| 471 | HOOCC₂H₄SC₂H₄COOH | 4.09 | 3.98 | 0.11 |
| 472 | ⁻OOCC₂H₄SC₂H4COOH | 5.08 | 4.56 | 0.51 |
| 473 | ⁻OOCCH(C₂H₅)SCH(C₂H₅)COOH rac | 4.67 | 4.68 | 0.00 |
| 474 | ⁻OOCCH(C₂H₅)SCH(C₂H₅)COOH meso | 4.66 | 4.67 | −0.01 |
| 475 | HOOCC₃H₆SC₃H₆COOH | 4.42 | 4.44 | −0.02 |
| 476 | ⁻OOCC₃H₆SC₃H₆COOH | 5.33 | 4.63 | 0.70 |
| 477 | ⁻OOCCH(isoC₃H₇)SCH(isoC₃H₇)COOH rac | 4.87 | 4.96 | −0.09 |
| 478 | ⁻OOCCH(isoC₃H₇)SCH(isoC₃H₇)COOH meso | 4.92 | 4.84 | 0.08 |
| 479 | H₃N⁺C₂H₄SC₉H₁₈COOH | 4.00 | 4.81 | −0.81 |
| 480 | HOOCC₁₀H₂₀NHC₂H₄SSC₂H₄N⁺H₂C₁₀H₂₀COOH | 3.20 | 4.65 | −1.45 |
| 481 | CH₃SO₂CH(CH₃)COOH | 2.44 | 2.38 | 0.06 |
| 482 | C₂H₅SO₂CH(CH₃)COOH | 2.49 | 2.44 | 0.04 |
| 483 | C₃H₇SO₂CH(CH₃)COOH | 2.51 | 2.48 | 0.02 |
| 484 | Iso-C₃H₇SO₂CH(CH₃)COOH | 2.52 | 2.68 | −0.16 |
| 485 | C₆H₁₀(cyclo)SeCH₂COOH | 3.19 | 3.19 | 0.00 |
| 486 | F₃CC₃H₆CN⁺H₃)COOH | 2.16 | 2.26 | −0.10 |
| 487 | F₃CCH(CH₃)CH₂CH(N⁺H₃)COOH | 2.05 | 2.06 | −0.01 |
| 488 | F₃CC₂H₄CH(N⁺H₃)COOH | 2.04 | 1.98 | 0.06 |
| 489 | F₃CCH(CH₃)CH(N⁺H₃)COOH | 1.54 | 1.90 | −0.36 |
| 490 | F₃CCH₂CH(N⁺H₃)COOH | 1.60 | 1.82 | −0.22 |
| 491 | F₃CCH(OH)CH(N⁺H₃)COOH | 1.55 | 1.31 | 0.24 |
| 492 | F₃CCH(NH₂)CH₂COOH | 2.76 | 2.91 | −0.16 |
| 493 | H₃N⁺CH(CH₂OH)COOH | 2.21 | 2.38 | −0.17 |
| 494 | (61) | 1.92 | 1.82 | 0.10 |
| 495 | HOOCCH₂CH(OH)CH(N⁺H₃)COOH | 2.32 | 1.90 | 0.43 |
| 496 | ⁻OOCCH(N⁺H₃)CH(OH)CH₂COOH | 4.24 | 4.00 | 0.23 |
| 497 | H₂⁺N═C(NH2)NH—O—C₂H₄CH(N⁺H₃)COOH | 2.50 | 2.42 | 0.08 |
| 498 | H₃⁺NOC₂H₄CH(N⁺H₃)COOH | 2.40 | 2.20 | 0.20 |
| 499 | HOOCCH(N⁺H₃)CH₂SSCH₂CH(N⁺H₃)COOH | 1.00 | 1.24 | −0.24 |
| 500 | ⁻OOCCH(N⁺H₃)CH₂SSCH₂CH(N⁺H₃)COOH | 2.10 | 2.10 | 0.00 |
| 501 | C₂H₅SCH₂CH(N⁺H₃)COOH | 2.03 | 1.94 | 0.09 |
| 502 | (CH₃)₃SiCH₂COOH | 5.22 | 5.07 | 0.15 |
| 503 | (CH₃)₃SiC₂H₄COOH | 4.91 | 5.14 | −0.23 |
| 504 | (CH₃)₃SiC₃H₆COOH | 4.89 | 5.04 | −0.15 |
| 505 | (CH₃)₃SiC₄H₈COOH | 4.96 | 5.19 | −0.22 |
| 506 | (CH₃)₃SiC₅H₁₀COOH | 5.06 | 5.34 | −0.28 |
| 507 | (CH₃)₃SiOSi(CH₃)₂CH₂COOH | 5.22 | 5.12 | 0.10 |
| 508 | C₆H₅Si(CH₃)₂CH₂COOH | 5.27 | 5.17 | 0.10 |
| 509 | C₆H₅CH₂COOH | 4.31 | 4.31 | 0.00 |
| 510 | C₆H₄(2-CH₃)CH₂COOH | 4.42 | 4.62 | −0.20 |
| 511 | C₆H₄(4-CH₃)CH₂COOH | 4.37 | 4.35 | 0.01 |
| 512 | C₆H₄(4-C₂H₅)CH₂COOH | 4.37 | 4.39 | −0.02 |
| 513 | C₆H₄(4-iso-C₃H₇)CH₂COOH | 4.39 | 4.35 | 0.04 |
| 514 | C₆H₄(4-t-C₄H₉)CH₂COOH | 4.42 | 4.48 | −0.06 |
| 515 | (C₆H₅)₂CHCOOH | 3.94 | 4.23 | −0.29 |
| 516 | (C₆H₅)₃CCOOH | 3.96 | 4.29 | −0.33 |
| 517 | Naphtyl-1-CH₂COOH | 4.24 | 4.30 | −0.06 |
| 518 | Naphtyl-2-CH₂COOH | 4.26 | 4.20 | 0.06 |
| 519 | C₆H₅C₂H₄COOH | 4.66 | 4.47 | 0.19 |
| 520 | C₆H₄(2-CH₃)C₂H₄COOH | 4.66 | 4.52 | 0.14 |
| 521 | C₆H₄(3-CH₃)C₂H₄COOH | 4.68 | 4.50 | 0.18 |
| 522 | C₆H₄(4-CH₃)C₂H₄COOH | 4.68 | 4.50 | 0.19 |
| 523 | C₆H₅C₃H₆COOH | 4.76 | 4.55 | 0.21 |
| 524 | C₆H₅CH═CHCOOH trans | 4.44 | 4.30 | 0.14 |
| 525 | C₆H₅CH═CHCOOH cis | 3.88 | 4.29 | −0.41 |
| 526 | C₆H₅(2-CH₃)CH═CHCOOH trans | 4.50 | 4.41 | 0.09 |
| 527 | C₆H₅(3-CH₃)CH═CHCOOH trans | 4.44 | 4.34 | 0.10 |
| 528 | C₆H₅(4-CH₃)CH═CHCOOH trans | 4.56 | 4.33 | 0.24 |
| 529 | C₆H₅CH(COOH)COOH | 2.58 | 2.48 | 0.10 |
| 530 | C₆H₅CH(COO⁻)COOH | 5.03 | 5.15 | −0.12 |
| 531 | C₆H₅CH(CH₂COOH)COOH | 3.78 | 3.56 | 0.22 |
| 532 | C₆H₅CH(COO⁻)CH₂COOH | 5.55 | 5.79 | −0.23 |
| 533 | C₆H₅CH₂CH(CH₂COOH)COOH | 4.16 | 3.97 | 0.19 |
| 534 | C₆H₅CH₂CH(COO⁻)CH₂COOH | 5.71 | 6.00 | −0.29 |
| 535 | (C₆H₅)2C(CH₂COOH)COOH | 3.09 | 3.36 | −0.27 |
| 536 | HOOCCH(C₆H₅)CH(C₆H₅)COOH rac | 3.58 | 3.87 | −0.30 |
| 537 | HOOCCH(C₆H₅)CH(C₆H₅)COOH meso | 3.48 | 3.99 | −0.51 |
| 538 | HOOCCH₂(C6H₅CH2)C(C6H₅)COOH | 3.74 | 4.20 | −0.47 |
| 539 | C₆H₅C(COO⁻)(CH₂C₆H₅)CH₂COOH | 6.58 | 6.95 | −0.37 |
| 540 | HOOCCH₂(C₆H₅CH₂)₂CCOOH | 4.01 | 4.39 | −0.38 |
| 541 | OOOC)C(CH₂C₆H5)₂CH₂COOH | 6.74 | 6.83 | −0.09 |
| 542 | HOOCCH₂(C₆H₅C₂H4)C(C₆H₅)COOH | 3.79 | 4.19 | −0.40 |
| 543 | C₆H₅C(COO⁻)(C₂H₄C6H₅)CH₂COOH | 6.61 | 6.13 | 0.48 |
| 544 | HOOCC₂H₄C(C₆H₅)₂COOH | 3.96 | 3.48 | 0.47 |
| 545 | (C₆H₅)₂C(COCr)C₂H₄COOH | 6.46 | 5.97 | 0.49 |
| 546 | HOOCC₃H₆C(C6H₅)₂COOH | 4.22 | 4.29 | −0.08 |
| 547 | (C₆H₅)₂C(COO⁻)C₃H₆COOH | 5.47 | 4.98 | 0.49 |
| 548 | HOOCCH₂CH(C₆H₅)CH(C₆H5)CH₂COOH | 4.22 | 4.46 | −0.24 |
| 549 | ⁻OOCCH₂CH(C₆H₅)CH(C₆H₅)CH₂COOH | 5.19 | 5.03 | 0.16 |
| 550 | HOOCC4H₈C(C₆H5)₂COOH | 4.33 | 4.37 | −0.04 |
| 551 | ⁻OOCC₄H₈C(C₆H₅)₂COOH | 5.46 | 4.91 | 0.54 |
| 552 | HOOCC₅H₁₀C(C₆H₅)₂COOH | 4.30 | 4.30 | 0.00 |
| 553 | ⁻OOCC₅H₁₀C(C₆H₅)₂COOH | 5.39 | 4.93 | 0.46 |
| 554 | HOOCC₆H₁₂C(C₅H₅)₂COOH | 4.33 | 4.37 | −0.05 |
| 555 | ⁻OOCC₆H₁₂C(C₅H₅)₂COOH | 5.40 | 4.96 | 0.44 |
| 556 | C₆H₅CH(Br)COOH | 2.21 | 2.58 | −0.37 |
| 557 | C₆H₄(4-F)CH₂COOH | 4.25 | 4.22 | 0.03 |
| 558 | C₆H₄(2-Cl)CH₂COOH | 4.07 | 3.84 | 0.22 |
| 559 | C₆H₄(3-Cl)CH₂COOH | 4.14 | 4.03 | 0.11 |
| 560 | C₆H₄(4-Cl)CH₂COOH | 4.19 | 4.02 | 0.17 |
| 561 | C₆H₄(2-Br)CH₂COOH | 4.05 | 3.80 | 0.25 |
| 562 | C₆H₄(4-Br)CH₂COOH | 4.19 | 3.99 | 0.20 |
| 563 | C₆H₄(2-I)CH₂COOH | 4.04 | 4.00 | 0.04 |
| 564 | C₆H₄(3-I)CH₂COOH | 4.16 | 4.12 | 0.04 |
| 565 | C₆H₄(4-I)CH₂COOH | 4.18 | 4.12 | 0.06 |
| 566 | C₆H₄(2-Cl)C₂H₄COOH | 4.58 | 4.09 | 0.49 |
| 567 | C₆H₄(3-Cl)C₂H₄COOH | 4.59 | 4.30 | 0.29 |
| 568 | C₆H₄(4-Cl)C₂H₄COOH | 4.61 | 4.31 | 0.30 |
| 569 | C₆H₅(2-Cl)—CH═CH—COOH trans | 4.23 | 3.90 | 0.33 |
| 570 | C₆H₅(3-Cl)—CH═CH—COOH trans | 4.29 | 4.06 | 0.24 |
| 571 | C₆H₅(4-Cl)—CH—CH—COOH trans | 4.41 | 4.12 | 0.29 |
| 572 | C₆H₅(2-Br)—CH═CH—COOH trans | 4.41 | 3.87 | 0.54 |
| 573 | C₆H₅CH₂C(CH₃)(CN)COOH | 2.29 | 2.32 | −0.03 |
| 574 | C₆H₅CH(OH)COOH | 3.41 | 3.78 | −0.37 |
| 575 | C₆H₅C(CH3)(OH)COOH | 3.60 | 4.02 | −0.42 |
| 576 | C₆H₅CH(OH)CH₂COOH | 4.47 | 4.13 | 0.34 |
| 577 | (C₆H₅)₂C(OH)COOH | 3.10 | 3.41 | −0.31 |
| 578 | C₅H₄(2-OH)—CH═CH—COOH trans | 4.61 | 4.07 | 0.54 |
| 579 | C₆H₄(3-OH)—CH═CH—COOH trans | 4.40 | 4.19 | 0.20 |
| 580 | C₆H₄(2-NO₂)CH₂COOH | 4.00 | 3.68 | 0.32 |
| 581 | C₆H₄(3-NO₂)CH₂COOH | 3.97 | 3.93 | 0.04 |
| 582 | C₆H4(4-NO₂)CH₂COOH | 3.85 | 4.11 | −0.26 |
| 583 | C₆H₃(2-NO₂, 4-NO₂)CH₂COOH | 3.50 | 3.20 | 0.30 |
| 584 | C₆H₄(2-NO₂)C2H₄COOH | 4.50 | 4.15 | 0.35 |
| 585 | C₆H₄(4-NO₂)C₂H₄COOH | 4.47 | 4.42 | 0.05 |
| 586 | C₆H₄(2-NO₂)CH═CHCOOH trans | 4.15 | 3.85 | 0.30 |
| 587 | C₆H₄(3-NO₂)CH═CHCOOH trans | 4.12 | 4.08 | 0.04 |
| 588 | C₆H₄(4-NO₂)CH═CHCOOH trans | 4.05 | 4.15 | −0.11 |
| 589 | C₆H₅CH₂CH(N⁺H₃)COOH | 2.16 | 2.16 | 0.00 |
| 590 | (62) | 2.38 | 2.26 | 0.11 |
| 591 | C₆H₄(4-OCH₃)CH₂COOH | 4.36 | 4.24 | 0.12 |
| 592 | C₆H₃(2-OCH₃, 3-OCH₃)CH₂COOH | 4.33 | 4.00 | 0.34 |
| 593 | C₆H₄(2-OCH₃)C₂H₄COOH | 4.80 | 4.43 | 0.37 |
| 594 | C₆H₄(3-OCH₃)C₂H₄COOH | 4.65 | 4.42 | 0.23 |
| 595 | C₆H₄(4-OCH₃)C₂H₄COOH | 4.69 | 4.42 | 0.27 |
| 596 | C₆H₄(2-OCH₃)CH═CHCOOH trans | 4.46 | 4.12 | 0.35 |
| 597 | C₆H₄(3-OCH₃)CH═CHCOOH trans | 4.38 | 4.18 | 0.19 |
| 598 | C₆H₄(4-OCH₃)CH═CHCOOH trans | 4.54 | 4.18 | 0.36 |
| 599 | C₆H₅CH₂SC₂H₄COOH | 4.53 | 4.24 | 0.30 |
| 600 | C₆H₅C₂H₄SCH₂COOH | 3.86 | 3.82 | 0.05 |
| 601 | C₆H₄(3-F)CH(OH)COOH | 4.24 | 3.82 | 0.42 |
| 602 | C₆H₄(3-Cl)CH(OH)COOH | 4.24 | 3.62 | 0.62 |
| 603 | C₆H₄(3-Br)CH(OH)COOH | 4.23 | 3.51 | 0.72 |
| 604 | C₆H₄(3-I)CH(OH)COOH | 4.26 | 3.61 | 0.65 |
| 605 | C₆H₄(2-F)CH₂CH(N⁺H₃)COOH | 2.13 | 1.96 | 0.17 |
| 606 | C₆H₄(3-F)CH₂CH(N⁺H₃)COOH | 2.10 | 2.21 | −0.11 |
| 607 | C₆H₄(4-F)CH₂CH(N⁺H₃)COOH | 2.13 | 2.13 | 0.00 |
| 608 | C₆H₄(2-Cl)CH₂CH(N⁺H₃)COOH | 2.23 | 1.78 | 0.45 |
| 609 | C₆H₄(3-Cl)CH₂CH(N⁺H₃)COOH | 2.17 | 2.05 | 0.12 |
| 610 | C₆H₄(4-Cl)CH₂CH(N+H₃)COOH | 2.08 | 2.01 | 0.07 |
| 611 | (63) | 2.20 | 2.08 | 0.12 |
| 612 | C₆H₃(3-OH, 4-OH)CH₂CH(N⁺H₃)COOH | 2.32 | 1.96 | 0.36 |
| 613 | C₆H₂(3-I, 4-I, 5-I)CH₂CH(N⁺H₃)COOH | 2.12 | 1.81 | 0.31 |
| 614 | 1-Naphtyl-C(O)C₂H₄COOH | 4.48 | 4.22 | 0.26 |
| 615 | 2-Naphtyl-C(O)C₂H₄COOH | 4.96 | 4.21 | 0.75 |
| 616 | C₆H₄(4-NHSO₂OH)CH₂CH(N⁺H₃)COOH | 1.99 | 1.82 | 0.17 |
| 617 | H₃CO(O)CC(C₆H₅)₂CH₂COOH | 4.52 | 4.03 | 0.48 |
| 618 | H₃CO(O)CC(C₆H₅)₂COOH | 3.95 | 3.65 | 0.30 |
| 619 | H₃CO(O)CC(C₆H₅)₂C₂H₄COOH | 4.71 | 4.32 | 0.39 |
| 620 | H₃CO(O)CC₂H₄C(C₆H₅)₂COOH | 4.05 | 4.21 | −0.16 |
| 621 | H₃CO(O)CC(C₆H₅)₂C₃H₆COOH | 4.89 | 4.47 | 0.42 |
| 622 | H₃CO(O)CC₃H₆C(C₆H₅)₂COOH | 4.31 | 4.31 | 0.00 |
| 623 | H₃CO(O)CC(C₆H₅)₂C₄H₈COOH | 5.04 | 4.56 | 0.48 |
| 624 | H₃CO(O)CC₄H₈C(C₆H₅)₂COOH | 4.45 | 4.43 | 0.03 |
| 625 | H₃CO(O)CC(C₆H₅)₂C₅H₁₀COOH | 5.15 | 4.50 | 0.65 |
| 626 | H₃CO(O)CC₅H₁₀C(C₆H₅)₂COOH | 4.55 | 4.48 | 0.07 |
| 627 | C₆H₅CH(COOCH₃)CH₂COOH | 4.41 | 4.12 | 0.28 |
| 628 | C₆H₅CH(CH₂COOCH₃)COOH | 4.10 | 3.85 | 0.25 |
| 629 | H₃COC(O)C(C₆H₅)(CH₂C₆H₅)CH₂COOH | 4.51 | 4.16 | 0.34 |
| 630 | H₃COC(O)CH₂C(C₆H₅)(CH₂C₆H₅)COOH | 4.11 | 4.18 | −0.07 |
| 631 | H₃COC(O)C(CH₂C₆H₅)₂CH₂COOH | 4.71 | 4.34 | 0.37 |
| 632 | H₃COC(O)CH₂C(CH₂C₆H₅)₂COOH | 4.53 | 4.56 | −0.03 |
| 633 | H₃N⁺CH(CH₃)C(O)NHCH(CH₃)COOH | 3.30 | 3.08 | 0.22 |
| | LL | | | |
| 634 | H₃N+CH(CH₃)C(O)NHCH(CH₃)COOH | 3.12 | 3.10 | 0.02 |
| | LD | | | |
| 635 | H₃N⁺CH(CH₃)C(O)NHCH(CH₃)C(O)NHCH(CH₃)CO | 3.39 | 3.40 | −0.01 |
| | OH LLL | | | |
| 636 | H₃N⁺CH(CH₃)C(O)NHCH(CH₃)C(O)NHCH(CH₃)CO | 3.37 | 3.14 | 0.23 |
| | OH LLD | | | |
| 637 | H₃N⁺CH(CH₃)C(O)NHCH(CH₃)C(O)NHCH(CH₃)CO | 3.31 | 3.31 | 0.00 |
| | OH LDL | | | |
| 638 | H₃N⁺CH(CH₃)C(O)NHCH(CH₃)C(O)NHCH(CH₃)CO | 3.37 | 3.43 | −0.06 |
| | OH DLL | | | |
| 639 | H₃N⁺CH(CH₃)C(O)NHCH(CH₃)C(O)NHCH(CH₃)CO | 3.39 | 3.28 | 0.11 |
| | OH DDD | | | |
| 640 | H₃N⁺CH(CH₃)C(O)[NHCH(CH₃)C(O)]₂NHCH(CH₃)C | 3.42 | 3.45 | −0.03 |
| | OOH LLLL | | | |
| 641 | H₃N⁺CH(CH₃)C(O)[NHCH(CH₃)C(O)]₂NHCH(CH₃)C | 3.24 | 3.31 | −0.07 |
| | OOH LLDL | | | |
| 642 | H₃N⁺CH(CH₃)C(O)[NHCH(CH₃)C(O)]₂NHCH(CH₃)C | 3.22 | 3.48 | −0.26 |
| | OOH LDLL | | | |
| 643 | H₃N⁺CH(CH₃)C(O)[NHCH(CH₃)C(O)]₂NHCH(CH₃)C | 3.42 | 3.56 | −0.14 |
| | OOH DLLL | | | |
| 644 | H₃N⁺CH(CH₃)C(O)NHCH(C₄H₈N⁺H₃)C(O)NHCH | 3.15 | 3.32 | −0.17 |
| | (CH₃)COOH DDD | | | |
| 645 | H₃N⁺CH(CH₃)C(O)NHCH(C₄H₈N⁺H₃)C(O)NHCH | 3.33 | 3.00 | 0.33 |
| | (CH₃)COOH LDL | | | |
| 646 | H₃N⁺CH(CH₃)C(O)NHCH(C4H8N⁺H₃)C(O)NHCH | 3.29 | 2.99 | 0.30 |
| | (CH₃)COOH LLD | | | |
| 647 | H₃N⁺CH(CH₃)CONHCH(C₄H₈N⁺H₃)CONHCH(CH₃) | 3.58 | 3.39 | 0.19 |
| | CONHCH(CH₃)COOH LLLL | | | |
| 648 | H₃N⁺CH(CH₃)CONHCH(C₄H₈N⁺H₃)CONHCH(CH₃) | 3.32 | 3.37 | −0.05 |
| | CONHCH(CH₃)COOH LDLL | | | |
| 649 | H₃N⁺CH(CH₃)CONHCH(C₄H₈N⁺H₃)CO[NHCH(CH₃) | 3.53 | 3.18 | 0.35 |
| | CO]₂NHCH(CH₃)COOH LLLLL | | | |
| 650 | H₃N⁺CH(CH₃)CONHCH(C₄H₈N⁺H₃)CO[NHCH(CH₃) | 3.30 | 3.57 | −0.27 |
| | CO]₂NHCH(CH₃)COOH LDLLL | | | |
| 651 | H₃N⁺CH₂C(O)NHCH(CH₃)COOH | 3.15 | 3.02 | 0.13 |
| 652 | H₃N⁺CH₂C(O)NHCH(CH₃)C(O)NHCH(CH₃)COOH | 3.38 | 3.00 | 0.38 |
| | LL | | | |
| 653 | H₃N⁺CH₂C(O)NHCH(CH₃)C(O)NHCH(CH₃)COOH | 3.30 | 3.24 | 0.06 |
| | LD | | | |
| 654 | H₃N⁺CH(C4H₈N⁺H₃)C(O)NHCH(CH₃)C(O)NHCH | 3.22 | 2.97 | 0.25 |
| | (CH₃)COOH LL | | | |
| 655 | H₃N⁺CH(C₄H₈N⁺H₃)C(O)NHCH(CH₃)COOH | 3.00 | 2.97 | 0.03 |
| | LD | | | |
| 656 | H₃N⁺CH(CH₂OCH₃)COOH | 2.04 | 2.02 | 0.02 |
| 657 | H₃N⁺CH(CH(OH)CH₃)COOH | 2.11 | 2.24 | −0.13 |
| 658 | H₃N⁺CH(CH(OCH₃)CH₃)COOH | 1.92 | 1.89 | 0.03 |
| 659 | C₂H₅CH(NH₂)COOH | 2.29 | 2.37 | −0.09 |
| 660 | H₃N⁺CH(C₂H₅)C(O)HNCH(C₂H₅)COOH | 3.07 | 3.04 | 0.03 |
| 661 | H₃N⁺CH₂C(O)HNCH(C₂H₅)COOH | 3.15 | 3.58 | −0.42 |
| 662 | HON⁺H₂CH(C₂H₅)COOH | 2.71 | 2.70 | 0.01 |
| 663 | F₃CCH(N⁺H₃)CH₂COOH | 2.76 | 2.63 | 0.13 |
| 664 | H₃N⁺CH₂C(O)C₂H₄COOH | 4.05 | 3.93 | 0.12 |
| 665 | H₃CCH(N⁺H₃)C₂H₄COOH | 3.97 | 4.00 | −0.03 |
| 666 | C₆H₄(4-NH₂)CH₂COOH | 3.60 | 4.25 | −0.65 |
| 667 | H₃N⁺CH(CH₂C₆H₅)C(O)NHCH(C₃H₆NHC(NH₂)═ | 2.60 | 2.92 | −0.32 |
| | N⁺H₂)COOH LL | | | |
| 668 | H₃N⁺CH(CH₂C₆H₄(4- | 2.63 | 2.68 | −0.05 |
| | OH))C(O)NHCH(C₃H₆NHC(NH₂)═N⁺H₂)COOH LL | | | |
| 669 | H₃N⁺CH₂C(O)NHCH(CH₂C(O)NH₂)COOH | 2.94 | 2.71 | 0.23 |
| 670 | H₂NC(O)CH₂C(OH)(N⁺H₃)COOH | 2.28 | 2.20 | 0.08 |
| 671 | H₂NC(O)CH(OH)CH(N⁺H₃)COOH | 2.09 | 1.82 | 0.27 |
| 672 | H₃N⁺CH(iso-C₄H₉)C(O)NHCH(CH₂C(O)NH₂)COOH | 3.03 | 3.37 | −0.34 |
| | LL | | | |
| 673 | HOOCCH(CH₂COOH)NHC(O)CH(N⁺H₃)CH₂COOH | 2.70 | 2.99 | −0.29 |
| 674 | H₃N⁺CH(CH₂COO—)C(O)NHCH(CH₂COOH)COOH | 3.40 | 2.96 | 0.44 |
| 675 | H₃N⁺CH(CH₂COO—)C(O)NHCH(COO—)CH₂COOH | 4.70 | 4.86 | −0.16 |
| 676 | H₃N⁺CH₂C(O)NHCH(CH₂COOH)COOH | 2.81 | 2.66 | 0.15 |
| 677 | H₃N⁺CH₂C(O)NHCH(COO—)CH₂COOH | 4.45 | 4.26 | 0.19 |
| 678 | H₃N⁺CH(CH₂C(O)NH₂)COOH | 1.98 | 1.67 | 0.31 |
| 679 | HON⁺HCH(CH₂COOH)COOH | 1.91 | 1.69 | 0.22 |
| 680 | HON⁺HCH(COO⁻)CH₂COOH | 3.51 | 3.81 | −0.30 |
| 681 | (CH₃)₃N⁺CH₂COOH | 1.83 | 2.52 | −0.69 |
| 682 | H₂NC(O)NHOC₃H₆CH(N⁺H₃)COOH | 2.43 | 2.12 | 0.31 |
| 683 | H₂NC(═NH)N(CH₃)CH₂COOH | 2.63 | 3.20 | −0.57 |
| 684 | H₃N⁺CH(CH₂SH)COOH | 1.86 | 1.92 | −0.06 |
| 685 | H₃N⁺CH(CH₂SH)C(O)NHCH(CH₂SH)COOH | 2.65 | 2.41 | 0.24 |
| 686 | HOOCCH(N⁺H₃)CH₂SSCH₂CH(N⁺H₃)CONHCH(CO | 1.87 | 1.91 | −0.04 |
| | OH)CH₂SSCH₂CH(N⁺H₃)COOH | | | |
| 687 | HOOCCH(N⁺H₃)CH₂SSCH₂CH(N⁺H₃)CONHCH(CH₂ | 2.94 | 2.26 | 0.68 |
| | SSCH₂C(N⁺H₃)COO⁻)COOH | | | |
| 688 | H₃N⁺CH₂CONHCH₂CONHCH(COOH)CH₂SSCH₂CH | 2.71 | 2.61 | 0.10 |
| | (N⁺H₃)COOH | | | |
| 689 | H₃N⁺CH₂CONHCH₂CONHCH(CH₂SSCH₂CH(N⁺H₃) | 2.71 | 2.64 | 0.07 |
| | COO⁻)COOH | | | |
| 690 | H₃N⁺C₂H₄CH(N⁺H₃)COOH | 1.87 | 1.90 | −0.03 |
| 691 | H₃N⁺CH₂CH(N⁺H₃)COOH | 1.33 | 0.88 | 0.45 |
| 692 | HOOCCH(N⁺H₃)C₄H₈CH(N⁺H3)COOH | 1.86 | 2.07 | −0.21 |
| 693 | ⁻OOCCH(N⁺H₃)C₄H₈CH(N⁺H₃)COOH | 2.68 | 2.55 | 0.13 |
| 694 | H₃N⁺CH(C₂H₄COOH)COOH | 2.13 | 2.18 | −0.05 |
| 695 | H₃N⁺CH(COOH)C₂H₄COOH | 4.32 | 4.37 | −0.05 |
| 696 | H₃N⁺CH(C₂H₄COOH)C(O)NHCH(C₂H₄COOH)COOH | 3.14 | 3.31 | −0.17 |
| | DD | | | |
| 697 | H₃N⁺CH(C(O)NHCH(C₂H₄COOH)COO⁻)C₂H₄COOH | 4.38 | 4.52 | −0.14 |
| | DD | | | |
| 698 | HOOCCH₂CH(OH)CH(N⁺H₃)COOH | 2.27 | 1.76 | 0.51 |
| 699 | ⁻OOCCH(N⁺H₃)CH(OH)CH₂COOH | 4.29 | 4.03 | 0.26 |
| 700 | H₃N⁺CH(C₄H₈N⁺H₃)C(O)NHCH(C₂H₄COOH)COOH | 2.93 | 3.24 | −0.31 |
| 701 | H₃N⁺CH(C₄H₈N⁺H₃)C(O)NHCH(COOH)C₂H₄COOH | 4.47 | 4.89 | −0.42 |
| 702 | C₆H₅OC(O)C₂H₄CH(N⁺H₃)COOH | 2.17 | 2.24 | −0.07 |
| 703 | C₂H₅OC(O)CH(N⁺H₃)C₂H₄COOH | 3.85 | 3.74 | 0.11 |
| 704 | C₂H₅OC(O)C₂H₄CH(N⁺H₃)COOH | 2.15 | 2.28 | −0.13 |
| 705 | H₃N⁺CH(C₂H₄CONH2)COOH | 2.17 | 2.19 | −0.02 |
| 706 | H₃N⁺CH₂C(O)NHCH(C₂H₄CONH2)COOH | 2.93 | 3.28 | −0.35 |
| 707 | H₃N⁺CH(isoC₄H₉)C(O)NHCH(C₂H₄COOH)COOH | 2.99 | 3.41 | −0.42 |
| | LL | | | |
| 708 | HOOCCH₂NHC(O)CH(CH₂SH)NHC(O)C₂H₄NHCH | 2.12 | 1.93 | 0.19 |
| | (N⁺H₃)COOH | | | |
| 709 | H₃CHCCOO⁻) | 3.59 | 3.61 | −0.02 |
| | C₂H₄C(O)NHCH(CH₂SH)C(O)NHCH₂COOH | | | |
| 710 | H₃N⁺CH(COOH)C₂H₄CONHCH(CONHCH₂COOH)C | 2.02 | 2.53 | −0.51 |
| | H₂SSCH₂CH(CONHCH₂COOH)NHCOC₂H₄CH(N⁺H₃) | | | |
| | COOH | | | |
| 711 | H₃N⁺CH(COO)C₂H₄CONHCH(CONHCH₂COOH) | 2.62 | 2.47 | 0.15 |
| | CH₂SSCH₂CH(CONHCH₂COOH)NHCOC₂H₄CH | | | |
| | (N⁺H₃)COOH | | | |
| 712 | H₃N⁺CH(COO)C₂H₄CONHCH(CONHCH₂COOH) | 3.32 | 3.27 | 0.05 |
| | CH₂SSCH₂CH(NHCOC₂H₄CH(N⁺H₃)COO⁻) | | | |
| | CONHCH₂COOH | | | |
| 713 | H₃N⁺CH(COO)C₂H₄CONHCH(CONHCH₂COO)CH₂ | 4.02 | 4.00 | 0.03 |
| | SSCH₂CH(NHCOC₂H₄CH(N⁺H₃)COO⁻) | | | |
| | CONHCH₂COOH | | | |
| 714 | CH₃CONHCH₂COOH | 3.69 | 3.84 | −0.16 |
| 715 | H₃N⁺CH(CH₃)CONHCH₂COOH. | 3.17 | 3.39 | −0.22 |
| 716 | H₃N⁺CH(CH₃)CONHCH₂CONHCH₂COOH | 3.23 | 2.88 | 0.34 |
| 717 | H₃N⁺CH(CH₂CONH₂)CONHCH₂COOH L | 2.95 | 2.88 | 0.06 |
| 718 | H₃N⁺CH(CH₂COOH)CONHCH₂COOH L | 2.10 | 2.47 | −0.37 |
| 719 | H₃N⁺CH(CONHCH₂COO⁻)CH₂COOH L | 4.53 | 4.58 | −0.05 |
| 720 | (HOC₂H₄)₂NCH₂COOH | 2.48 | 2.05 | 0.43 |
| 721 | H₃N⁺CH(CH₂SH)C(O)NHCH₂C(O)NHCH₂COOH | 3.05 | 2.84 | 0.21 |
| 722 | H₃N⁺CH(CH₂SH)C(O)[NHCH₂C(O)]₃NHCH₂COOH | 3.14 | 2.59 | 0.55 |
| 723 | (C₂H₅)₂N⁺HCH₂COOH | 2.04 | 2.50 | −0.46 |
| 724 | (CH₃)₂N⁺HCH₂COOH | 2.08 | 2.29 | −0.21 |
| 725 | (CH₃)₂N⁺HCH₂CONHCH₂COOH | 3.11 | 2.80 | 0.31 |
| 726 | C₂H₅N⁺H₂CH₂COOH | 2.30 | 2.20 | 0.10 |
| 727 | H₃N⁺CH(C₂H₄CONH₂)C(O)NHCH₂COOH | 3.15 | 2.95 | 0.20 |
| 728 | H₃N⁺CH₂CONHCH₂COOH | 3.14 | 3.03 | 0.11 |
| 729 | H₃N⁺CH₂CO[NHCH(CH3)CO]₂NHCH₂COOH | 3.30 | 3.42 | −0.12 |
| 730 | H₃N⁺CH₂CONHCH₂CONHCH₂COOH | 3.23 | 3.41 | −0.19 |
| 731 | H₃N⁺CH₂CO[NHCH₂CO]₂NHCH₂COOH | 3.11 | 3.38 | −0.27 |
| 732 | H₃N⁺CH₂CONHCH(CH₂OH)CONHCH₂COOH | 3.23 | 3.10 | 0.13 |
| 733 | H₃N⁺CH₂CO[NHCH₂CO]₅NHCH₂COOH | 2.94 | 3.59 | −0.65 |
| 734 | (64) | 2.43 | 2.66 | −0.23 |
| 735 | Iso-C₃H₇N⁺H₂CH₂COOH | 2.36 | 2.45 | −0.09 |
| 736 | H₃N⁺CH(iso-C₄H9)CONHCH₂COOH | 3.25 | 3.67 | −0.42 |
| 737 | H₃N⁺CH(iso-C₄H₉)CONHCH₂CONHCH₂COOH | 3.28 | 3.54 | −0.26 |
| 738 | H₃CN⁺H₂CH(iso-C₄H₉)CONHCH₂COOH | 3.29 | 3.32 | −0.03 |
| 739 | H₃N⁺CH₂CO[NHCH₂CO]₄NHCH₂COOH | 3.17 | 3.48 | −0.32 |
| 740 | H₃N⁺CH(CH₂C₆H₅)CONHCH₂COOH | 3.13 | 2.65 | 0.48 |
| 741 | (65) | 3.19 | 3.05 | 0.14 |
| 742 | H₃CN⁺H₂CH₂CONHCH₂COOH | 3.14 | 3.00 | 0.14 |
| 743 | H₃N⁺CH(CH₂OH)CONHCH₂COOH | 3.10 | 2.98 | 0.12 |
| 744 | H₃N⁺CH₂CO[NHCH₂CO]₃NHCH₂COOH | 3.14 | 3.47 | −0.33 |
| 745 | H₃N⁺H₂CH(iso-C₃H₇)CONHCH₂COOH L | 3.23 | 3.34 | −0.11 |
| 746 | H₂NC(═N⁺H₂)NHCH₂COOH | 2.82 | 2.60 | 0.22 |
| 747 | (66) | 2.64 | 2.91 | −0.27 |
| 748 | (67) | 2.64 | 2.96 | −0.32 |
| 749 | (68) | 2.40 | 2.33 | 0.07 |
| 750 | (69) | 2.93 | 2.83 | 0.10 |
| 751 | (70) | 1.93 | 1.72 | 0.21 |
| 752 | (71) | 2.95 | 3.11 | −0.16 |
| 753 | (72) | 2.72 | 2.08 | 0.64 |
| 754 | (73) | 2.25 | 2.04 | 0.21 |
| 755 | (74) | ,1.65 | 1.61 | 0.04 |
| 756 | (75) | 1.84 | 1.65 | 0.19 |
| 757 | (76) | 2.00 | 1.87 | 0.13 |
| 758 | (77) | 1.73 | 1.83 | −0.11 |
| 759 | HSC₂H₄CH(NH₂)COOH | 2.22 | 2.24 | −0.02 |
| 760 | HOOCCH(N⁺H₃)C₂H₄SSC₂H₄CH(N⁺H₃)COOH | 1.59 | 2.09 | −0.50 |
| 761 | ⁻OOCCH(N⁺H₃)C₂H₄SSC₂H₄CH(N⁺H₃)COOH | 2.54 | 2.74 | −0.21 |
| 762 | HOOCCH₂NHN⁺H₂CH₂COOH | 2.42 | 1.96 | 0.46 |
| 763 | ⁻OOCCH₂N⁺H₂NHCH₂COOH | 3.16 | 2.58 | 0.57 |
| 764 | (78) | 2.96 | 2.86 | 0.10 |
| 765 | (79) | 4.25 | 4.26 | −0.01 |
| 766 | H₂NCOCH(N⁺H₃)CH₂COOH | 2.97 | 3.10 | −0.13 |
| 767 | H₂NC(═N⁺H₂)CH₂N(CH₃)COOH | 2.84 | 3.04 | −0.20 |
| 768 | H₂NCOCH(N+H₃)C₂H₄COOH | 3.81 | 3.52 | 0.29 |
| 769 | H₃N⁺CH(sec-C₄H₉)COOH | 2.32 | 2.54 | −0.22 |
| 770 | H₃N⁺CH(OH)COOH | 2.72 | 2.75 | −0.03 |
| 771 | H₃N⁺CH(iso-C₄H₉)C(O)NHCH(OH)COOH | 3.22 | 3.03 | 0.19 |
| 772 | H₃N⁺CH(iso-C₄H₉)COOH L | 2.33 | 2.54 | −0.21 |
| 773 | H₃N⁺CH₂C(O)NHCH(iso-C₄H₉)COOH L | 3.18 | 3.42 | −0.24 |
| 774 | H₃CN⁺H₂CH₂C(O)NHCH(iso-C₄H₉)COOH L | 3.15 | 3.66 | −0.51 |
| 775 | H₃N⁺CH(CH₂OH)CONHCH(iso-C₄H₉)COOH | 3.08 | 3.72 | −0.64 |
| | LL | | | |
| 776 | H₃N⁺CH(CH₂CH(CH₃)CF₃)COOH | 2.05 | 2.30 | −0.26 |
| 777 | H₃N⁺CH(C₄H₈N⁺H₃)COOH L | 2.16 | 2.40 | −0.24 |
| 778 | HON⁺H₂CH(C₄H₈N⁺H₃)COOH | 2.08 | 2.12 | −0.04 |
| 779 | H₃N⁺CH(C₄H₈N⁺H₃)CONHCH(C₄H₈N⁺H₃)COOH | 3.01 | 2.85 | 0.16 |
| | LL | | | |
| 780 | H₃N⁺CH(C₄H₈N⁺H₃)CONHCH(C₄H₈N⁺H₃)COOH | 2.85 | 2.80 | 0.05 |
| | LD | | | |
| 781 | H₃N⁺CH(C₄H₈N⁺H₃)CONHCH(C₄H₈N⁺H₃)CONHCH | 3.08 | 3.39 | −0.31 |
| | (C₄H₈N⁺H₃)COOH LLL | | | |
| 782 | H₃N⁺CH(C₄H₈N⁺H₃)CONHCH(C₄H₈N⁺H₃)CONHCH | 2.91 | 2.57 | 0.34 |
| | (C₄H₈N⁺H₃)COOH LDL | | | |
| 783 | H₃N⁺CH(C₄H₈N⁺H₃)CONHCH(C₄H₈N⁺H₃)CONHCH | 2.94 | 3.03 | −0.09 |
| | (C₄H₈N⁺H₃)COOH LDD | | | |
| 784 | H₃N⁺CH(C₂H₄SCH₃)COOH | 2.17 | 2.09 | 0.08 |
| 785 | H₃N⁺CH(C₂H₄SCH₃)CONHCH(C₂H₄SCH₃)COOH | 3.20 | 3.08 | 0.12 |
| | LL | | | |
| 786 | H₃N⁺C₃H₆CH(N⁺H₃)COOH | 1.71 | 2.08 | −0.37 |
| 787 | H₃N⁺CH(CH₂C6H₃(3-OH, 4-OH))COOH | 2.32 | 2.17 | 0.15 |
| 788 | H₃N⁺CH(CH₂C6H₃(2-F, 4-OCH₃))COOH | 2.12 | 2.21 | −0.09 |
| 789 | H₃N⁺CH₂C(O)NHCH(CH₂C₆H₅)COOH | 3.12 | 3.01 | 0.11 |
| 790 | H₃N⁺CH(C₆H₅)COOH | 1.83 | 2.17 | −0.34 |
| 791 | H₃N⁺CH(C₆H₄(3-C(O)CH₃))COOH | 1.14 | 1.93 | −0.79 |
| 792 | H₃N⁺CH(C₆H₄(3-Cl))COOH | 1.05 | 1.66 | −0.61 |
| 793 | H₃N⁺CH(C₆H₄(4-Cl))COOH | 1.46 | 1.62 | −0.16 |
| 794 | H₃N⁺CH(C₆H₄(3-CN))COOH | 0.28 | 1.33 | −1.05 |
| 795 | H₃N⁺CH(C₆H₄(3-OCH₃))COOH | 1.68 | 2.08 | −0.40 |
| 796 | H₃N⁺CH(C₆H₄(4-OCH₃))COOH | 2.08 | 1.79 | 0.29 |
| 797 | H₃N⁺CH(C₆H₄(3-CH₃))COOH | 1.89 | 2.02 | −0.13 |
| 798 | H₃N⁺CH(C₆H₄(4-CH₃))COOH | 1.97 | 1.94 | 0.03 |
| 799 | H₃N⁺CH(C₆H₄(3-NO₂))COOH | 0.06 | 1.54 | −1.48 |
| 800 | (80) | 1.95 | 1.97 | −0.01 |
| 801 | (81) | 3.04 | 2.81 | 0.23 |
| 802 | (82) | 2.81 | 2.98 | −0.17 |
| 803 | (83) | 1.82 | 2.20 | −0.38 |
| 804 | H₃CN⁺H₂CH₂COOH | 2.21 | 2.24 | −0.03 |
| 805 | H₃N⁺CH₂C(O)N(CH₃)CH₂COOH | 2.98 | 3.34 | −0.36 |
| 806 | H₃CN⁺H₂CH₂CON(CH₃)CH₂COOH | 2.89 | 2.75 | 0.14 |
| 807 | H₃N⁺CH(CH₂OH)COOH | 2.19 | 1.99 | 0.20 |
| 808 | H₃N⁺CH₂C(O)NH(CH₂OH)COOH | 2.98 | 2.99 | −0.01 |
| 809 | H₃N⁺CH(CH(CH₃)OH)COOH | 2.09 | 2.25 | −0.16 |
| 810 | H₃N⁺CH(CH(CH₃)OCH₃)COOH | 2.02 | 2.37 | −0.35 |
| 811 | H₃N⁺CH(CH(CF₃)OCH₃)COOH | 1.55 | 1.51 | 0.04 |
| 812 | H₃N⁺CH(CH₂C₆H₄(4-OH))COOH | 2.20 | 2.27 | −0.07 |
| 813 | H₃N⁺CH(CH₂COOH)C(0)NHCH(CH₂C₆H4(4- | 2.13 | 1.82 | 0.31 |
| | OH))COOH | | | |
| 814 | H₃N⁺CH(C(O)NHCH(CH₂C₆H4(4-OH)) | 3.57 | 3.49 | 0.08 |
| | COO⁻)CH₂COOH | | | |
| 815 | H₃N⁺CH(CH₂C₆H₂(4-OH, 3-Br, 5-Br))COOH | 2.17 | 2.20 | −0.03 |
| 816 | H₃N⁺CH(CH₂C₆H₂(4-OH, 3-Cl, 5-Cl))COOH | 2.12 | 2.25 | −0.13 |
| 817 | H₃N⁺CH(CH₂C₆H₂(4-OH, 3-I, 5-I))COOH | 2.12 | 2.48 | −0.36 |
| 818 | H₃N⁺CH₂C(O)NHCH(CH₂C₆H₄(4-OH))COOH | 2.98 | 2.95 | 0.03 |
| 819 | H₃N⁺CH(iso-C₄H9)C(0)NHCH(CH₂C₆H₄(4- | 2.87 | 3.23 | −0.36 |
| | OH))COOH DL | | | |
| 820 | H₃N⁺CH(CH₂C₆H₄(4-OCH₃))COOH | 2.21 | 2.20 | 0.01 |
| 821 | H₃N⁺CH(CH₂C₆H₄(4-OH))CONHCH(CH₂C₆H₄(4- | 3.52 | 3.30 | 0.22 |
| | OH))COOH | | | |
| 822 | H₃N⁺CH(iso-C₃H₇)COOH | 2.29 | 2.45 | −0.16 |
| 823 | H₃N⁺CH₂C(O)NHCH(iso-C₃H₇)COOH | 3.15 | 3.18 | −0.03 |
| 824 | HON⁺H₂CH(iso-C₃H₇)COOH | 2.55 | 2.33 | 0.22 |
| 825 | H₃N⁺CH(C(CH₃)₂SH)COOH | 2.00 | 2.15 | −0.15 |
| 826 | H₃N⁺CH(CH(CH₃)CF₃)COOH | 1.54 | 1.69 | −0.15 |

The numbers in the table correspond to the structures presented in scheme 1.

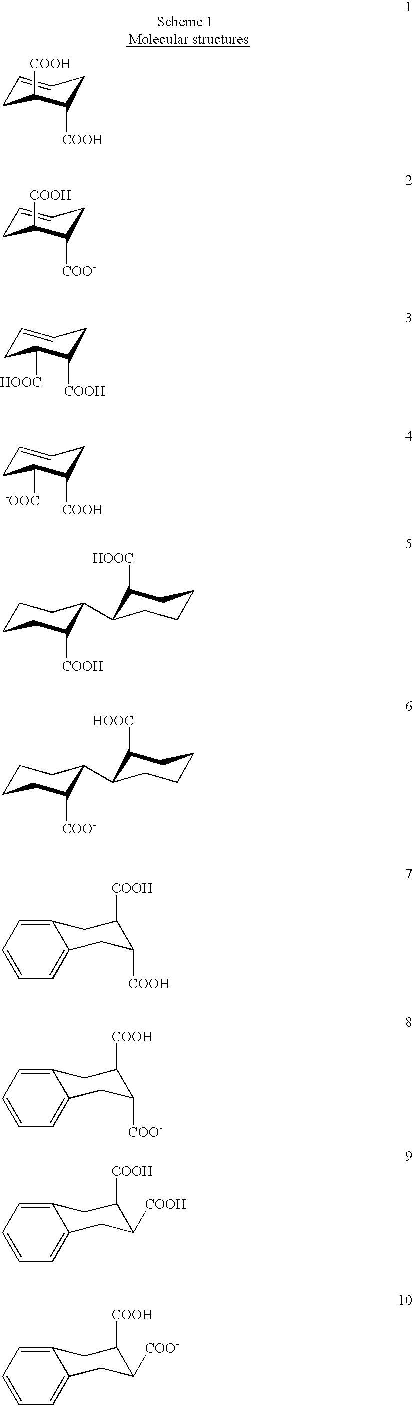

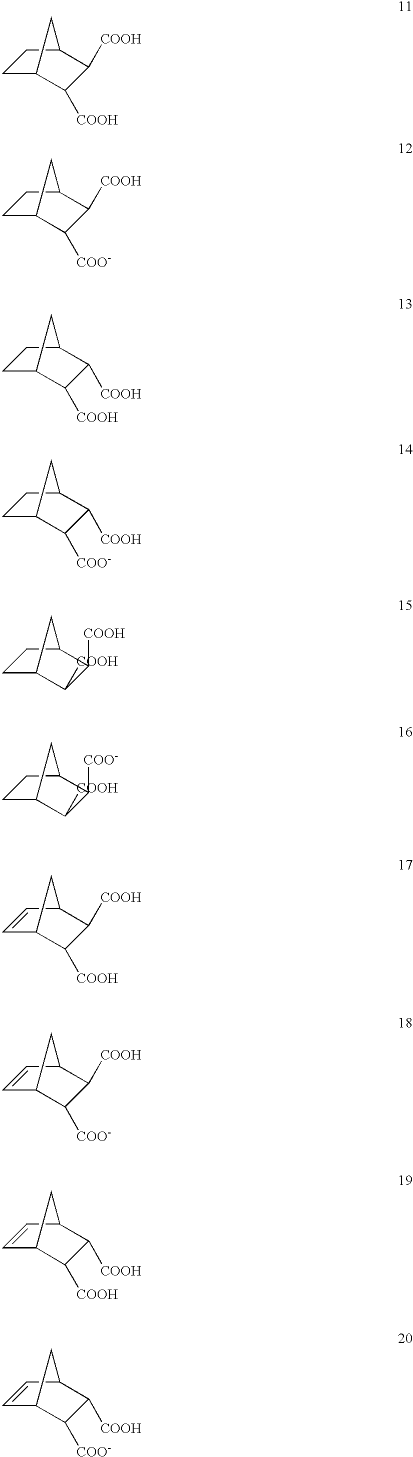

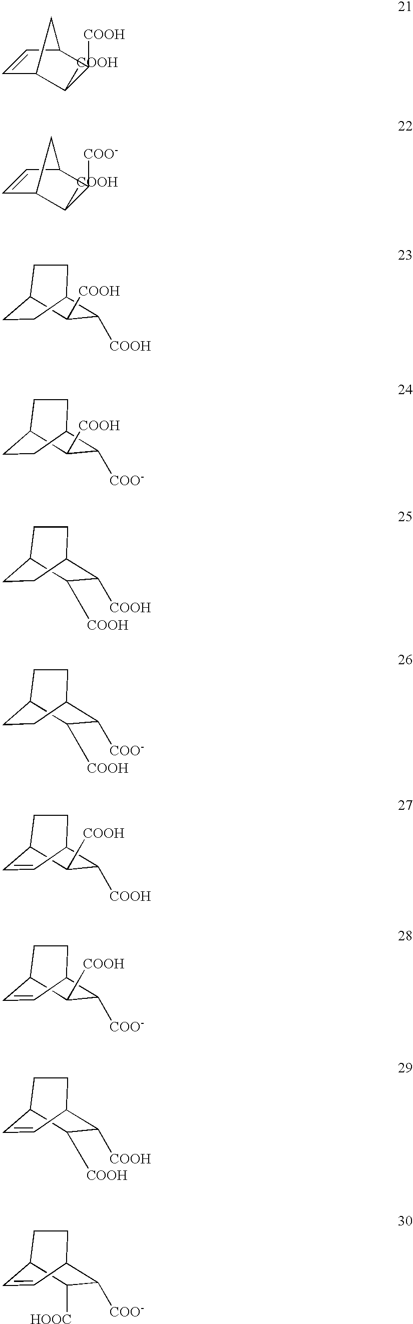

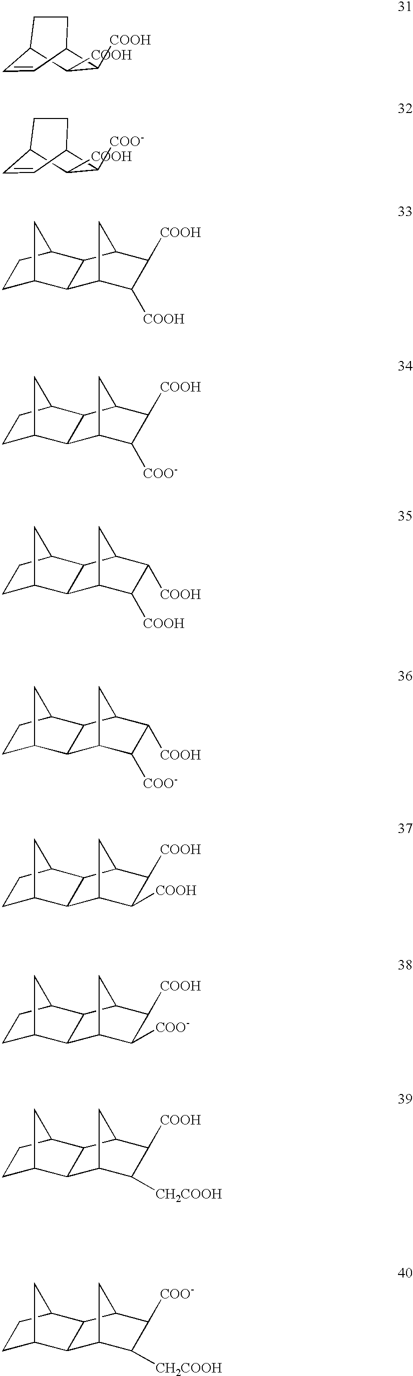

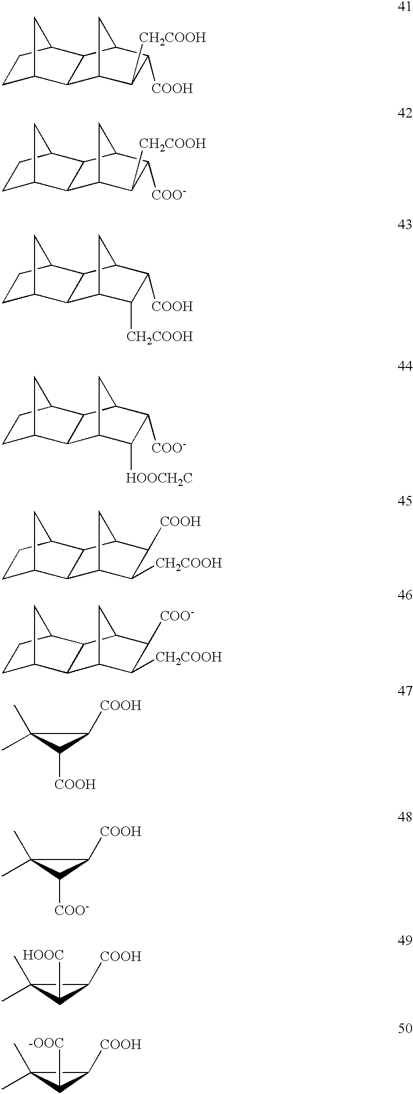

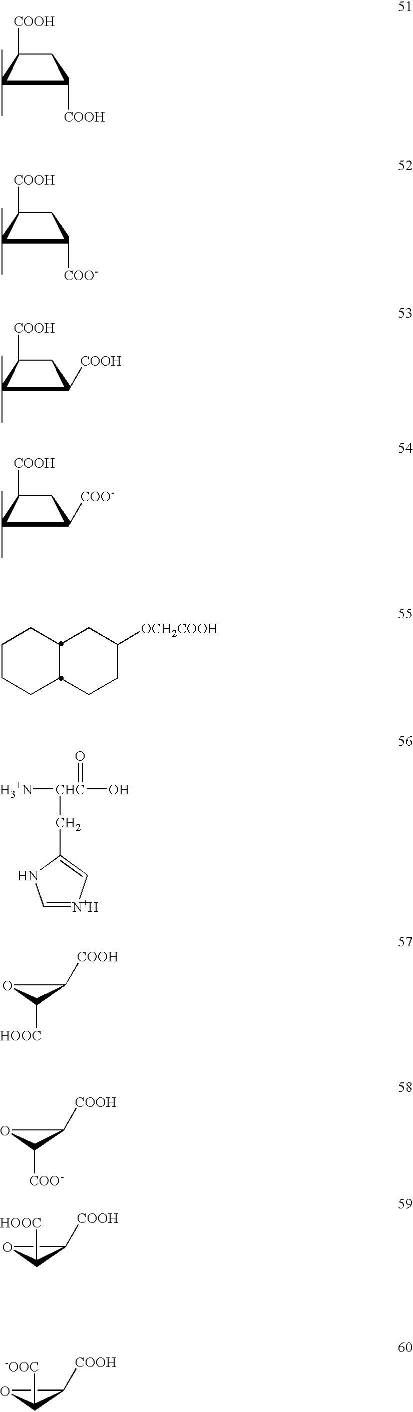

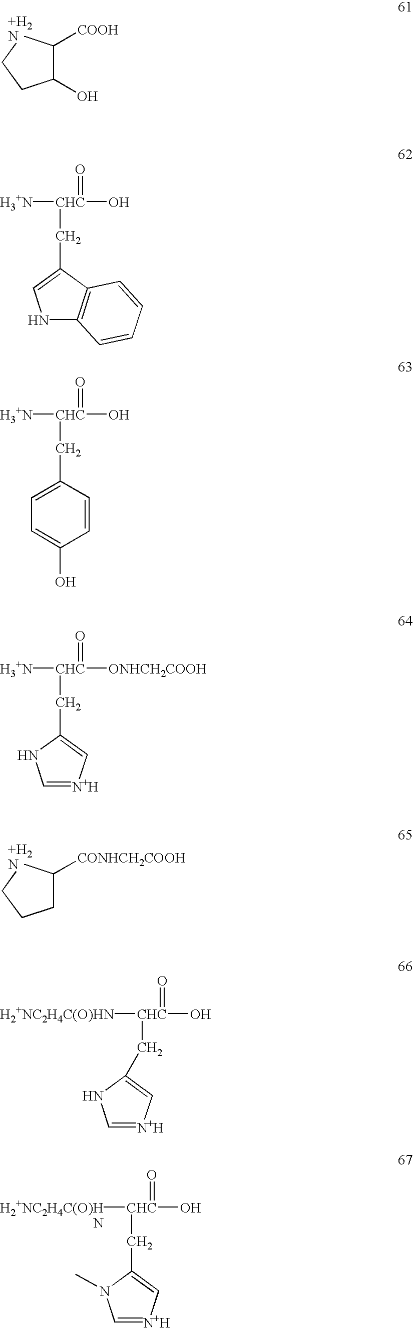

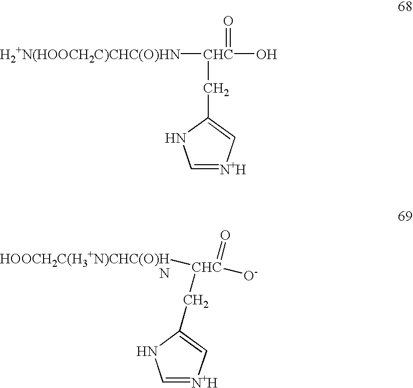

The estimated results demonstrate that the suggested approach allows for accurate quantitative interpretation dissociation constants of wide range of various carboxylic acids. The values of the estimated atomic operational contributions in equation above can be used for an accurate prediction of unknown pK values of molecules, constituted from the a variety of atom types presented in table 6 shown below.

TABLE 6
Operational atomic constants δᵢ^{a}ₑₛₜ and δᵢ^{b}ₑₛₜ, estimated from pK
parameters of carboxylic acids and protonated amines respectively, the corresponding
values, predicted by correlations and parameters of atomic “inductive” electronegativities
and radii, used in these correlations.

| | | | δᵢ^{a} | | δᵢ^{a} | δᵢ^{b} | | δᵢ^{b} |
|---|---|---|---|---|---|---|---|---|
| | χ | R(A⁰) | est | +/− | calc | est | +/− | calc |
| H | 2.10 | 0.30 | 0.95 | 0.17 | 0.15 | 0.76 | 0.06 | 0.22 |
| C4 | 2.10 | 0.77 | 0.48 | 0.24 | 0.99 | 0.08 | 0.04 | 1.48 |
| C3 | 2.25 | 0.67 | 0.56 | 0.20 | −0.23 | −2.54 | 0.27 | −1.05 |
| C2 | 2.65 | 0.60 | −5.07 | 1.25 | −4.88 | −8.66 | 0.45 | −11.26 |
| C ar | 2.45 | 0.67 | −0.45 | 0.11 | −1.56 | −2.46 | 0.11 | −4.01 |
| N3 | 2.56 | 0.70 | −3.34 | 0.33 | −2.45 | −5.15 | 0.26 | −6.03 |
| N1 | 6.76 | 0.55 | −18.24 | 2.55 | −19.95 | −42.00 | 1.34 | −44.56 |
| O2 | 3.05 | 0.66 | −5.61 | 0.25 | −5.28 | −9.54 | 0.24 | −12.22 |
| F | 3.93 | 0.64 | −2.88 | 0.28 | | −8.32 | 0.46 | |
| Cl | 3.09 | 0.99 | −12.59 | 0.55 | −12.44 | −23.77 | 0.31 | −28.75 |
| Br | 2.96 | 1.14 | −14.60 | 0.83 | −14.05 | −36.59 | 0.64 | −32.70 |
| I | 2.80 | 1.33 | −8.90 | 1.88 | | −16.52 | 4.67 | |
| S2 | 2.69 | 1.04 | −6.19 | 0.50 | −7.45 | −14.85 | 4.30 | −17.82 |
| Si | 2.06 | 1.11 | 2.86 | 1.49 | 2.77 | 1.36 | 0.84 | 4.65 |
| N+ | 4.33 | 0.70 | −20.33 | 0.42 | −15.04 | −41.29 | 0.72 | −33.91 |
| O− | 1.85 | 0.70 | 28.61 | 0.60 | | 9.44 | 0.46 | 5.19 |
| N2 | | | | | | 2.05 | 3.47 | |
| N2+ | | | −16.71 | 2.02 | −13.28 | −30.67 | 16.33 | |
| O1 | 4.60 | 0.62 | −6.25 | 0.32 | −13.30 | −9.82 | 0.71 | |
| S6 | | | −3.64 | 1.36 | | | | |
| Se | 2.54 | 1.17 | −16.30 | 3.69 | | | | |
| Nitro | | | −9.02 | 2.04 | | | | |

χ is electronegativity of the substituent part.

### Example 3

### Quantitative Assessment of pKa Values of Amines

It is a matter of common knowledge that the basicity of amines can be interpreted in terms of polar substituent constants. Numerous authors have proposed different linear free energy (LFER) equations describing limited series of basicity data for of primary-, secondary- and tertiary amines (Perrin, D. D.; Dempsey, B.; Seijeant, E. P. pKₐ Prediction for Organic Acids and Bases. Chapman & Hall, London: New York, 1981).

We have not separated experimental data into several reaction series and have considered the pK values of 802 different amines in which ionizing nitrogen was not engaged into conjugation interactions. The structures of organic amines have been optimized within MM+ routine of Hyperchem software package allowing simple estimation of the standard geometries in the gas phase.

We have assumed ionizable nitrogen as the reaction center, and composed [802×19] R-matrix for 802 compounds containing 19 types of substituent atoms. The following atomic types: H, C sp³, C sp², C sp, C_{aromatic}, N sp³, N sp², N sp (CN group), O sp², O sp³, F, Cl, Br, I, S, Si, N⁺, O⁻, N⁺sp² have been specified. Ionized carboxylic groups have been considered as having full negative charge on one of oxygens, while the other is in O sp² configuration. The columns of [802×19] R-matrix have been taken as the sets of independent variables. Values of pK-s, have been extrapolated to 25C and zero ionic strength (Perrin, D. D.; Dempsey, B.; Serjeant, E. P. pKₐ Prediction for Organic Acids and Bases. Chapman & Hall, London: New York, 1981 Perrin, D. D. Dissociation Constants of Organic Bases in Aqueous Solution; Butter Worth: London, 1965). When experimental details were insufficient, the corresponding pK values have been accepted as given (what in some cases might lead to uncertainties up to 0.1 pK units). Then corrected pKₐ parameters have been considered as dependent parameters of polynomial equation:

$${pK}_{{R}_{3} N} = {\sum }_{i}^{N - 1} \frac{{δ}_{i}^{b}}{{r}_{i}^{2}} + const$$

where N is the number of atoms in amine, δᵢ^{b} is introduced atomic operational parameter reflecting the ability of atoms of one type to contribute to amine's pKₐ

A multilinear regression was established based on the equation above, with high accuracy (Const=9.12 +/−0.19; N=802; R (mult)=0.9659; S=0.1819) that allows the usage of the estimated operational atomic parameters for amines basicity predictions:

$${pK}_{{R}_{3} N} = 9.12 + {\sum }_{i}^{N - 1} \frac{{δ}_{i}^{b}}{{r}_{i}^{2}}$$

The structures of the various amines are presented in Scheme 2.

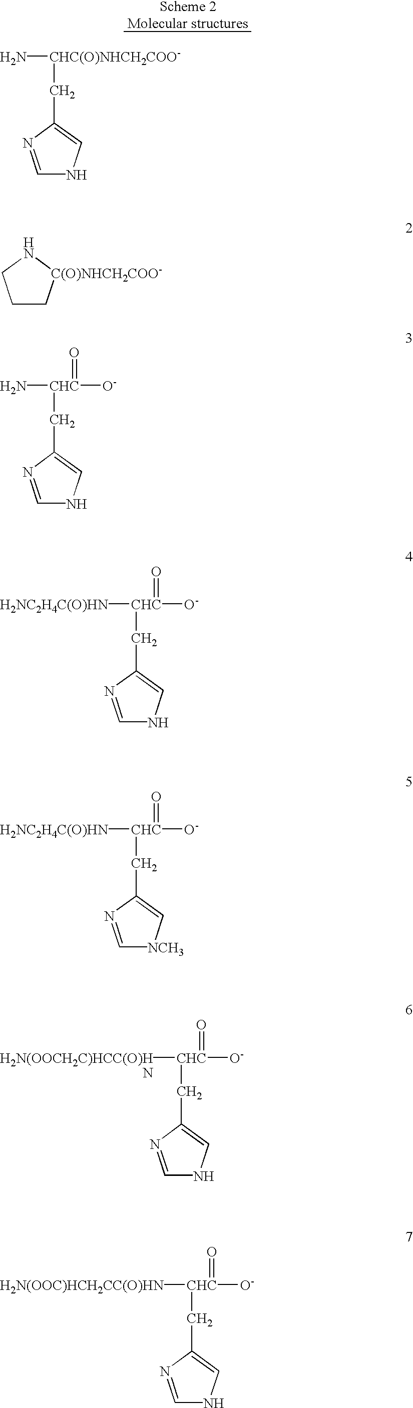

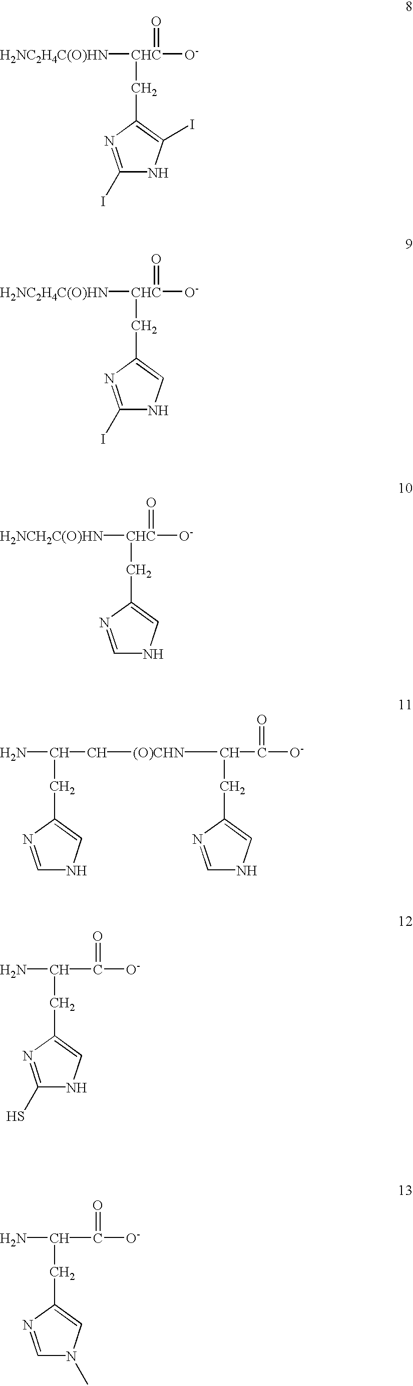

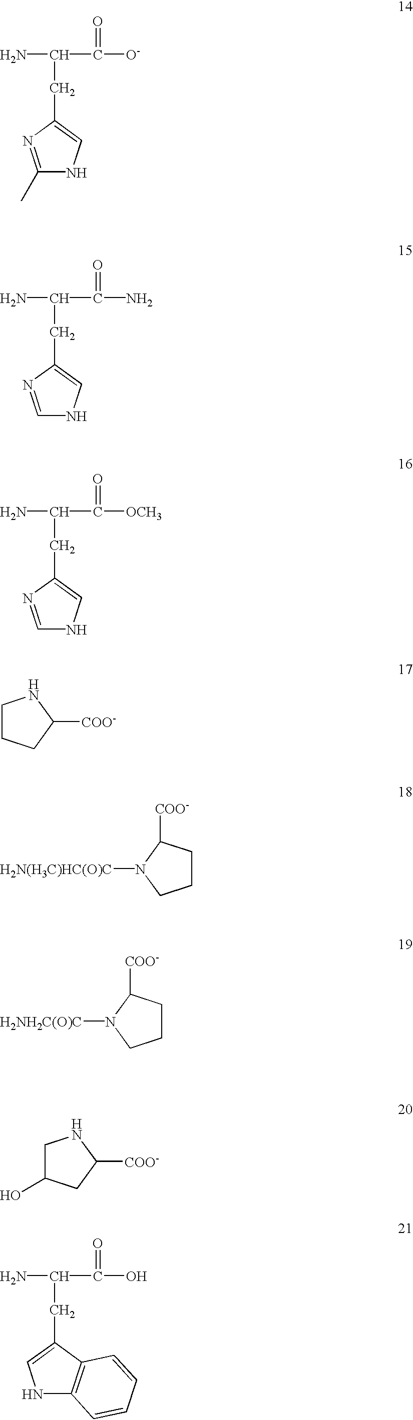

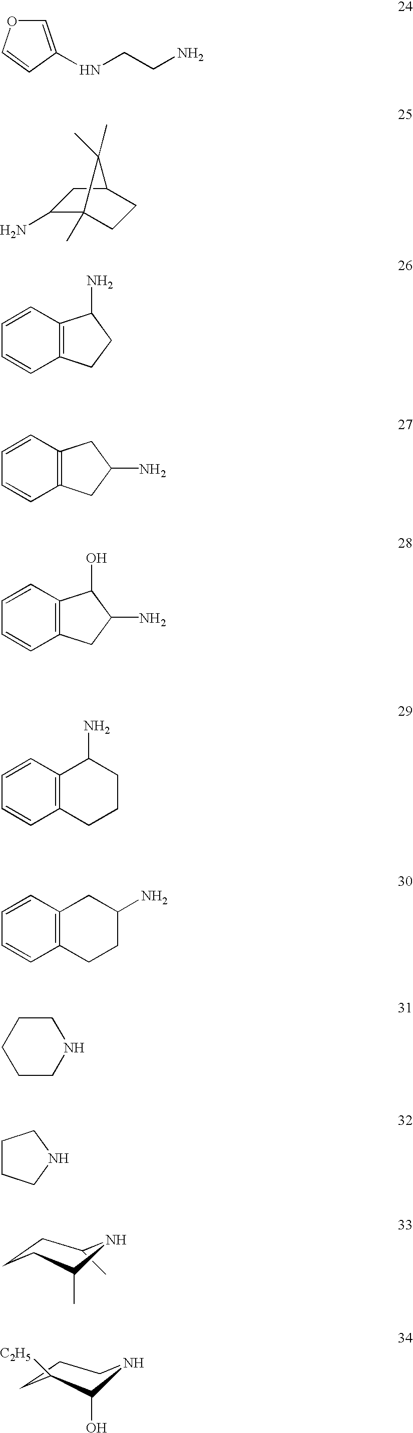

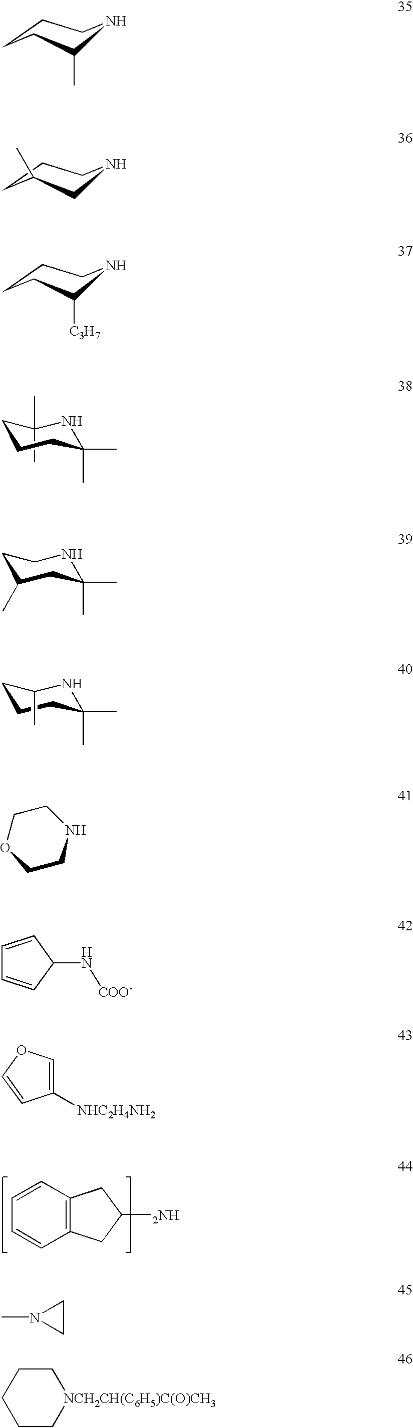

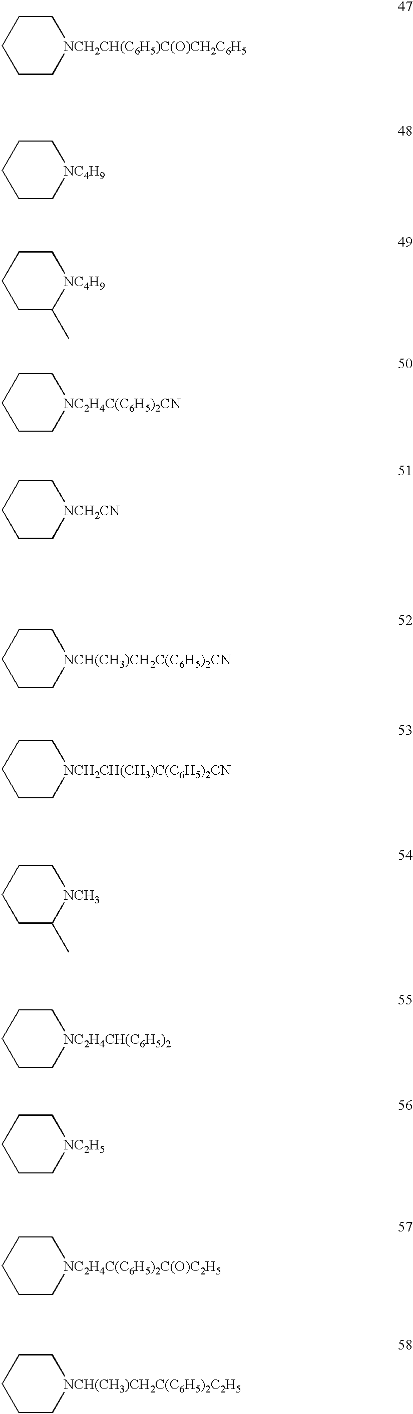

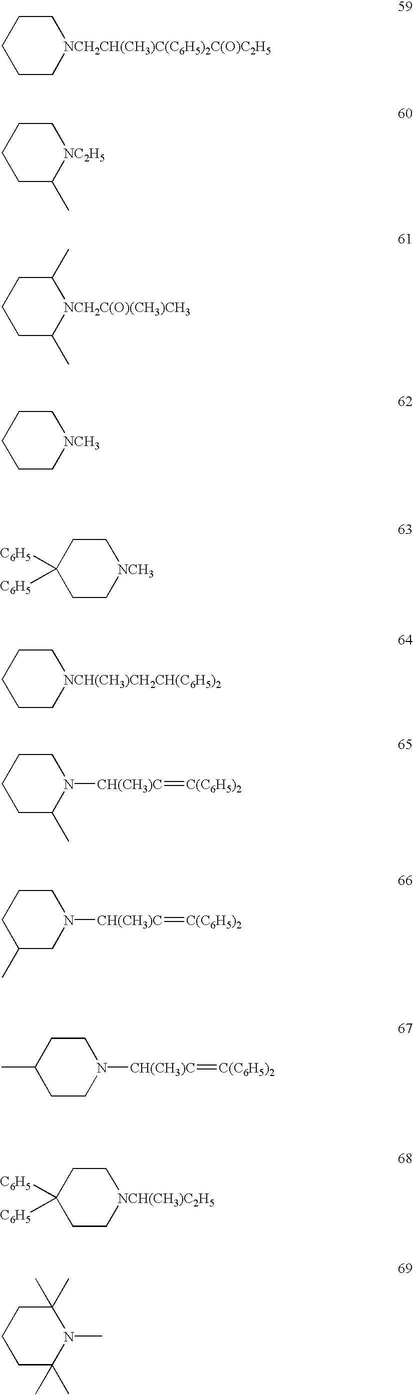

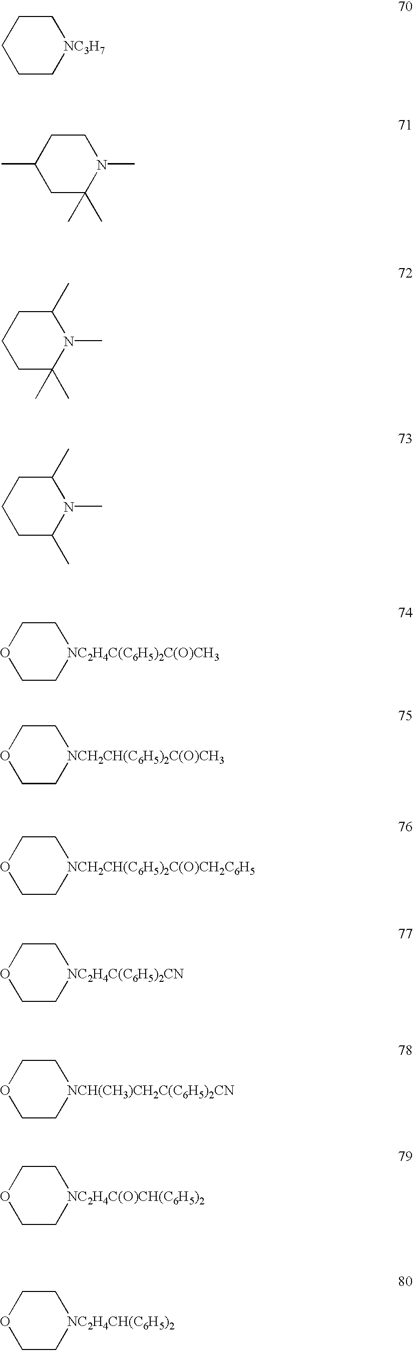

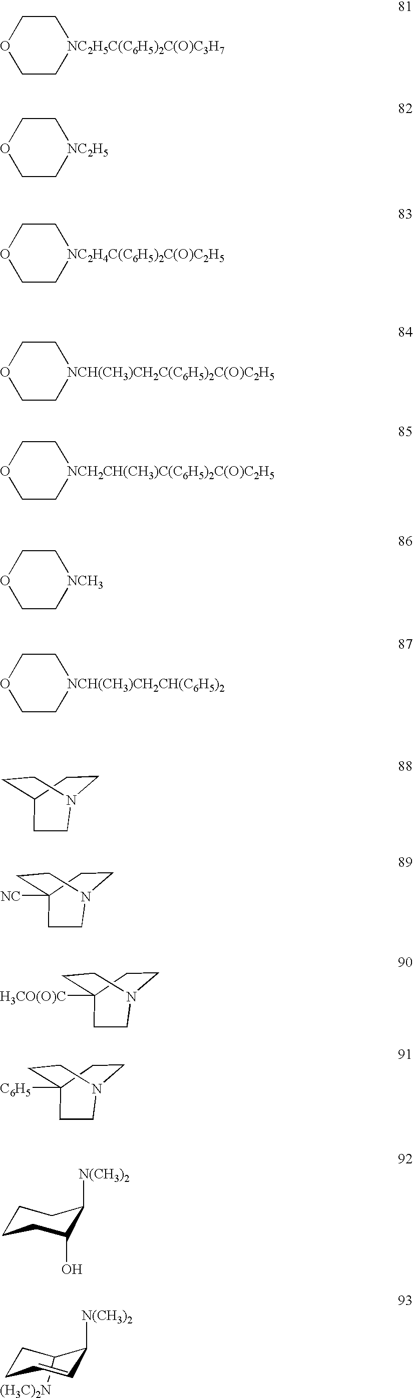

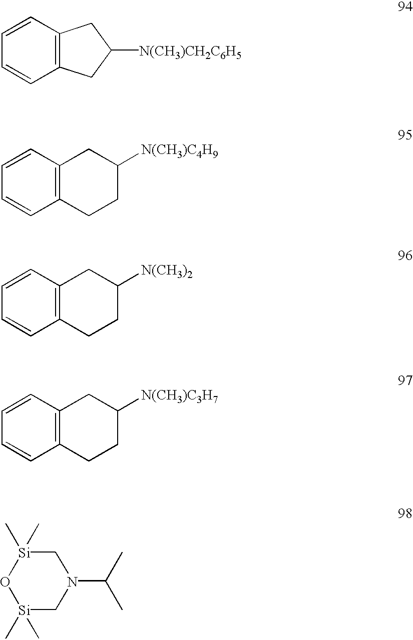

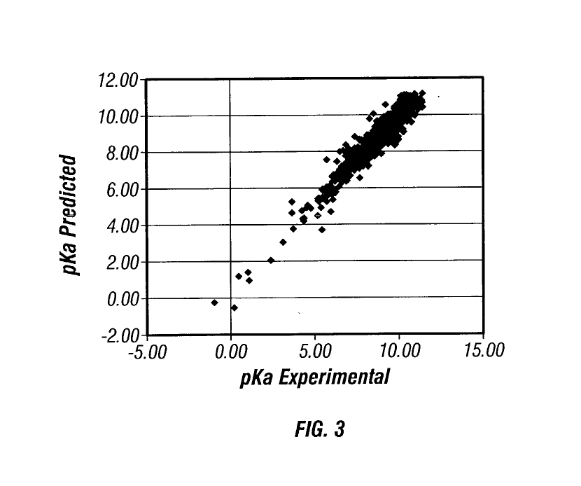

The estimated pKₐ-s of the amines are presented in Table 7 along with the corresponding experimental data. Interrelation between estimated and experimental pK values is presented graphically in FIG. 3. Operational atomic parameters δᵢ^{b} for 19 atomic types used, taken as the multiple coefficients of the equation above, are collected in Table 6 (example 2). The large uncertainties in the operational parameters δᵢ^{b} estimated for O sp², F and I are due to the lack of the data (column elements of the R-matrix) for these atoms, which lead to significant statistical deviations.

This data demonstrate that this approach allows for accurate quantitative interpretation of basicity data for a wide range of primary-, secondary- and ternary amines. The values of the estimated atomic operational contributions in the equation above can hence be used for prediction of unknown pK values for amines, constituted from the atom types presented in Table 6 in Example 2.

TABLE 7
Experimental (25C, I = 0) and Estimated pK parameters of organic amines

| | | | pK | pK | | σ* |
|---|---|---|---|---|---|---|
| Nr | Molecule | | exper | pred | Δ | calc |
| 1 | CH₃NH₂ | | 10.66 | 10.41 | 0.24 | −0.14 |
| 2 | H₂NC(O)CH₂NH₂ | | 7.95 | 8.14 | −0.19 | 0.42 |
| 3 | N≡CCH₂NH₂ | | 5.34 | 4.99 | 0.35 | 1.18 |
| 4 | (C₂H₅O)₂Si(CH₃)CH₂NH₂ | | 9.20 | 9.31 | −0.11 | 0.13 |
| 5 | C₂H₅OSi(CH₃)₂CH₂NH₂ | | 10.18 | 10.29 | −0.11 | −0.11 |
| 6 | CH₃ONH₂ | | 4.60 | 5.06 | −0.46 | 1.17 |
| 7 | (C₂H₅O)₃SiCH₂NH₂ | | 8.43 | 8.32 | 0.11 | 0.37 |
| 8 | (H₃C)₃SiCH₂NH₂ | | 10.96 | 10.87 | 0.09 | −0.25 |
| 9 | C₂H₅NH₂ | | 10.70 | 10.57 | 0.13 | −0.17 |
| 10 | C₆H₅C(O)NHC₂H₄NH₂ | | 9.13 | 9.41 | −0.28 | 0.11 |
| 11 | BrC₂H₄NH₂ | | 8.47 | 8.35 | 0.12 | 0.37 |
| 12 | CH₃CH(CONH₂)NH₂ | | 8.02 | 8.23 | −0.21 | 0.40 |
| 13 | N≡CC₂H₄NH₂ | | 7.77 | 8.23 | −0.46 | 0.40 |
| 14 | HOC₂H₄NH₂ | | 9.50 | 9.76 | −0.26 | 0.02 |
| 15 | HSC₂H₄NH₂ | | 8.35 | 8.40 | −0.05 | 0.35 |
| 16 | H₃COC₂H₄NH₂ | | 9.42 | 9.34 | 0.08 | 0.13 |
| 17 | H₃CSC₂H₄NH₂ | | 9.36 | 9.34 | 0.02 | 0.13 |
| 18 | Cl₃CC₂H₄NH₂ | | 5.40 | 3.80 | 1.60 | 1.47 |
| 19 | F₃CC₂H₄NH₂ | | 5.70 | 7.57 | −1.87 | 0.56 |
| 20 | (CH₃)₃SiC₂H₄NH₂ | | 10.97 | 10.78 | 0.19 | −0.22 |
| 21 | CH₃C(O)OC₂H₄NH₂ | | 9.10 | 9.04 | 0.06 | 0.20 |
| 22 | HOC₂H₄SC₂H₄NH₂ | | 9.28 | 8.85 | 0.43 | 0.25 |
| 23 | C₃H₇NH₂ | | 10.69 | 10.57 | 0.12 | −0.17 |
| 24 | iso-C₃H₇NH₂ | | 10.60 | 10.62 | −0.02 | −0.19 |
| 25 | BrC₃H₆NH₂ | | 8.82 | 9.26 | −0.44 | 0.15 |
| 26 | (CH₃)₂C(CN)NH₂ | | 5.23 | 5.34 | −0.11 | 1.10 |
| 27 | (OHCH₂)₃CNH₂ | | 8.08 | 7.98 | 0.10 | 0.46 |
| 28 | (OHCH₂)₂C(CH₃)NH₂ | | 8.80 | 9.26 | −0.46 | 0.15 |
| 29 | t-C₄H₉CH₂NH₂ | | 10.24 | 10.83 | −0.59 | −0.24 |
| 30 | HOC₃H₆NH₂ | | 9.96 | 10.16 | −0.20 | −0.07 |
| 31 | CH₃CH(CH₂OH)NH₂ | | 9.43 | 9.37 | 0.06 | 0.12 |
| 32 | (CH₃)₂C(OH)CH₂NH₂ | | 9.25 | 9.07 | 0.18 | 0.19 |
| 33 | (CH₃)₂C(CH₂OH)CH₂NH₂ | | 9.71 | 9.49 | 0.22 | 0.09 |
| 34 | iso-C₄H₉NH₂ | | 10.72 | 10.75 | −0.03 | −0.22 |
| 35 | t-C₄H₉NH₂ | | 10.68 | 10.85 | −0.17 | −0.24 |
| 36 | F₃CC₂H₄NH₂ | | 8.58 | 9.19 | −0.61 | 0.16 |
| 37 | (CH₃)₃SiC₃H₆NH₂ | | 10.73 | 10.77 | −0.04 | −0.22 |
| 38 | H₂C═CH—CH₂NH₂ | | 9.49 | 9.72 | −0.23 | 0.03 |
| 39 | HC≡C—CH₂NH₂ | | 8.15 | 7.99 | 0.16 | 0.45 |
| 40 | C₄H₉NH₂ | | 10.61 | 10.62 | −0.01 | −0.19 |
| 41 | sec-C₄H₉NH₂ | | 10.56 | 10.69 | −0.13 | −0.20 |
| 42 | HOC₄H₈NH₂ | | 10.20 | 10.37 | −0.17 | −0.12 |
| 43 | C₂H₅CH(CH₂OH)NH₂ | | 9.55 | 9.49 | 0.06 | 0.09 |
| 44 | C₂H₅C(CH₂OH)₂NH₂ | | 8.80 | 8.89 | −0.09 | 0.23 |
| 45 | C₂H₅CH(CH₃)CH₂NH₂ | | 10.64 | 10.76 | −0.12 | −0.22 |
| 46 | (CH₃)₂CHC₂H₄NH₂ | | 10.70 | 10.69 | 0.01 | −0.20 |
| 47 | (CH₃)₂C(C₂H₅)NH₂ | | 10.72 | 10.81 | −0.09 | −0.23 |
| 48 | Cl₃CC₃H₆NH₂ | | 9.78 | 8.39 | 1.39 | 0.36 |
| 49 | Cl₂C═CHC₂H₄NH₂ | | 9.97 | 8.84 | 1.13 | 0.25 |
| 50 | C₅H₁₁NH₂ | | 10.63 | 10.65 | −0.02 | −0.19 |
| 51 | (C₂H₅)₂CHNH₂ | | 10.42 | 10.78 | −0.36 | −0.22 |
| 52 | BrC₅H₁₀NH₂ | | 9.50 | 10.05 | −0.56 | −0.05 |
| 53 | (iso-C₃H₇)₂CHNH₂ | | 10.23 | 10.98 | −0.75 | −0.27 |
| 54 | (C₂H₅)₃CNH₂ | | 10.59 | 11.00 | −0.41 | −0.28 |
| 55 | HOC₅H₁₀NH₂ | | 10.43 | 10.48 | −0.05 | −0.15 |
| 56 | (C₂H₅)₂C(CH₃)NH₂ | | 10.63 | 10.90 | −0.27 | −0.25 |
| 57 | Cl₃CC₄H₈NH₂ | | 9.97 | 9.18 | 0.79 | 0.16 |
| 58 | t-C₄H₉CH₂C(CH₃)₂NH₂ | | 10.73 | 11.00 | −0.27 | −0.28 |
| 59 | C₆H₁₃NH₂ | | 10.64 | 10.68 | −0.04 | −0.20 |
| 60 | BrC₆H₁₂NH₂ | | 10.48 | 10.24 | 0.24 | −0.09 |
| 61 | HOC₆H₁₂NH₂ | | 10.48 | 10.55 | −0.07 | −0.17 |
| 62 | C₇H₁₃NH₂ | | 10.66 | 10.68 | −0.02 | −0.20 |
| 63 | C₅H₁₁CH(CH₃)NH₂ | | 10.67 | 10.80 | −0.13 | −0.23 |
| 64 | C₅H₁₁C(CH₃)₂NH₂ | | 10.56 | 10.92 | −0.36 | −0.26 |
| 65 | (CH₃)₂CHC₃H₆CH(CH₃)NH₂ | | 10.28 | 10.83 | −0.55 | −0.24 |
| 66 | C₈H₁₇NH₂ | | 10.65 | 10.71 | −0.06 | −0.21 |
| 67 | C₆H₁₃CH(CH₃)NH₂ | | 10.49 | 10.82 | −0.33 | −0.23 |
| 68 | C₅H₁₁CH(OH)C(CH3)₂NH₂ | | 9.85 | 9.72 | 0.13 | 0.03 |
| 69 | C₉H₁₉NH₂ | | 10.64 | 10.72 | −0.08 | −0.21 |
| 70 | C₁₀H₂₁NH₂ | | 10.62 | 10.73 | −0.11 | −0.21 |
| 71 | C₁₁H₂₃NH₂ | | 10.63 | 10.74 | −0.11 | −0.21 |
| 72 | C₁₂H₂₅NH₂ | | 10.63 | 10.74 | −0.11 | −0.22 |
| 73 | C₁₃H₂₇NH₂ | | 10.63 | 10.79 | −0.16 | −0.23 |
| 74 | C₁₄H₂₉NH₂ | | 10.62 | 10.80 | −0.18 | −0.23 |
| 75 | C₁₅H₃₁NH₂ | | 10.61 | 10.80 | −0.19 | −0.23 |
| 76 | C₁₆H₃₃NH₂ | | 10.61 | 10.76 | −0.15 | −0.22 |
| 77 | C₁₇H₃₅NH₂ | | 10.60 | 10.81 | −0.21 | −0.23 |
| 78 | C₁₈H₃₇NH₂ | | 10.60 | 10.82 | −0.22 | −0.23 |
| 79 | C₂₂H₄₄NH₂ | | 10.60 | 10.83 | −0.23 | −0.24 |
| 80 | C₅H₈(cyclo), 2-OH, 1-NH₂ | | 9.20 | 9.35 | −0.15 | 0.12 |
| 81 | C₆H₁₁(cyclo)NH₂ | | 10.68 | 10.76 | −0.08 | −0.22 |
| 82 | C₆H₁₀(cyclo) 2-Cl, 1-NH₂ | | 9.49 | 9.34 | 0.15 | 0.13 |
| 83 | C₆H₁₀(cyclo) 2-OH, 1-NH₂ | | 9.53 | 9.51 | 0.02 | 0.08 |
| 84 | C₆H₉(cyclo) 5-CH₃, 2-OH, 1-NH₂ | | 9.44 | 9.56 | −0.12 | 0.07 |
| 85 | C₆H₉(cyclo) 6-CH₃, 2-OH, 1-NH₂ | | 9.39 | 9.62 | −0.23 | 0.06 |
| 86 | C₆H₉(cyclo) 5-CH₃, 2-CH(CH3)₂, 1-NH₂ | ecvat | 10.35 | 11.06 | −0.71 | −0.29 |
| 87 | C₆H₉(cyclo) 5-CH₃, 2-CH(CH3)₂, 1-NH₂ | axial | 10.48 | 11.08 | −0.60 | −0.30 |
| 88 | C₆H₁₁(cyclo)CH₂NH₂ | | 10.49 | 10.83 | −0.34 | −0.24 |
| 89 | C₆H₁₀(cyclo) 1-CH₃, 1-NH₂ | | 10.36 | 10.93 | −0.57 | −0.26 |
| 90 | C₆H₁₀(cyclo) 2-CH₃, 1-NH₂ | ecvat | 10.49 | 10.87 | −0.38 | −0.25 |
| 91 | C₆H₁₀(cyclo) 2-CH₃, 1-NH₂ | axial | 10.51 | 10.89 | −0.38 | −0.25 |
| 92 | C₆H₁₀(cyclo) 3-CH₃, 1-NH₂ | ecvat | 10.56 | 10.78 | −0.22 | −0.23 |
| 93 | C₆H₁₀(cyclo) 3-CH₃, 1-NH₂ | axial | 10.61 | 10.80 | −0.19 | −0.23 |
| 94 | C₆H₁₁(cyclo)CH₂CH(CH₃)NH₂ | | 10.14 | 10.87 | −0.73 | −0.25 |
| 95 | 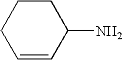 | | 10.42 | 10.00 | 0.42 | −0.03 |
| 96 | 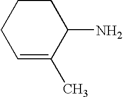 | | 10.37 | 10.06 | 0.31 | −0.05 |
| 97 | C₇H₁₂(cyclo) 2-OH, 1-NH₂ | | 9.25 | 9.27 | −0.02 | 0.14 |
| 98 | C₆H₅C₂H₄CH(CH₃)NH₂ | | 9.79 | 10.36 | −0.57 | −0.12 |
| 99 | C₆H₄(4-OH)C₂H₄CH(CH₃)NH₂ | | 9.14 | 9.90 | −0.76 | −0.01 |
| 100 | C₆H₅C₄H₈NH₂ | | 10.36 | 10.41 | −0.05 | −0.13 |
| 101 | C₆H₅CH(CH₃)NH₂ | | 9.08 | 9.34 | −0.26 | 0.13 |
| 102 | C₆H₅C₂H₄NH₂ | | 9.84 | 9.96 | −0.12 | −0.03 |
| 103 | C₆H₃(3-OH, 4-OH)C₂H₄NH₂ | | 8.74 | 9.07 | −0.33 | 0.19 |
| 104 | C₆H₄(4-OH)C₂H₄NH₂ | | 9.30 | 9.37 | −0.07 | 0.12 |
| 105 | C₆H₃(3-OH, 4-OH)CH(OH)CH(C₂H₅)NH₂ | | 8.42 | 8.82 | −0.40 | 0.25 |
| 106 | C₆H₅CH(OH)CH₂NH₂ | | 8.90 | 8.44 | 0.46 | 0.34 |
| 107 | C₆H₃(3-OH, 4-OH)CH(OH)CH₂NH₂ | | 8.58 | 8.45 | 0.13 | 0.34 |
| 108 | C₆H₄(3-OH)CH(OH)CH₂NH₂ | | 8.67 | 8.06 | 0.61 | 0.44 |
| 109 | C₆H₄(4-OH)CH(OH)CH₂NH₂ | | 8.81 | 8.23 | 0.58 | 0.40 |
| 110 | C₆H₅CH(OH)CH(CH₃)NH₂ | | 9.31 | 8.81 | 0.50 | 0.26 |
| 111 | C₆H₃(3-OH, 4-OH)CH(OH)CH(CH₃)NH₂ | | 8.45 | 8.43 | 0.02 | 0.35 |
| 112 | C₆H₄(4-OH)CH(OH)CH(CH₃)NH₂ | | 8.70 | 8.65 | 0.05 | 0.29 |
| 113 | C₆H₅CH(CH₃)CH₂NH₂ | | 10.27 | 10.10 | 0.17 | −0.06 |
| 114 | C₆H₅Si(CH₃)₂CH₂NH₂ | | 10.36 | 10.39 | −0.03 | −0.13 |
| 115 | C₆H₅CH(CH₃)C₂H₄NH₂ | | 10.03 | 10.25 | −0.22 | −0.09 |
| 116 | C₆H₅C₃H₆CH(CH₃)NH₂ | | 9.99 | 10.51 | −0.52 | −0.16 |
| 117 | C₆H₅C₅H₁₀NH₂ | | 10.44 | 10.53 | −0.09 | −0.16 |
| 118 | C₆H₄(4-OH)C₃H₆CH(CH₃)NH₂ | | 9.40 | 10.02 | −0.62 | −0.04 |
| 119 | C₆H₅CH₂CH(CH₃)NH₂ | | 10.03 | 10.08 | −0.05 | −0.05 |
| 120 | C₆H₅C₃H₆NH₂ | | 10.16 | 10.22 | −0.06 | −0.09 |
| 121 | C₆H₃(3-OCH₃, 4-OCH₃)CH₂CH(CH₃)NH₂ | | 9.60 | 9.76 | −0.16 | 0.02 |
| 122 | C₆H₄(4-OH)CH₂CH(CH₃)NH₂ | | 9.31 | 9.93 | −0.62 | −0.02 |
| 123 | C₆H₄(4-OCH₃)CH₂CH(CH₃)NH₂ | | 9.53 | 9.95 | −0.42 | −0.02 |
| 124 | C₆H₅CH₂NH₂ | | 9.33 | 9.21 | 0.12 | 0.16 |
| 125 | C₆H₃(2-OCH₃, 3-OCH₃)CH₂NH₂ | | 9.41 | 8.51 | 0.90 | 0.33 |
| 126 | C₆H₃(3-OCH₃, 4-OCH₃)CH₂NH₂ | | 9.39 | 8.75 | 0.64 | 0.27 |
| 127 | C₆H₄(2-OCH₃)CH₂NH₂ | | 9.70 | 8.73 | 0.97 | 0.27 |
| 128 | C₆H₄(3-OCH₃)CH₂NH₂ | | 9.15 | 8.97 | 0.18 | 0.22 |
| 129 | C₆H₄(4-OCH₃)CH₂NH₂ | | 9.47 | 9.01 | 0.46 | 0.21 |
| 130 | C₆H₄(2-CH₃)CH₂NH₂ | | 9.19 | 9.33 | −0.14 | 0.13 |
| 131 | C₆H₄(3-CH₃)CH₂NH₂ | | 9.33 | 9.25 | 0.08 | 0.15 |
| 132 | C₆H₄(4-CH₃)CH₂NH₂ | | 9.36 | 9.24 | 0.12 | 0.15 |
| 133 | F₅C₆CH₂NH₂ | | 7.67 | 6.59 | 1.08 | 0.79 |
| 134 | ⁻OC(O)CH(CH₃)NH₂ | | 9.87 | 10.22 | −0.35 | −0.09 |
| 135 | ⁻OC(O)CH(CH₃)NHC(O)CH(CH₃)NH₂ | | 8.14 | 8.39 | −0.25 | 0.36 |
| | LL | | | | | |
| 136 | ⁻OC(O)CH(CH₃)NHC(O)CH(CH₃)NH₂ | | 8.30 | 8.14 | 0.16 | 0.42 |
| | LD | | | | | |
| 137 | ⁻OC(O)CH(CH₃)NHC(O)CH(CH₃)NHC(O)CH(CH₃)NH₂ | | 8.03 | 7.91 | 0.12 | 0.47 |
| | LLL | | | | | |
| 138 | ⁻OC(O)CH(CH₃)NHC(O)CH(CH₃)NHC(O)CH(CH₃)NH₂ | | 8.05 | 7.91 | 0.14 | 0.47 |
| | LLD | | | | | |
| 139 | ⁻OC(O)CH(CH₃)NHC(O)CH(CH₃)NHC(O)CH(CH₃)NH₂ | | 8.13 | 7.95 | 0.18 | 0.46 |
| | LDL | | | | | |
| 140 | ⁻OC(O)CH(CH₃)NHC(O)CH(CH₃)NHC(O)CH(CH₃)NH₂ | | 8.06 | 7.95 | 0.11 | 0.47 |
| | DLL | | | | | |
| 141 | ⁻OC(O)CH(CH₃)NHC(O)CH(CH₃)NHC(O)CH(CH₃)NH₂ | | 8.06 | 7.96 | 0.10 | 0.46 |
| | DDD | | | | | |
| 142 | ⁻OC(O)CH(CH₃)NH[C(O)CH(CH₃)NH]₂C(O)CH(CH₃)NH₂ | | 7.94 | 7.71 | 0.23 | 0.52 |
| | LLLL | | | | | |
| 143 | ⁻OC(O)CH(CH₃)NH[C(O)CH(CH₃)NH]₂C(O)CH(CH₃)NH₂ | | 7.93 | 7.77 | 0.16 | 0.51 |
| | LLDL | | | | | |
| 144 | ⁻OC(O)CH(CH₃)NH[C(O)CH(CH₃)NH]₂C(O)CH(CH₃)NH₂ | | 7.99 | 7.77 | 0.22 | 0.51 |
| | LDLL | | | | | |
| 145 | ⁻OC(O)CH(CH₃)NH[C(O)CH(CH₃)NH]₂C(O)CH(CH₃)NH₂ | | 7.99 | 7.78 | 0.21 | 0.51 |
| | DLLL | | | | | |
| 146 | ⁻OC(O)CH(CH₃)NHC(O)CH(C₄H₈N⁺H₃)NHC(O)CH(CH₃)NH₂ | | 7.65 | 7.63 | 0.02 | 0.54 |
| | LLL | | | | | |
| 147 | ⁻OC(O)CH(CH₃)NHC(O)CH(C₄H₈N⁺H₃)NHC(O)CH(CH₃)NH₂ | | 7.97 | 7.64 | 0.33 | 0.54 |
| | LDL | | | | | |
| 148 | ⁻OC(O)CH(CH₃)NHC(O)CH(C₄H₈N⁺H₃)NHC(O)CH(CH₃)NH₂ | | 7.84 | 7.64 | 0.20 | 0.54 |
| | LLD | | | | | |
| 149 | ⁻OC(O)CH(CH₃)NHC(O)CH(NHC(O)CH(CH₃)NH₂)C₄H₈NH₂ | | 10.30 | 9.97 | 0.33 | −0.03 |
| | LLL | | | | | |
| 150 | ⁻OC(O)CH(CH₃)NHC(O)CH(NHC(O)CH(CH₃)NH₂)C₄H₈NH₂ | | 10.36 | 9.95 | 0.41 | −0.02 |
| | LDL | | | | | |
| 151 | ⁻OC(O)CH(CH₃)NHC(O)CH(NHC(O)CH(CH₃)NH₂)C₄H₈NH₂ | | 10.49 | 9.99 | 0.50 | −0.03 |
| | LLD | | | | | |
| 152 | ⁻OC(O)CH(CH₃)NHC(O)CH(C₄H₈N⁺H₃)NHC(O)CH(CH₃)NHC(O)CH(CH₃)NH₂ | | 8.01 | 7.48 | 0.53 | 0.58 |
| | LLLL | | | | | |
| 153 | ⁻OC(O)CH(CH₃)NHC(O)CH(NHC(O)CH(CH₃)NHC(O)CH(CH₃)NH₂)C₄H₈NH₂ | | 10.58 | 9.93 | 0.65 | −0.02 |
| | LLLL | | | | | |
| 154 | ⁻OCOCH(CH₃)NHC(O)CH(C₄H₈N⁺H₃)NHC(O)CH(CH₃)NHC(O)CH(CH₃)NH₂ | | 8.01 | 7.44 | 0.57 | 0.59 |
| | LDLL | | | | | |
| 155 | ⁻OCOCH(CH₃)NHC(O)CH(C₄H₈N⁺H₃)NH[C(O)CH(CH₃)NH]₂C(O)CH(CH₃)NH₂ | | 7.75 | 7.57 | 0.18 | 0.56 |
| | LLLLL | | | | | |
| 156 | ⁻OCOCH(CH₃)NHC(O)CH(C₄H₈N⁺H₃)NH[C(O)CH(CH₃)NH]₂C(O)CH(CH₃)NH₂ | | 7.85 | 7.32 | 0.53 | 0.62 |
| | LDLLL | | | | | |
| 157 | ⁻OC(O)CH(CH₃)NHC(O)CH(NH[C(O)CH(CH₃)NH]₂C(O)CH(CH₃)NH₂)C₄H₈NH₂ | | 10.35 | 9.92 | 0.43 | −0.02 |
| | LLLLL | | | | | |
| 158 | ⁻OC(O)CH(CH₃)NHC(O)CH(NH[C(O)CH(CH₃)NH]₂C(O)CH(CH₃)NH₂)C₄H₈NH₂ | | 10.29 | 9.83 | 0.46 | 0.01 |
| | LDLLL | | | | | |
| 159 | ⁻OOCCH(CH₃)NHC(O)CH₂NH₂ | | 8.23 | 8.41 | −0.18 | 0.35 |
| 160 | ⁻OOCCH(CH₃)NHC(O)CH(CH₃)NHC(O)CH₂NH₂ | | 8.10 | 7.91 | 0.19 | 0.47 |
| | LL | | | | | |
| 161 | ⁻OOCCH(CH₃)NHC(O)CH(CH₃)NHC(O)CH₂NH₂ | | 8.17 | 8.05 | 0.12 | 0.44 |
| | LD | | | | | |
| 162 | ⁻OC(O)CH(CH₃)NHC(O)CH(C₄H₈N⁺H₃)NH₂ | | 7.62 | 7.93 | −0.31 | 0.47 |
| | LL | | | | | |
| 163 | ⁻OC(O)CH(CH₃)NHC(O)CH(NH₂)C₄H₈NH₂ | | 10.70 | 10.24 | 0.46 | −0.09 |
| | LL | | | | | |
| 164 | ⁻OC(O)CH(CH₃)NHC(O)CH(C₄H₈N⁺H₃)NH₂ | | 7.74 | 7.86 | −0.12 | 0.49 |
| | LD | | | | | |
| 165 | ⁻OC(O)CH(CH₃)NHC(O)CH(NH₂)C₄H₈NH₂ | | 10.63 | 10.23 | 0.40 | −0.09 |
| | LD | | | | | |
| 166 | ⁻OC(O)CH(CH₂OCH₃)NH₂ | | 9.18 | 9.06 | 0.12 | 0.19 |
| 167 | H₅C₂OC(O)CH(CH₃)NH₂ | | 7.74 | 7.99 | −0.25 | 0.45 |
| 168 | ⁻OC(O)CH(C₂H₄OH)NH₂ | | 9.10 | 9.08 | 0.02 | 0.19 |
| 169 | ⁻OC(O)CH(C₂H₄OCH₃)NH₂ | | 8.90 | 9.12 | −0.22 | 0.18 |
| 170 | ⁻OC(O)CH(C₂H₅)NH₂ | | 9.60 | 9.76 | −0.16 | 0.02 |
| 171 | ⁻OC(O)CH(CH₂CF₃)NH₂ | | 8.17 | 8.06 | 0.12 | 0.44 |
| 172 | H₅C₂OC(O)CH(C₂H₅)NH₂ | | 7.60 | 8.11 | −0.51 | 0.42 |
| 173 | ⁻OOCCH₂CH(CF₃)NH₂ | | 5.83 | 5.83 | 0.00 | 0.98 |
| 174 | ⁻OOCC₃H₆NH₂ | | 10.56 | 10.49 | 0.06 | −0.15 |
| 175 | H₅C₂OOCC₃H₆NH₂ | | 9.71 | 9.79 | −0.08 | 0.02 |
| 176 | ⁻OOCC₅H₁₀NH₂ | | 10.80 | 10.56 | 0.25 | −0.17 |
| 177 | H₅C₂OOCC₅H₁₀NH₂ | | 10.30 | 10.34 | −0.03 | −0.12 |
| 178 | ⁻OOCC(CH₃)₂NH₂ | | 10.21 | 10.44 | −0.23 | −0.14 |
| 179 | ⁻OOCC₂H₄C(O)CH₂NH₂ | | 8.82 | 8.64 | 0.18 | 0.30 |
| 180 | ⁻OOCC₂H₄CH(CH₃)NH₂ | | 10.46 | 10.61 | −0.15 | −0.18 |
| 181 | ⁻OOCC₄H₈NH₂ | | 10.75 | 10.59 | 0.16 | −0.18 |
| 182 | H₅C₂OOCC₄H₈NH₂ | | 10.15 | 10.19 | −0.04 | −0.08 |
| 183 | ⁻OOCC₂H₄NH₂ | | 10.24 | 10.49 | −0.26 | −0.16 |
| 184 | H₅C₂OOCC₂H₄NH₂ | | 9.06 | 9.59 | −0.53 | 0.07 |
| 185 | ⁻OOCCH(C₃H₆NHC(═N⁺H₂)NH₂)NH₂ | | 8.99 | 9.08 | −0.09 | 0.19 |
| 186 | ⁻OOCCH(C₃H₆NHC(═N⁺H₂)NH₂)NHC(O)CH(CH₂C₆H₅)NH₂ | | 7.54 | 7.53 | 0.01 | 0.57 |
| 187 | ⁻OOCCH(C₃H₆NHC(═N⁺H₂)NH₂)NHC(O)CH(CH₂C₆H₄(4-OH))NH₂ | | 7.39 | 7.39 | 0.00 | 0.60 |
| | DD | | | | | |
| 188 | ⁻OOCCH(CH₂C(O)NH₂)NH₂ | | 8.84 | 9.36 | −0.52 | 0.12 |
| 189 | ⁻OOCCH(CH₂C(O)NH₂)NHC(O)CH(CH₂SH)NH₂ | | 6.95 | 7.13 | −0.18 | 0.66 |
| | LL | | | | | |
| 190 | ⁻OOCCH(CH₂C(O)NH₂)NHC(O)CH₂NH₂ | | 8.27 | 8.14 | 0.13 | 0.42 |
| 191 | ⁻OOCC(OH)(CH₂C(O)NH₂)NH₂ | | 7.20 | 7.55 | −0.35 | 0.56 |
| 192 | ⁻OOCCH(CH(OH)C(O)NH₂)NH₂ | | 8.29 | 8.46 | −0.17 | 0.34 |
| 193 | ⁻OOCCH(CH₂C(O)NH₂)NHC(O)CH(iso-C₄H₉)NH₂ | | 8.11 | 8.24 | −0.13 | 0.39 |
| 194 | ⁻OOCCH(CH₂COO⁻)NH₂ | | 10.00 | 10.13 | −0.13 | −0.07 |
| 195 | ⁻OOCCH(CH₂COO⁻)NHC(O)CH(CH₂COO⁻)NH₂ | | 8.26 | 7.92 | 0.34 | 0.47 |
| 196 | ⁻OOCCH(CH₂COO⁻)NHC(O)CH₂NH₂ | | 8.60 | 8.27 | 0.33 | 0.39 |
| 197 | H₅C₂OOCCH(CH₂COOC₂H₅)NH₂ | | 6.40 | 6.77 | −0.37 | 0.75 |
| 198 | H₂NOCCH(CH₂CONH₂)NH₂ | | 7.00 | 6.92 | 0.08 | 0.72 |
| 199 | ⁻OOCCH(CH₂SH)NH₂ | | 8.33 | 8.70 | −0.37 | 0.28 |
| 200 | ⁻OOCCH(CH₂SH)NHC(O)CH(CH₂SH)NH₂ | | 7.27 | 7.12 | 0.15 | 0.67 |
| 201 | ⁻OOCCH(CH₂SC₂H₅)NH₂ | | 8.69 | 9.12 | −0.43 | 0.18 |
| 202 | ⁻OOCCH(CH₂SCH₃)NH₂ | | 8.75 | 9.15 | −0.40 | 0.17 |
| 203 | H₅C₂OOCCH(CH₂SH)NH₂ | | 6.69 | 6.75 | −0.06 | 0.76 |
| 204 | H₃COOCCH(CH₂SH)NH₂ | | 6.56 | 6.92 | −0.36 | 0.71 |
| 205 | ⁻OOCCH(NH₂)CH₂SSCH₂CH(COO⁻)NH₂ | | 8.95 | 9.19 | −0.24 | 0.16 |
| 206 | ⁻OOCCH(N⁺H₃)CH₂SSCH₂CH(COO⁻)NH₂ | | 8.26 | 7.75 | 0.51 | 0.51 |
| 207 | ⁻OOCCH(N⁺H₃)CH₂SSCH₂CH(COO⁻) | | 7.66 | 7.81 | −0.15 | 0.50 |
| | NHC(O)CH(N⁺H₃)CH₂SSCH₂CH(COO⁻)NH₂ | | | | | |
| 208 | ⁻OOCCH(NH₂)CH₂SSCH₂CH(COO⁻) | | 8.18 | 7.68 | 0.50 | 0.53 |
| | NHC(O)CH₂NHC(O)CH₂NH₂ | | | | | |
| 209 | H₃N⁺CH₂C(O)NHCH₂C(O)NHCH(COO⁻) | | 8.18 | 7.76 | 0.42 | 0.51 |
| | CH₂SSCH₂C(O)CH(COO⁻)NH₂ | | | | | |
| 210 | H₂NC(O)CH(NH₂)CH₂SSCH₂CH(CONH₂)NH₂ | | 6.80 | 6.87 | −0.07 | 0.73 |
| 211 | H₃CCH(NH₂)CH₂CH(COO⁻)NH₂ | | 10.35 | 9.75 | 0.60 | 0.03 |
| 212 | ⁻OOCCH(N⁺H₃)CH₂CH(CH₃)NH₂ | | 8.16 | 8.14 | 0.02 | 0.42 |
| 213 | H₂NCH₂CH(COO⁻)NH₂ | | 9.60 | 9.26 | 0.34 | 0.14 |
| 214 | ⁻OOCCH(N⁺H₃)CH₂NH₂ | | 6.80 | 7.29 | −0.49 | 0.63 |
| 215 | ⁻OOCCH(C₂H₄COO⁻)NH₂ | | 9.94 | 10.17 | −0.23 | −0.08 |
| 216 | ⁻OOCCH(C₂H₄COO⁻)NHC(O)CH(C₂H₄COO⁻)NH₂ | | 7.62 | 7.99 | −0.37 | 0.45 |
| | DD | | | | | |
| 217 | ⁻OOCCH(CH(OH)CH₂COO⁻)NH₂ | | 9.66 | 9.49 | 0.17 | 0.09 |
| 218 | ⁻OOCCH(C₂H₄COO⁻)NHC(O)CH(C₄H₈N⁺H₃)NH₂ | | 7.75 | 7.72 | 0.03 | 0.52 |
| 219 | ⁻OOCCH(C₂H₄COO⁻)NHC(O)CH(NH₂)C₄H₈NH₂ | | 10.50 | 10.21 | 0.29 | −0.09 |
| 220 | H₅C₂OOCCH(C₂H₄COOC₂H₅)NH₂ | | 7.04 | 7.30 | −0.26 | 0.62 |
| 221 | ⁻OOCCH(C₂H₄COOCH₂C₆H₅)NH₂ | | 9.00 | 9.26 | −0.26 | 0.14 |
| 222 | H₅C₂OOCCH(C₂H₄COO⁻)NH₂ | | 7.84 | 7.86 | −0.02 | 0.49 |
| 223 | ⁻OOCCH(C₂H₄COOC₂H₅)NH₂ | | 9.19 | 9.53 | −0.34 | 0.08 |
| 224 | ⁻OOCCH(C₂H₄CONH₂)NH₂ | | 9.13 | 9.16 | −0.03 | 0.17 |
| 225 | ⁻OOCCH(C₂H₄CONH₂)NHC(O)CH₂NH₂ | | 8.16 | 8.12 | 0.04 | 0.42 |
| 226 | ⁻OOCCH(C₂H₄CONH₂)NHC(O)CH(iso-C₄H₉)NH₂ | | 7.94 | 8.34 | −0.40 | 0.37 |
| | LL | | | | | |
| 227 | ⁻OOCCH₂NHC(O)CH(CH₂SH)NHC(O)C₂H₄CH(COO⁻)NH₂ | | 8.66 | 9.01 | −0.35 | 0.21 |
| 228 | H₂NCH(COO⁻)C₂H₄CONHCH(CONHCH₂COO⁻) | | 9.52 | 9.15 | 0.37 | 0.17 |
| | CH₂SSCH₂CH(CONHCH₂COO⁻)NHCOC₂H₄CH(COO⁻)NH₂ | | | | | |
| 229 | H₃N⁺CH(COO⁻)C₂H₄CONHCH(CONHCH₂COO⁻) | | 8.62 | 8.85 | −0.24 | 0.24 |
| | CH₂SSCH₂CH(CONHCH₂COO⁻)NHCOC₂H₄CH(COO⁻)NH₂ | | | | | |
| 230 | ⁻OOCCH₂NHC(O)CH(CH₂SC₂H₅)NHC(O)C₂H₄CH(COO⁻)NH₂ | | 9.20 | 9.43 | −0.23 | 0.10 |
| 231 | ⁻OOCCH₂NH₂ | | 9.78 | 10.13 | −0.35 | −0.07 |
| 232 | ⁻OOCCH₂NHC(O)CH(CH₃)NH₂ | | 8.18 | 8.56 | −0.38 | 0.32 |
| 233 | ⁻OOCCH₂NHC(O)CH₂NHC(O)CH(CH₃)NH₂ | | 8.03 | 7.99 | 0.04 | 0.45 |
| 234 | ⁻OOCCH₂NHC(O)CH(CH₂C(O)NH₂)NH₂ | | 7.25 | 7.61 | −0.36 | 0.55 |
| 235 | H₂NC(O)CH(N⁺H₃)CH₂SSCH₂CH(CONH₂)NH₂ | | 5.85 | 5.94 | −0.10 | 0.95 |
| 236 | ⁻OOCCH₂NHC(O)CH₂NHC(O)CH(N⁺H₃)CH₂SSCH₂CH(COO⁻)NH₂ | | 6.95 | 7.10 | −0.15 | 0.67 |
| 237 | ⁻OOCCH₂NHC(O)CH(C₂H₄COO⁻)NH₂ | | 7.52 | 7.89 | −0.37 | 0.48 |
| 238 | ⁻OOCCH₂NHC(O)CH₂NH₂ | | 8.25 | 8.16 | 0.09 | 0.41 |
| 239 | ⁻OOCCH₂NH[C(O)CH(CH₃)NH]₂C(O)CH₂NH₂ | | 7.93 | 7.78 | 0.15 | 0.51 |
| 240 | ⁻OOCCH₂NHC(O)CH₂NHC(O)CH₂NH₂ | | 8.09 | 7.63 | 0.46 | 0.54 |
| 241 | ⁻OOCCH₂NH[C(O)CH₂NH]₂C(O)CH₂NH₂ | | 7.94 | 7.65 | 0.29 | 0.54 |
| 242 | ⁻OOCCH₂NHC(O)CH(CH₂OH)NHC(O)CH₂NH₂ | | 7.99 | 7.63 | 0.36 | 0.54 |
| 243 | ⁻OOCCH₂NH[C(O)CH₂NH]₅C(O)CH₂NH₂ | | 7.59 | 7.16 | 0.43 | 0.66 |
| 244 | (1) | | 7.97 | 7.79 | 0.18 | 0.50 |
| 245 | ⁻OOCCH₂NHC(O)CH(iso-C₄H₉)NH₂ | | 8.13 | 8.56 | −0.43 | 0.32 |
| 246 | ⁻OOCCH₂NHC(O)CH₂NHC(O)CH(iso-C₄H₉)NH₂ | | 7.97 | 7.74 | 0.23 | 0.51 |
| 247 | ⁻OOCCH₂NH[C(O)CH₂NH]₄C(O)CH₂NH₂ | | 7.62 | 7.32 | 0.30 | 0.62 |
| 248 | (2) | | 8.97 | 8.34 | 0.64 | 0.37 |
| 249 | ⁻OOCCH₂NHC(O)CH(CH₂OH)NH₂ | | 7.33 | 7.07 | 0.26 | 0.68 |
| 250 | ⁻OOCCH₂NH[C(O)CH₂NH]₃C(O)CH₂NH₂ | | 7.90 | 7.63 | 0.27 | 0.54 |
| 251 | ⁻OOCCH₂NHC(O)CH(iso-C₃H₇)NH₂ | | 8.02 | 8.42 | −0.40 | 0.35 |
| 252 | H₂NOOCCH₂NHC(O)CH(CH₃)NHC(O)CH(CH₂C₆H₅)NH₂ | | 6.72 | 6.84 | −0.12 | 0.73 |
| 253 | C₂H₅OOCCH₂NH₂ | | 7.64 | 7.79 | −0.15 | 0.50 |
| 254 | CH₃OOCCH₂NH₂ | | 7.59 | 7.72 | −0.13 | 0.52 |
| 255 | CH₃OOCCH₂NHC(O)CH₂NH₂ | | 7.75 | 7.43 | 0.32 | 0.59 |
| 256 | C₂H₅OOCCH₂NHC(O)CH₂NHC(O)CH₂NH₂ | | 7.79 | 7.59 | 0.20 | 0.55 |
| 257 | C₂H₅OOCCH₂NH[C(O)CH₂NH]₂C(O)CH₂NH₂ | | 7.69 | 7.60 | 0.09 | 0.55 |
| 258 | CH₃OOCCH₂NH[C(O)CH₂NH]₄C(O)CH₂NH₂ | | 7.74 | 7.50 | 0.24 | 0.57 |
| 259 | (3) | | 9.15 | 9.12 | 0.03 | 0.18 |
| 260 | (4) | | 9.51 | 9.48 | 0.03 | 0.09 |
| 261 | (5) | | 9.45 | 9.34 | 0.11 | 0.13 |
| 262 | (6) | | 8.20 | 8.45 | −0.25 | 0.34 |
| 263 | (7) | | 9.07 | 9.03 | 0.05 | 0.20 |
| 264 | (8) | | 8.18 | 7.73 | 0.45 | 0.52 |
| 265 | (9) | | 8.62 | 8.83 | −0.21 | 0.25 |
| 266 | (10) | | 8.20 | 8.09 | 0.11 | 0.43 |
| 267 | (11) | | 7.82 | 7.82 | 0.00 | 0.50 |
| 268 | (12) | | 8.47 | 8.84 | −0.37 | 0.25 |
| 269 | (13) | | 8.85 | 8.82 | 0.03 | 0.25 |
| 270 | (14) | | 9.31 | 9.40 | −0.09 | 0.11 |
| 271 | (15) | | 7.64 | 7.61 | 0.03 | 0.55 |
| 272 | (16)r | | 7.33 | 7.44 | −0.11 | 0.59 |
| 273 | ⁻OOCCH(C₂H₄SH)NH₂ | | 8.87 | 8.76 | 0.11 | 0.27 |
| 274 | ⁻OOCCH(NH₂)C₂H₄SSC₂H₄CH(COO⁻)NH₂ | | 9.44 | 9.20 | 0.24 | 0.16 |
| 275 | ⁻OOCCH(N⁺H₃)C₂H₄SSC₂H₄CH(COO⁻)NH₂ | | 8.52 | 8.49 | 0.03 | 0.33 |
| 276 | H₂NC(O)CH(CH₂COO⁻)NH₂ | | 7.95 | 7.75 | 0.20 | 0.51 |
| 277 | H₂NC(O)CH(C₂H₄COO⁻)NH₂ | | 7.88 | 8.19 | −0.31 | 0.41 |
| 278 | ⁻OOCCH(sec-C₄H₉)NH₂ | | 9.76 | 9.89 | −0.13 | —0.01 |
| 279 | ⁻OOCH₂NHC(O)CH(sec-C₄H₉)NH₂ | | 8.00 | 8.26 | −0.26 | 0.39 |
| 280 | ⁻OOCCH(OH)NH₂ | | 9.33 | 9.48 | −0.15 | 0.09 |
| 281 | ⁻OOCCH(OH)NHC(O)CH(iso-C₄H₉)NH₂ | | 8.21 | 8.38 | −0.17 | 0.36 |
| 282 | ⁻OOCCH(iso-C₄H₉)NH₂ | | 9.74 | 9.81 | −0.06 | 0.01 |
| 283 | ⁻OOCCH(iso-C₄H₉)NHC(O)CH₂NH₂ | | 8.29 | 8.52 | −0.23 | 0.33 |
| 284 | ⁻OOCCH(iso-C₄H₉)NHC(O)CH₂N(CH₃)H | | 8.67 | 8.28 | 0.39 | 0.38 |
| 285 | ⁻OOCCH(iso-C₄H₉)NHC(O)CH(CH₂OH)NH₂ | | 7.45 | 7.62 | −0.17 | 0.54 |
| | LL | | | | | |
| 286 | ⁻OOCCH(CH₂CH(CH₃)CF₃)NH₂ | | 8.95 | 9.46 | −0.52 | 0.10 |
| 287 | H₂NC(O)CH(iso-C₄H₉)NH₂ | | 7.80 | 8.60 | −0.80 | 0.31 |
| 288 | H₅C₂OOCCH(iso-C₄H₉)NH₂ | | 7.57 | 8.24 | −0.67 | 0.39 |
| 289 | ⁻OOCCH(C₄H₉N⁺H₃)NH₂ | | 9.20 | 9.57 | −0.37 | 0.07 |
| 290 | ⁻OOCCH(NH₂)C₄H₉NH₂ | | 10.80 | 10.50 | 0.30 | −0.16 |
| 291 | ⁻OOCCH(C₄H₉N⁺H₃)NHC(O)CH(C₄H₉N⁺H₃)NH₂ | | 7.53 | 7.49 | 0.04 | 0.58 |
| | LL | | | | | |
| 292 | ⁻OOCCH(C₄H₉N⁺H₃)NHC(O)CH(NH₂)C₄H₉NH₂ | | 10.05 | 9.96 | 0.09 | −0.03 |
| | LL | | | | | |
| 293 | H₂NCH(C₄H₉NH₃)C(O)NHCH(COO⁻)C₄H₉NH₂ | | 11.01 | 10.44 | 0.57 | −0.14 |
| | LL | | | | | |
| 294 | ⁻OOCCH(C₄H₉N⁺H₃)NHC(O)CH(C₄H₉N⁺H₃)NH₂ | | 7.53 | 7.54 | −0.01 | 0.56 |
| | LD | | | | | |
| 295 | ⁻OOCCH(C₄H₉N⁺H₃)NHC(O)CH(NH₂)C₄H₉NH₂ | | 9.92 | 9.81 | 0.11 | 0.01 |
| | LD | | | | | |
| 296 | H₂NCH(C₄H₉NH₂)C(O)NHCH(COO⁻)C₄H₉NH₂ | | 10.89 | 10.45 | 0.44 | −0.15 |
| | LD | | | | | |
| 297 | ⁻OOCCH(C₄H₉N⁺H₃)NHC(O)CH(C₄H₉N⁺H₃)NHC(O)CH(C₄H₉N⁺H₃)NH₂ | | 7.34 | 7.04 | 0.30 | 0.68 |
| | LLL | | | | | |
| 298 | H₃N⁺C₄H₉CH(C(O)NHCH(COO)C₄H₉N⁺H₃)NHC(O)CH(NH₂)C₄H₉NH₂ | | 9.80 | 9.58 | 0.22 | 0.07 |
| | LLL | | | | | |
| 299 | H₂NCH(C₄H₉NH₂)C(O)NHCH(C(O)NHCH(COO⁻)C₄H₉N⁺H₃)C₄H₉NH₂ | | 10.54 | 10.02 | 0.52 | −0.04 |
| | LLL | | | | | |
| 300 | H₂NCH(C₄H₉NH₂)C(O)NHCH(C₄H₉NH₂)C(O)NHCH(COO⁻)C₄H₉NH₂ | | 11.32 | 10.74 | 0.58 | −0.21 |
| | LLL | | | | | |
| 301 | ⁻OOCCH(C₂H₄SCH₃)NH₂ | | 9.27 | 9.76 | −0.49 | 0.02 |
| 302 | ⁻OOCCH(C₂H₄SCH₃)NHC(O)CH(C₂H₄SCH₃)NH₂ | | 7.50 | 7.73 | −0.23 | 0.52 |
| | LL | | | | | |
| 303 | H₂NC(O)CH(C₂H₄SCH₃)NH₂ | | 7.53 | 7.55 | −0.02 | 0.56 |
| 304 | ⁻OOCCH(C₄H₉)NH₂ | | 9.83 | 9.57 | 0.26 | 0.07 |
| 305 | ⁻OOCCH(C₃H₆CF₃)NH₂ | | 9.46 | 9.65 | −0.19 | 0.05 |
| 306 | ⁻OOCCH(C₃H₇)NH₂ | | 9.81 | 9.52 | 0.29 | 0.08 |
| 307 | ⁻OOCCH(C₂H₄CF₃)NH₂ | | 8.92 | 9.40 | −0.48 | 0.11 |
| 308 | ⁻OOCC₂H₄NHC(═NH)NHC₃H₆CH(COO⁻)NH₂ | | 8.72 | 8.66 | 0.06 | 0.29 |
| 309 | —OOCCH(C₃H₆N⁺H₃)NH₂ | | 8.69 | 8.87 | −0.18 | 0.24 |
| 310 | H₂NCH(COO⁻)C₃H₆NH₂ | | 10.76 | 10.32 | 0.43 | −0.11 |
| 311 | —OOCCH(CH₂C₆H₅)NH₂ | | 9.24 | 9.29 | −0.05 | 0.14 |
| 312 | —OOCCH(CH₂C₆H₄(2-Cl))NH₂ | | 8.93 | 8.51 | 0.41 | 0.33 |
| 313 | —OOCCH(CH₂C₆H₄(3-Cl))NH₂ | | 8.90 | 9.06 | −0.16 | 0.19 |
| 314 | —OOCCH(CH₂C₆H₄(4-Cl))NH₂ | | 8.95 | 9.21 | −0.27 | 0.16 |
| 315 | —OOCCH(CH₂C₆H₃(3-OH, 4-OH))NH₂ | | 9.19 | 9.19 | 0.00 | 0.16 |
| 316 | —OOCCH(CH₂C₆H₄(2-F))NH₂ | | 8.98 | 9.25 | −0.26 | 0.15 |
| 317 | —OOCCH(CH₂C₆H₄(3-F))NH₂ | | 8.95 | 9.37 | −0.42 | 0.12 |
| 318 | —OOCCH(CH₂C₆H₄(4-F))NH₂ | | 9.02 | 9.45 | −0.42 | 0.10 |
| 319 | —OOCCH(CH₂C₆H₃(2-F, 4-OCH₃))NH₂ | | 8.98 | 8.91 | 0.06 | 0.23 |
| 320 | —OOCCH(CH₂C₆H₅)NHC(O)CH₂NH₂ | | 8.17 | 8.19 | −0.02 | 0.41 |
| 321 | —OOCC(CH₃)(CH₂C₆H₅)NH₂ | | 9.57 | 9.92 | −0.35 | −0.02 |
| 322 | —OOCC(CH₃)(CH₂C₆H₃(3-OH, 4-OH))NH₂ | | 9.12 | 9.61 | −0.49 | 0.06 |
| 323 | H2NC(O)C(CH₃)(CH₂C₆H₅)NH₂ | | 7.22 | 7.75 | −0.53 | 0.51 |
| 324 | HONHC(O)CH(CH₂C₆H₅)NH₂ | | 6.78 | 6.98 | −0.20 | 0.70 |
| 325 | CH₃OC(O)CH(CH₂C₆H₅)NH₂ | | 7.00 | 7.57 | −0.57 | 0.56 |
| 326 | HONHC(O)CH(CH₂C₆H₅)NH₂ | | 7.15 | 7.45 | −0.30 | 0.59 |
| 327 | (17) | | 10.64 | 10.14 | 0.50 | −0.07 |
| 328 | (18) | | 8.38 | 8.11 | 0.27 | 0.42 |
| 329 | (19) | | 8.69 | 8.67 | 0.02 | 0.29 |
| 330 | (20) | | 9.47 | 9.19 | 0.28 | 0.16 |
| 331 | ⁻OOCCH₂N(CH₃)C(O)CH₂NH₂ | | 8.59 | 8.19 | 0.40 | 0.41 |
| 332 | ⁻OOCCH(CH₂OH)NH₂ | | 9.21 | 9.08 | 0.13 | 0.19 |
| 333 | ⁻OOCCH(CH₂OH)NHC(O)CH₂NH₂ | | 8.10 | 7.90 | 0.20 | 0.48 |
| 334 | H₂NOCCH(CH₂OH)NH₂ | | 7.30 | 7.55 | −0.25 | 0.56 |
| 335 | H₃COCCH(CH₂OH)NH₂ | | 7.10 | 7.28 | −0.18 | 0.63 |
| 336 | ⁻OOCCH(CH(CH₃)OH)NH₂ | | 9.10 | 9.31 | −0.21 | 0.13 |
| 337 | ⁻OOCCH(CH(CH₃)OCH₃)NH₂ | | 9.00 | 9.00 | 0.00 | 0.21 |
| 338 | ⁻OOCCH(CH(CF₃)OH)NH₂ | | 7.78 | 7.49 | 0.29 | 0.58 |
| 339 | (21) | | 9.44 | 9.82 | −0.38 | 0.01 |
| 340 | (22) | | 8.06 | 7.82 | 0.24 | 0.50 |
| 341 | (23) | | 7.55 | 7.38 | 0.17 | 0.60 |
| 342 | ⁻OOCCH(CH₂C₆H₄(4-OH))NH₂ | | 9.11 | 9.13 | −0.02 | 0.18 |
| 343 | ⁻OOCCH(CH₂C₆H₄(4-OH))NHC(O)CH(CH₂COO)NH₂ | | 8.93 | 9.05 | −0.12 | 0.20 |
| 344 | ⁻OOCCH(CH₂C₆H₂(3-Br, 4-OH, 5-Br))NH₂ | | 6.45 | 6.14 | 0.31 | 0.90 |
| 345 | ⁻OOCCH(CH₂C₆H₂(3-Cl, 4-OH, 5-Cl))NH₂ | | 6.47 | 6.82 | −0.35 | 0.74 |
| 346 | ⁻OOCCH(CH₂C₆H₂(3-I, 4-OH, 5-I))NH₂ | | 6.48 | 7.03 | −0.55 | 0.69 |
| 347 | ⁻OOCCH(CH₂C₆H₄(4-OH))NHC(O)CH₂NH₂ | | 8.45 | 8.06 | 0.39 | 0.44 |
| 348 | ⁻OOCCH(CH₂C₆H₄(4-OH))NHC(O)CH(iso-C₄H₉)NH₂ | | 8.36 | 8.39 | −0.03 | 0.36 |
| | DL | | | | | |
| 349 | ⁻OOCCH(CH₂C₆H₄(4-OCH₃))NH₂ | | 9.27 | 8.95 | 0.32 | 0.22 |
| 350 | ⁻OOCCH(CH₂C₆H₄(4-OH))NHC(O)CH(CH₂C₆H₄(4-OH))NH₂ | | 7.68 | 7.42 | 0.26 | 0.59 |
| 351 | H₂NOCCH(CH₂C₆H₄(4-OH))NH₂ | | 7.48 | 7.80 | −0.32 | 0.50 |
| 352 | C₂H₅OCCH(CH₂C₆H₄(4-OH))NH₂ | | 7.33 | 7.32 | 0.01 | 0.62 |
| 353 | C₂H₅OCCH(CH₂C₆H₄(4-OCH₃))NH₂ | | 7.31 | 7.33 | −0.02 | 0.61 |
| 354 | HONHC(O)CH(CH₂C₆H₄(4-OH))NH₂ | | 7.00 | 7.30 | −0.30 | 0.62 |
| 355 | ⁻OOCCH(iso-C₃H₇)NH₂ | | 9.72 | 9.84 | −0.12 | 0.00 |
| 356 | ⁻OOCCH(iso-C₃H₇)NHC(O)CH₂NH₂ | | 8.25 | 8.36 | −0.11 | 0.37 |
| 357 | ⁻OOCCH(C(CH₃)₂SH)NH₂ | | 8.00 | 8.02 | −0.02 | 0.45 |
| 358 | ⁻OOCCH(CH(CH₃)CF₃)NH₂ | | 8.10 | 8.20 | −0.09 | 0.40 |
| 359 | H₂NOCCH(iso-C₃H₇)NH₂ | | 8.00 | 8.62 | −0.62 | 0.30 |
| 360 | H₂NC₂H₄OC₂H₄NH₂ | | 9.68 | 9.28 | 0.40 | 0.14 |
| 361 | H₃N⁺C₂H₄OC₂H₄NH₂ | | 8.76 | 8.68 | 0.08 | 0.29 |
| 362 | H₂NC₂H₄NHC₂H₄NH₂ | | 9.80 | 10.11 | −0.32 | −0.06 |
| 363 | H₃N⁺C₂H₄NHC₂H₄NH₂ | | 9.10 | 9.43 | −0.33 | 0.10 |
| 364 | (H₂N + C₂H₄)₂NH | | 4.30 | 4.40 | −0.10 | 1.33 |
| 365 | C₆H₅CH₂NHC₂H₄NH₂ | | 6.48 | 6.51 | −0.03 | 0.81 |
| 366 | (H₂NC₂H₄)₃N | | 10.13 | 10.09 | 0.04 | −0.06 |
| 367 | (H₂NC₂H₄)₂N⁺HC₂H₄NH₂ | | 9.44 | 9.03 | 0.41 | 0.20 |
| 368 | H₃N⁺C₂H₄(H₂NC₂H₄)N⁺HC₂H₄NH₂ | | 8.42 | 7.87 | 0.55 | 0.48 |
| 369 | (C₄H₉)N⁺H₂C₂H₄NH₂ | | 7.53 | 7.33 | 0.20 | 0.61 |
| 370 | (C₂H₅)₂N⁺HC₂H₄NH₂ | | 7.07 | 7.03 | 0.04 | 0.69 |
| 371 | (CH₃)₂N⁺HC₂H₄NH₂ | | 6.63 | 6.90 | −0.27 | 0.72 |
| 372 | H₂NC₂H₄OC₂H₄SC₂H₄NH₂ | | 9.60 | 9.32 | 0.28 | 0.13 |
| 373 | H₃N⁺C₂H₄SC₂H₄OC₂H₄NH₂ | | 8.66 | 8.68 | −0.02 | 0.29 |
| 374 | H₅C₂N⁺H₂C₂H₄NH₂ | | 7.42 | 7.23 | 0.19 | 0.64 |
| 375 | (C4H3O)—CH2—NH—C2H4—NH2 (24) | | 6.12 | 5.98 | 0.13 | 0.94 |
| 376 | H₃N⁺C₂H₄(HOC₂H₄)NH | | 6.83 | 7.02 | −0.19 | 0.69 |
| 377 | H₃N⁺C₂H₄(CH₃CH(OH)CH₂)NH | | 6.94 | 7.07 | −0.13 | 0.68 |
| 378 | H₃N⁺C₂H₄(HOC₃H₆)NH | | 6.78 | 7.11 | −0.33 | 0.67 |
| 379 | iso-C₃H₇N⁺H₂C₂H₄NH₂ | | 7.70 | 7.76 | −0.06 | 0.51 |
| 380 | CH₃N⁺H₂C₂H₄NH₂ | | 6.83 | 7.19 | −0.36 | 0.65 |
| 381 | C₆H₄(4-CH₃)CH₂N⁺H₂C₂H₄NH₂ | | 6.51 | 6.90 | −0.39 | 0.72 |
| 382 | C₆H₅C₂H₄N⁺H₂C₂H₄NH₂ | | 6.59 | 6.38 | 0.21 | 0.84 |
| 383 | C₃H₇N⁺H₂C₂H₄NH₂ | | 7.54 | 7.28 | 0.26 | 0.63 |
| 384 | H₂NC₂H₄OC₂H₄OC₂H₄NH₂ | | 9.71 | 9.14 | 0.57 | 0.18 |
| 385 | H₃N⁺C₂H₄OC₂H₄OC₂H₄NH₂ | | 8.74 | 8.70 | 0.04 | 0.28 |
| 386 | H₂NC₂H₄SC₂H₄SC₂H₄NH₂ | | 9.45 | 9.40 | 0.04 | 0.11 |
| 387 | H₃N⁺C₂H₄SC₂H₄SC₂H₄NH₂ | | 8.57 | 8.43 | 0.13 | 0.35 |
| 388 | H₂NCH₂C(O)NHC₂H₄NHC(O)CH₂NH₂ | | 8.35 | 7.96 | 0.39 | 0.46 |
| 389 | H₃N⁺CH₂C(O)NHC₂H₄NHC(O)CH₂NH₂ | | 7.63 | 7.87 | −0.24 | 0.48 |
| 390 | H₂NC₂H₄NH₂ | | 9.93 | 9.93 | 0.00 | −0.02 |
| 391 | H₃N⁺C₂H₄NH₂ | | 6.85 | 7.13 | −0.28 | 0.66 |
| 392 | H₂NC₂H₄SSC₂H₄NH₂ | | 9.03 | 9.05 | −0.03 | 0.20 |
| 393 | H₃N⁺C₂H₄SSC₂H₄NH₂ | | 8.69 | 8.65 | 0.03 | 0.29 |
| 394 | H₂NC₂H₄SC₂H₄NH₂ | | 9.80 | 9.41 | 0.38 | 0.11 |
| 395 | H₃N⁺C₂H₄SC₂H₄NH₂ | | 8.98 | 8.96 | 0.01 | 0.22 |
| 396 | H₂NC₃H₆NHC₃H₆NH₂ | | 9.86 | 9.87 | −0.01 | 0.00 |
| 397 | H₃N⁺C₃H₆(H₂NC₃H₆)NH | | 8.14 | 7.25 | 0.89 | 0.63 |
| 398 | H₂NC₃H₆N(CH₃)C₃H₆NH₂ | | 10.01 | 10.48 | −0.47 | −0.15 |
| 399 | H₃N⁺C₃H₆N(CH₃)C₃H₆NH₂ | | 9.02 | 9.17 | −0.15 | 0.17 |
| 400 | H₂NCH₂CH(CH₃)NH₂ | | 10.00 | 10.06 | −0.06 | −0.05 |
| 401 | H₃CCH(N⁺H₂)CH₂NH₂ | | 7.13 | 7.25 | −0.12 | 0.63 |
| 402 | H₂NC₃H₆NH₂ | | 10.48 | 10.38 | 0.10 | −0.13 |
| 403 | H₃N⁺C₃H₆NH₂ | | 8.45 | 8.78 | −0.33 | 0.26 |
| 404 | (H₂NCH₂)₂CHCH₂NH₂ | | 10.42 | 10.25 | 0.17 | −0.10 |
| 405 | (H₃N⁺CH₂)(H₂NCH₂)CHCH₂NH₂ | | 8.78 | 8.70 | 0.08 | 0.28 |
| 406 | (H₃N⁺CH₂)₂CHCH₂NH₂ | | 6.84 | 6.43 | 0.41 | 0.83 |
| 407 | H₂NCH₂C(CH₃)₂CH₂NH₂ | | 10.38 | 10.64 | −0.27 | −0.19 |
| 408 | H₃N⁺CH₂C(CH₃)₂CH₂NH₂ | | 8.30 | 8.61 | −0.31 | 0.30 |
| 409 | H₂NCH₂CH(OH)CH₂NH₂ | | 9.56 | 9.22 | 0.33 | 0.15 |
| 410 | H₃N⁺CH₂CH(OH)CH₂NH₂ | | 7.78 | 7.30 | 0.48 | 0.62 |
| 411 | H₂NCH₂C(CH₃)₂NH₂ | | 10.00 | 10.11 | −0.11 | −0.06 |
| 412 | H₃N⁺C(CH₃)₂CH₂NH₂ | | 6.79 | 7.00 | −0.21 | 0.69 |
| 413 | H₂NCH₂CH(NH₂)CH₂NH₂ | | 9.46 | 9.48 | −0.02 | 0.09 |
| 414 | H₃N⁺CH₂CH(NH₂)CH₂NH₂ | | 7.83 | 7.46 | 0.37 | 0.58 |
| 415 | (H₃N⁺CH₂)₂CHNH₂ | | 3.67 | 3.83 | −0.16 | 1.47 |
| 416 | H₂NC₄H₈(H₅C₂)₂N | | 10.30 | 10.60 | −0.30 | −0.18 |
| 417 | H₂NC₄H₈NH₂ | | 10.19 | 10.50 | −0.31 | −0.16 |
| 418 | H₃N⁺C₄H₈NH₂ | | 8.78 | 9.02 | −0.24 | 0.20 |
| 419 | H₃CCH(NH₂)CH(CH₃)NH₂ | | 10.00 | 10.41 | −0.41 | −0.14 |
| 420 | H₃CCH(N⁺H₃)CH(CH₃)NH₂ | | 6.91 | 6.59 | 0.32 | 0.79 |
| 421 | H₃CCH(NH₂)C₃H₆(H₅C₂)₂N | | 10.10 | 10.80 | −0.70 | −0.23 |
| 422 | H₂NC₅H₁₀NH₂ | | 10.25 | 10.57 | −0.32 | −0.17 |
| 423 | H₃N⁺C₅H₁₀NH₂ | | 9.13 | 9.24 | −0.11 | 0.15 |
| 424 | H₂NC₆H₁₂NH₂ | | 10.93 | 10.62 | 0.31 | −0.19 |
| 425 | H₃N⁺C₆H₁₂NH₂ | | 9.83 | 10.16 | −0.33 | −0.07 |
| 426 | H₂NC₈H₁₆NH₂ | | 10.83 | 10.75 | 0.08 | −0.22 |
| 427 | H₃N⁺C₈H₁₆NH₂ | | 9.95 | 10.34 | −0.40 | −0.12 |
| 428 | C₆H₁₀(cyclo), 2-NH₂, 1-NH₂ | ecvat | 9.80 | 10.20 | −0.41 | −0.08 |
| 429 | C₆H₁₀(cyclo), 2-N⁺H₃, 1-NH₂ | ecvat | 6.03 | 5.76 | 0.26 | 1.00 |
| 430 | C₆H₁₀(cyclo), 2-NH₂, 1-NH₂ | axial | 9.74 | 10.47 | −0.73 | −0.15 |
| 431 | C₆H₁₁(cyclo)CH₂CH(CH₃)NH₂ | | 10.52 | 11.04 | −0.52 | −0.29 |
| 432 | C₇H₁₂(cyclo), 2-OH, 1-NH₂ | | 9.25 | 9.51 | −0.26 | 0.08 |
| 433 | C₇H₁₂(cyclo), 2-NH₂, 1-NH₂ | | 10.02 | 10.32 | −0.31 | −0.11 |
| 434 | C₇H₁₂(cyclo), 2-N⁺H₃, 1-NH₂ | | 6.21 | 5.83 | 0.37 | 0.98 |
| 435 | (25) | | 10.17 | 11.00 | −0.83 | −0.28 |
| 436 | (26) | | 9.14 | 9.31 | −0.16 | 0.13 |
| 437 | (27) | | 9.48 | 9.83 | −0.35 | 0.01 |
| 438 | (28) | | 8.13 | 8.15 | −0.02 | 0.41 |
| 439 | (29) | | 9.50 | 9.40 | 0.09 | 0.11 |
| 440 | (30) | | 9.71 | 9.77 | −0.06 | 0.02 |
| 441 | ⁻OOCCH₂NHC(O)CH(CH₂COO⁻)NH₂ | | 9.07 | 8.65 | 0.42 | 0.29 |
| 442 | H₂NC(O)CH₂(H₃C)NH | | 8.31 | 8.29 | 0.02 | 0.20 |
| 443 | (NCCH₂)₂NH | | 0.20 | −0.44 | 0.64 | 2.32 |
| 444 | (CH₃)₂NC(O)CH₂(H₃C)NH | | 8.82 | 8.44 | 0.38 | 0.16 |
| 445 | H₃C(HO)NH | | 5.96 | 4.78 | 1.18 | 1.05 |
| 446 | H₃C(H₃CO)NH | | 4.75 | 4.90 | −0.15 | 1.02 |
| 447 | (H₃C)₂NH | | 10.73 | 10.21 | 0.52 | −0.27 |
| 448 | H₃CNHC(O)CH₂(H₃C)NH | | 8.24 | 8.08 | 0.16 | 0.25 |
| 449 | [(H₃C)₃SiCH₂]₂NH | | 11.40 | 11.17 | 0.23 | −0.50 |
| 450 | H₃CC(O)NHC₂H₄NH₂ | | 9.05 | 9.30 | −0.25 | −0.05 |
| 451 | (NCC₂H₄)₂NH | | 5.26 | 5.48 | −0.22 | 0.88 |
| 452 | (C₆H₅)₂CHC(O)C₂H₄(CH₃)NH | | 9.12 | 8.98 | 0.14 | 0.03 |
| 453 | (H₅C₂)₂NH | | 11.04 | 10.43 | 0.61 | −0.32 |
| 454 | (HOC₂H₄)₂NH | | 8.88 | 8.68 | 0.20 | 0.10 |
| 455 | (HOC₂H₄)₂(H₃C)N | | 8.52 | 8.50 | 0.02 | 0.15 |
| 456 | HOC₂H₄(H₃CCH(OH)CH₂)NH | | 8.81 | 8.60 | 0.21 | 0.12 |
| 457 | tBu-NH—CH2CH(OH)—CH3 | | 10.00 | 9.88 | 0.12 | −0.19 |
| 458 | (iso-C₄H₉)₂NH | | 10.79 | 10.84 | −0.05 | −0.42 |
| 459 | (iso-C₃H₇)₂NH | | 10.99 | 10.64 | 0.35 | −0.37 |
| 460 | (C₃H₇)₂NH | | 11.00 | 10.55 | 0.45 | −0.35 |
| 461 | (H₃C)₃SiCH₂(iso-C₃H₇)NH | | 10.80 | 10.91 | −0.11 | −0.44 |
| 462 | (H₂C═CHCH₂)₂NH | | 9.29 | 8.93 | 0.36 | 0.04 |
| 463 | H₂C═CHCH₂(H₃C)NH | | 10.11 | 9.62 | 0.49 | −0.12 |
| 464 | (HC≡CCH₂)₂NH | | 6.10 | 5.39 | 0.71 | 0.90 |
| 465 | (C₄H₉)₂NH | | 11.25 | 10.65 | 0.60 | −0.38 |
| 466 | (sec-C₄H₉)₂NH | | 11.01 | 10.80 | 0.21 | −0.41 |
| 467 | [(H₃C)₂CHC₂H₄]₂NH | | 11.03 | 10.80 | 0.22 | −0.41 |
| 468 | (C₅H₁₁)₂NH | | 11.19 | 10.72 | 0.47 | −0.39 |
| 469 | (C₆H₁₃)₂NH | | 11.01 | 10.81 | 0.20 | −0.41 |
| 470 | C₅H₁₁CH(H₃C)CH(H₃C)NH | | 10.82 | 10.61 | 0.21 | −0.36 |
| 471 | (C₈H₁₇)₂NH | | 11.01 | 10.87 | 0.14 | −0.43 |
| 472 | (C₁₂H₂₅)₂NH | | 11.00 | 10.78 | 0.22 | −0.41 |
| 473 | (C₁₃H₂₇)₂NH | | 11.00 | 10.96 | 0.04 | −0.45 |
| 474 | (C₁₅H₃₁)₂NH | | 11.00 | 10.99 | 0.01 | −0.46 |
| 475 | (C₁₈H₃₇)₂NH | | 11.00 | 11.01 | −0.01 | −0.46 |
| 476 | C₅H₈(cyclo), 2-OH, 1-(H₃C)NH | | 10.06 | 9.48 | 0.58 | −0.09 |
| 477 | C₅H₉(cyclo)(H₃C)NH | | 10.85 | 10.45 | 0.40 | −0.33 |
| 478 | C₆H₁₁(cyclo)(t-H₉C₄)NH | | 11.23 | 10.87 | 0.36 | −0.43 |
| 479 | C₆H₁₀(cyclo), 2-Cl, 1-(H₃C)NH | | 9.85 | 9.15 | 0.70 | −0.01 |
| 480 | C₆H₁₁(cyclo)(H₃C)₂N | | 10.72 | 10.35 | 0.37 | −0.30 |
| 481 | C₆H₁₀(cyclo) 2-OH, 1-(H₃C)₂N | | 10.32 | 9.78 | 0.54 | −0.16 |
| 482 | C₆H₁₀(cyclo) 4-OH, 1-CH(OH)CH₂(H₇C₃)NH | | 10.08 | 9.94 | 0.13 | −0.20 |
| 483 | C₆H₁₁(cyclo)(H₃C)NH | | 11.04 | 10.63 | 0.41 | −0.37 |
| 484 | C₆H₁₁(cyclo)CH₂(H₃C)CH(H₃C)NH | | 10.52 | 10.86 | −0.34 | −0.43 |
| 485 | C₆H₁₁(cyclo)[(H₃C)₃SiCH₂]NH | | 10.96 | 11.12 | −0.16 | −0.49 |
| 486 | C₆H₅CH₂CH(CH₃)(NCC₂H₄)NH | | 7.23 | 7.52 | −0.29 | 0.39 |
| 487 | C₆H₃, 1-OH, 2-OH, 4-CH(OH)CH₂(iso-H₇C₃)NH | | 8.87 | 8.44 | 0.43 | 0.16 |
| 488 | C₆H₃, 1-OH, 2-OH, 4-CH(OH)(iso-C₃H₇)CH(iso-H₇C₃)NH | | 8.91 | 8.71 | 0.20 | 0.10 |
| 489 | C₆H₃, 1-OH, 2-OH, 4-CH(OH)CH₂(H₃C)NH | | 8.50 | 8.24 | 0.26 | 0.21 |
| 490 | C₆H₃, 1-OH, 2-OH, 4-C₂H₄(H₃C)NH | | 8.78 | 8.80 | −0.02 | 0.07 |
| 491 | C₆H₄, 1-F, 3-CH(OH)CH₂(iso-H₇C₃)NH | | 9.35 | 8.89 | 0.45 | 0.05 |
| 492 | C₆H₄, 1-OH, 3-CH(OH)CH₂(H₃C)NH | | 8.86 | 8.34 | 0.52 | 0.19 |
| 493 | C₆H₄, 1-OH, 4-CH(OH)CH₂(H₃C)NH | | 8.90 | 8.40 | 0.50 | 0.17 |
| 494 | C₆H₄, 1-OH, 4-C(O)CH₂(iso-H₇C₃)NH | | 7.64 | 7.77 | −0.13 | 0.33 |
| 495 | C₆H₅CH(OH)CH₂(H₃C)NH | | 9.31 | 8.86 | 0.45 | 0.06 |
| 496 | C₆H₄, 1-OH, 4-CH(OH)CH₂(H₃C)NH | | 9.36 | 8.48 | 0.88 | 0.15 |
| 497 | C₆H₅CH(OH)CH(CH₃)(H₃C)NH | | 9.52 | 8.77 | 0.75 | 0.08 |
| 498 | C₆H₅C₄H₈(H₃C)NH | | 10.80 | 10.39 | 0.41 | −0.31 |
| 499 | C₆H₅C₂H₄(H₃C)NH | | 10.08 | 9.78 | 0.30 | −0.16 |
| 500 | C₆H₅CH₂(H₃C)CH(H₃C)NH | | 9.87 | 9.89 | −0.02 | −0.19 |
| 501 | C₆H₅C₃H₆(H₃C)NH | | 10.64 | 10.04 | 0.60 | −0.23 |
| 502 | C₆H₅CH(CH₃)CH₂(H₃C)NH | | 9.88 | 9.86 | 0.02 | −0.18 |
| 503 | C₆H₅CH₂(H₅C₂)NH | | 9.64 | 9.16 | 0.48 | −0.01 |
| 504 | C₆H₅CH₂(H₃C)NH | | 9.54 | 9.06 | 0.48 | 0.01 |
| 505 | C₆H₅CH₂(H₇C₃)NH | | 9.58 | 9.24 | 0.34 | −0.03 |
| 506 | (31) | | 11.07 | 10.50 | 0.57 | −0.34 |
| 507 | (32) | | 11.12 | 10.36 | 0.77 | −0.30 |
| 508 | (33) | | 11.07 | 10.58 | 0.49 | −0.36 |
| 509 | (34) | | 9.09 | 8.57 | 0.52 | 0.13 |
| 510 | (35) | | 10.95 | 10.47 | 0.48 | −0.33 |
| 511 | (36) | | 11.07 | 10.42 | 0.65 | −0.32 |
| 512 | (37) | | 10.90 | 10.64 | 0.26 | −0.37 |
| 513 | (38) | | 11.07 | 10.78 | 0.29 | −0.41 |
| 514 | (39) | | 11.21 | 10.63 | 0.58 | −0.37 |
| 515 | (40) | | 11.38 | 10.69 | 0.69 | −0.38 |
| 516 | (41) | | 8.39 | 9.03 | −0.64 | 0.02 |
| 517 | —OOCCH₂(H₃C)NH | | 10.19 | 9.96 | 0.23 | −0.21 |
| 518 | —OOCCH₂(H₇C₃)NH | | 10.19 | 10.14 | 0.05 | −0.25 |
| 519 | —OOCCH₂(H₉C₄)NH | | 10.07 | 10.18 | −0.11 | −0.26 |
| 520 | (42) | | 8.72 | 8.90 | −0.18 | 0.05 |
| 521 | ⁻OOCCH₂(iso-H₉C₄)NH | | 10.12 | 10.56 | −0.44 | −0.35 |
| 522 | ⁻OOCCH₂(iso-H₇C₃)NH | | 10.06 | 10.16 | −0.10 | −0.25 |
| 523 | ⁻OOCCH₂(H₇C₃)NH | | 10.19 | 10.04 | 0.15 | −0.23 |
| 524 | ⁻OOCCH₂NHC(O)CH2(H₃C)NH | | 8.57 | 8.50 | 0.07 | 0.15 |
| 525 | ⁻OOCCH₂(H₃C)NH | | 10.20 | 9.94 | 0.26 | −0.20 |
| 526 | ⁻OOCCH₂(H₃C)NC(O)CH₂(H₃C)NH | | 9.18 | 8.69 | 0.49 | 0.10 |
| 527 | C₆H₅CH₂NHC₂H₄NH₂ | | 9.41 | 8.82 | 0.59 | 0.07 |
| 528 | C₄H₉NHC₂H₄NH₂ | | 10.30 | 10.20 | 0.10 | −0.27 |
| 529 | C₂H₅NHC₂H₄NH₂ | | 10.36 | 10.08 | 0.28 | −0.24 |
| 530 | (43) | | 9.57 | 9.41 | 0.16 | −0.07 |
| 531 | HOC₂H₄NHC₂H₄NH₂ | | 9.82 | 9.34 | 0.48 | −0.06 |
| 532 | H₃CCH(OH)CH₂NHC₂H₄NH₂ | | 9.86 | 9.47 | 0.39 | −0.09 |
| 533 | HOC₃H₆NHC₂H₄NH₂ | | 9.67 | 9.50 | 0.17 | −0.10 |
| 534 | iso-C₃H₇NHC₂H₄NH₂ | | 10.62 | 10.32 | 0.30 | −0.30 |
| 535 | CH₃NHC₂H₄NH₂ | | 9.98 | 9.73 | 0.24 | −0.15 |
| 536 | C₆H₄(4-CH₃)CH₂NHC₂H₄NH₂ | | 9.41 | 8.79 | 0.62 | 0.08 |
| 537 | C₆H₅C₂H₄NHC₂H₄NH₂ | | 9.44 | 9.00 | 0.44 | 0.03 |
| 538 | C₃H₇NHC₂H₄NH₂ | | 10.34 | 10.15 | 0.19 | −0.25 |
| 539 | C₄H₉NHC₂H₄(H₉C₄)NH | | 10.19 | 10.35 | −0.16 | −0.30 |
| 540 | C₄H₉N⁺H₂C₂H₄(H₉C₄)NH | | 7.46 | 7.32 | 0.14 | 0.43 |
| 541 | C₂H₅NHC₂H₄(H₅C₂)NH | | 10.46 | 10.02 | 0.44 | −0.22 |
| 542 | C₂H₅N⁺H₂C₂H₄(H₅C₂)NH | | 7.70 | 7.35 | 0.35 | 0.43 |
| 543 | iso-C₃H₇NHC₂H₄(iso-C₃H₇)NH | | 10.40 | 10.32 | 0.08 | −0.29 |
| 544 | iso-C₃H₇N⁺H₂C₂H₄(iso-C₃H₇)NH | | 7.59 | 7.42 | 0.17 | 0.41 |
| 545 | CH₃NHC₂H₄(H₃C)NH | | 10.16 | 10.02 | 0.14 | −0.22 |
| 546 | CH₃N⁺H₂C₂H₄(H₃C)NH | | 7.40 | 7.18 | 0.22 | 0.47 |
| 547 | C₃H₇NHC₂H₄(C₃H₇)NH | | 10.27 | 10.26 | 0.01 | −0.28 |
| 548 | C₃H₇N⁺H₂C₂H₄(C₃H₇)NH | | 7.53 | 7.49 | 0.04 | 0.39 |
| 549 | H₂NC₃H₆NHC₃H₆NH₂ | | 10.86 | 10.41 | 0.45 | −0.32 |
| 550 | C₄H₉NHCH₂C₃F₆CH₂(H₉C₄)NH | | 7.07 | 6.74 | 0.33 | 0.58 |
| 551 | C₄H₉N⁺H₂CH₂C₃F₆CH₂(H₉C₄)NH | | 5.69 | 5.32 | 0.37 | 0.92 |
| 552 | t-C₄H₉NHCH₂C₃F₆CH₂(t-H₉C₄)NH | | 6.89 | 6.79 | 0.10 | 0.56 |
| 553 | t-C₄H₉N⁺H₂CH₂C₃F₆CH₂(t-H₉C₄)NH | | 5.92 | 6.17 | −0.25 | 0.71 |
| 554 | iso-C₃H₇NHCH₂C₃F₆CH₂(iso-H₇C₃)NH | | 7.01 | 6.66 | 0.35 | 0.60 |
| 555 | iso-C₃H₇N⁺H₂CH₂C₃F₆CH₂(iso-H₇C₃)NH | | 5.72 | 6.05 | −0.33 | 0.74 |
| 556 | CH₃NHCH₂C₃F₆CH₂(H₃C)NH | | 6.82 | 6.45 | 0.37 | 0.65 |
| 557 | CH₃N⁺H₂CH₂C₃F₆CH₂(H₃C)NH | | 5.70 | 5.64 | 0.06 | 0.84 |
| 558 | C₄H₉NHC₆H₁₂(C₄H₉)NH | | 11.28 | 10.78 | 0.50 | −0.41 |
| 559 | C₄H₉N⁺H₂C₆H₁₂(C₄H₉)NH | | 11.09 | 10.74 | 0.35 | −0.40 |
| 560 | t-C₄H₉NHC₆H₁₂(t-C₄H₉)NH | | 11.02 | 10.81 | 0.21 | −0.42 |
| 561 | t-C₄H₉N⁺H₂C₆H₁₂(t-C₄H₉)NH | | 11.00 | 10.83 | 0.17 | −0.42 |
| 562 | iso-C₃H₇NHC₆H₁₂(iso-C₃H₇)NH | | 11.21 | 10.70 | 0.51 | −0.39 |
| 563 | iso-C₃H₇N⁺H₂C₆H₁₂(iso-C₃H₇)NH | | 10.94 | 10.23 | 0.71 | −0.27 |
| 564 | C₆H₁₁(cyclo), 4-OH, 1-CH(OH)CH₂(iso-C₃H₇)NH | | 10.08 | 9.95 | 0.12 | −0.21 |
| 565 | C₆H₁₁(cyclo)(CH₃)NH | | 11.04 | 10.64 | 0.40 | −0.37 |
| 566 | (CH₃)₃SiCH₂[C₆H₁₁(cyclo)]NH | | 10.96 | 11.12 | −0.16 | −0.49 |
| 567 | (44) | | 6.46 | 8.03 | −1.57 | 0.26 |
| 568 | (CH₃)₂ClN | | 0.46 | 1.26 | −0.80 | 1.73 |
| 569 | NCCH₂(H₃C)₂N | | 4.24 | 4.79 | −0.55 | 0.87 |
| 570 | (H₃C)₃N | | 9.75 | 10.01 | −0.26 | −0.40 |
| 571 | HO(H₃C)₂N | | 5.20 | 4.52 | 0.68 | 0.93 |
| 572 | H₃CO(H₃C)₂N | | 3.65 | 4.72 | −1.07 | 0.89 |
| 573 | H₃CC(O)C₂H₄(H₅C₂)₂N | | 8.91 | 9.50 | −0.60 | −0.28 |
| 574 | H₃CC(O)C₂H₄(H₃C)₂N | | 8.25 | 8.80 | −0.55 | −0.11 |
| 575 | C₆H₅CH₂C(O)C₂H₄(H₅C₂)₂N | | 9.27 | 9.39 | −0.13 | −0.25 |
| 576 | C₆H₅CH₂C(O)C₂H₄(H₃C)₂N | | 8.18 | 8.51 | −0.33 | −0.04 |
| 577 | (ClC₂H₄)₂(H₅C₂)N | | 6.55 | 6.91 | −0.36 | 0.35 |
| 578 | (ClC₂H₄)₂(H₃COC₂H₄)N | | 5.45 | 5.53 | −0.08 | 0.69 |
| 579 | (NCC₂H₄)₂(H₅C₂)N | | 4.55 | 5.05 | −0.50 | 0.81 |
| 580 | (NCCH₂)₂(H₅C₂)N | | −0.60 | −0.28 | −0.32 | 2.10 |
| 581 | (ClC₂H₄)₃N | | 4.37 | 4.40 | −0.03 | 0.96 |
| 582 | (ClC₂H₄)₂(H₃C)N | | 6.43 | 6.78 | −0.35 | 0.38 |
| 583 | ClC₂H₄(H₅C₂)₂N | | 8.80 | 8.37 | 0.43 | 0.00 |
| 584 | Cl(H₅C₂)₂N | | 1.02 | 1.46 | −0.44 | 1.68 |
| 585 | HOC₂H₄(ClC₂H₄)(H₃C)N | | 7.48 | 7.50 | −0.02 | 0.21 |
| 586 | (NCC₂H₄)₃N | | 1.10 | 1.05 | 0.05 | 1.78 |
| 587 | NCC₂H₄(H₅C₂)₂N | | 7.65 | 7.86 | −0.21 | 0.12 |
| 588 | NCC₂H₄(H₃C)₂N | | 7.07 | 7.67 | −0.60 | 0.17 |
| 589 | NCC₂H₄(iso-H₇C₃)NH | | 8.10 | 8.08 | 0.01 | 0.07 |
| 590 | NCCH₂(H₅C₂)₂N | | 4.55 | 4.99 | −0.44 | 0.82 |
| 591 | (H₅C₂)₃N | | 10.75 | 10.30 | 0.45 | −0.47 |
| 592 | (C₆H₅)₂CHC(O)C₂H₄(H₅C₂)₂N | | 9.42 | 9.02 | 0.40 | −0.16 |
| 593 | HOC₂H₄(H₅C₂)₂N | | 9.74 | 9.30 | 0.43 | −0.23 |
| 594 | C₂H₅(H₃C)₂N | | 10.01 | 10.11 | −0.10 | −0.43 |
| 595 | (C₆H₅)₂CHC(O)C₂H₄(H₃C)₂N | | 8.59 | 8.89 | −0.30 | −0.13 |
| 596 | HOC₂H₄(H₃C)₂N | | 9.18 | 9.11 | 0.07 | −0.18 |
| 597 | H₃C(C₂H₅)₂N | | 10.31 | 10.20 | 0.10 | −0.45 |
| 598 | (HOC₂H₄)₃N | | 7.77 | 7.39 | 0.38 | 0.24 |
| 599 | H₃CC(O)C₃H₆(H₃C)₂N | | 8.94 | 9.73 | −0.80 | −0.33 |
| 600 | H₃CC(O)C(C₆H₅)₂CH(CH₃)CH₂(H₃C)₂N | | 9.40 | 8.90 | 0.50 | −0.13 |
| 601 | H₅C₆C(O)C(C₆H₅)₂C₂H₄(H₃C)₂N | | 9.34 | 8.51 | 0.83 | −0.04 |
| 602 | H₅C₆CH₂C(O)CH(C₆H₅)C₂H₄(H₅C₂)₂N | | 9.33 | 9.27 | 0.05 | −0.22 |
| 603 | H₅C₆CH₂C(O)CH(C₆H₅)C₂H₄(H₃C)₂N | | 8.86 | 9.09 | −0.23 | −0.18 |
| 604 | (ClC₂H₄)₂(H₇C₃)N | | 6.68 | 7.21 | −0.53 | 0.28 |
| 605 | (ClC₂H₄)₂(iso-H₇C₃)N | | 6.98 | 7.43 | −0.45 | 0.23 |
| 606 | (H₃CCH(OH)CH₂)₂(H₇C₃)N | | 8.90 | 8.28 | 0.62 | 0.02 |
| 607 | (H₃CCH(OH)CH₂)₂(iso-H₉C₄)N | | 8.80 | 8.25 | 0.55 | 0.03 |
| 608 | (H₃CCH(OH)CH₂)₂(t-H₉C₄)N | | 9.40 | 8.81 | 0.59 | −0.11 |
| 609 | H₉C₄C(O)C(C₆H₅)₂C₂H₄(CH₃)₂N | | 10.23 | 9.10 | 1.13 | −0.18 |
| 610 | ⁻OOCC(C₆H₅)₂C₂H₄(C₂H₅)₂N | | 10.44 | 9.93 | 0.51 | −0.38 |
| 611 | ⁻OOCC(C₆H₅)₂C₂H₄CH(CH₃)(H₃C)₂N | | 10.73 | 9.66 | 1.06 | −0.32 |
| 612 | NCC₃H₆(C₂H₅)₂N | | 9.29 | 8.83 | 0.46 | −0.11 |
| 613 | NCC(C₆H₅)₂C₂H₄(C₂H₅)₂N | | 8.95 | 7.89 | 1.06 | 0.12 |
| 614 | NCC(C₆H₅)₂C₂H₄(H₃C)₂N | | 8.26 | 7.69 | 0.57 | 0.16 |
| 615 | NCC(C₆H₅)₂CH(CH₃)CH₂(H₃C)₂N | | 7.85 | 7.24 | 0.61 | 0.27 |
| 616 | NCC(C₆H₅)₂CH₂(H₃C)CH(H₃C)₂N | | 8.56 | 7.78 | 0.78 | 0.14 |
| 617 | (H₃CCH(OH)CH₂)₃N | | 7.86 | 8.06 | −0.20 | 0.07 |
| 618 | (iso-C₄H₉)₃N | | 10.32 | 10.80 | −0.48 | −0.59 |
| 619 | C₃H₇(H₃C)₂N | | 10.01 | 10.17 | −0.17 | −0.44 |
| 620 | iso-C₃H₇(H₃C)₂N | | 10.32 | 10.21 | 0.11 | −0.45 |
| 621 | CH(C₆H₅)₂C₂H₄(CH₃)₂N | | 9.35 | 9.39 | −0.04 | −0.25 |
| 622 | H₅C₂OC(O)C(C₆H₅)₂C₂H₄(H₃C)₂N | | 9.72 | 8.56 | 1.15 | −0.05 |
| 623 | H₅C₂OC(O)C(C₆H₅)₂CH₂CH(CH₃)(H₃C)₂N | | 9.97 | 8.69 | 1.27 | −0.08 |
| 624 | H₅C₂C(O)C(C₆H₅)₂C₂H₄(H₃C)₂N | | 9.18 | 8.99 | 0.19 | −0.15 |
| 625 | iso-C₄H₉(H₃C)₂N | | 9.93 | 10.30 | −0.38 | −0.47 |
| 626 | t-C₄H₉(H₃C)₂N | | 10.54 | 10.30 | 0.23 | −0.47 |
| 627 | (H₇C₃)₃N | | 10.26 | 10.51 | −0.25 | −0.52 |
| 628 | HOC₂H₄(iso-H₇C₃)₂N | | 9.93 | 9.76 | 0.16 | −0.34 |
| 629 | H₃CCH(OH)CH₂(HOC₂H₄)(H₃C)N | | 8.70 | 8.33 | 0.37 | 0.01 |
| 630 | H₂C═CHCH₂(H₃CCH(OH)CH₂)₂N | | 8.20 | 8.36 | −0.16 | 0.00 |
| 631 | (H₂C═CHCH₂)₃N | | 8.31 | 8.11 | 0.20 | 0.06 |
| 632 | H₂C═CHCH₂(H₃C)₂N | | 8.64 | 9.40 | −0.76 | −0.25 |
| 633 | H₃C(H₂C═CHCH₂)₂N | | 8.79 | 8.72 | 0.07 | −0.09 |
| 634 | HC≡CHCH₂(H₃C)₂N | | 6.97 | 7.68 | −0.71 | 0.17 |
| 635 | (HC≡CHCH₂)₃N | | 3.09 | 3.11 | −0.02 | 1.28 |
| 636 | H₃CC(O)C₄H₈(H₃C)₂N | | 9.61 | 9.95 | −0.34 | −0.39 |
| 637 | (ClC₂H₄)₂(C₄H₉)N | | 6.61 | 7.22 | −0.61 | 0.28 |
| 638 | (H₃CCH(OH)CH₂)₂(H₉C₄)N | | 9.30 | 9.23 | 0.07 | −0.21 |
| 639 | NCC₄H₈(H₅C₂)₂N | | 10.08 | 9.41 | 0.67 | −0.26 |
| 640 | NCC(C₆H₅)₂CH₂CH(CH₃)(H₃C)₂N | | 8.26 | 7.70 | 0.56 | 0.16 |
| 641 | (C₄H₉)₃N | | 9.93 | 10.65 | −0.72 | −0.56 |
| 642 | C₄H₉(CH₃)₂N | | 10.04 | 10.22 | −0.19 | −0.45 |
| 643 | sec-C₄H₉(CH₃)₂N | | 10.42 | 10.27 | 0.15 | −0.46 |
| 644 | CH(C₆H₅)₂CH₂CH(CH₃)(CH₃)₂N | | 9.43 | 9.46 | −0.03 | −0.27 |
| 645 | C₂H₅C(O)C(C₆H₅)₂CH₂CH(CH₃)(CH₃)₂N | | 8.94 | 9.01 | −0.07 | −0.16 |
| 646 | (C₆H₅)₂C═CHCH(CH₃)(CH₃)₂N | | 9.21 | 8.73 | 0.48 | −0.09 |
| 647 | HC≡CHC₂H₄(H₃C)₂N | | 8.25 | 8.75 | −0.50 | −0.10 |
| 648 | C₅H₁₁(CH₃CH(OH)CH₂)₂N | | 9.00 | 8.59 | 0.41 | −0.05 |
| 649 | NCC₅H₁₀(C₂H₅)₂N | | 10.46 | 9.71 | 0.75 | −0.33 |
| 650 | iso-C₃H₇(H₃C)₂N | | 9.96 | 10.55 | −0.59 | −0.53 |
| 651 | HC≡CC₃H₆(H₃C)₂N | | 8.80 | 9.49 | −0.69 | −0.28 |
| 652 | C₆H₁₃(CH₃CH(OH)CH₂)₂N | | 8.50 | 8.34 | 0.16 | 0.00 |
| 653 | HC≡CC₄H₈(H₃C)₂N | | 9.16 | 9.81 | −0.65 | −0.35 |
| 654 | C₈H₁₇(CH₃CH(OH)CH₂)₂N | | 8.30 | 8.58 | −0.28 | −0.05 |
| 655 | C₁₀H₂₁(CH₃CH(OH)CH₂)₂N | | 7.60 | 8.12 | −0.52 | 0.06 |
| 656 | C₆H₄(4-CH₂Br)C(O)OC₂H₄(C₂H₅)₂N | | 8.12 | 8.51 | −0.39 | −0.04 |
| 657 | C₆H₄(3-CH₂OC₄H₉)C(O)OC₂H₄(C₂H₅)₂N | | 8.11 | 8.79 | −0.68 | −0.10 |
| 658 | C₆H₄(4-OC₄H₉)C(O)OC₂H₄[C₅H₉(cyclo)]₂N | | 8.30 | 8.75 | −0.45 | −0.09 |
| 659 | C₆H₄(4-Cl)C(O)OC₂H₄(C₂H₅)₂N | | 8.08 | 8.53 | −0.45 | −0.04 |
| 660 | C₆H₅CH₂CH(CH₃)(NCC₂H₄)(CH₃)N | | 6.95 | 7.35 | −0.40 | 0.25 |
| 661 | C₆H₅C(O)OCH₂C(CH₃)₂CH₂(C₂H₅)₂N | | 9.58 | 9.69 | −0.11 | −0.32 |
| 662 | C₆H₅CH═CHC(O)OC₃H₆(C₂H₅)₂N | | 9.71 | 9.45 | 0.26 | −0.26 |
| 663 | C₆H₅CH₂CH(CH₃)(CH₃)₂N | | 9.40 | 9.68 | −0.28 | −0.32 |
| 664 | C₆H₅CH₂(C₂H₅)₂N | | 9.44 | 9.05 | 0.39 | −0.17 |
| 665 | C₆H₅CH₂(H₃C)₂N | | 8.91 | 8.85 | 0.06 | −0.12 |
| 666 | (45) | | 10.40 | 9.86 | 0.54 | −0.36 |
| 667 | (46) | | 8.67 | 8.72 | −0.06 | −0.09 |
| 668 | (47) | | 8.90 | 8.30 | 0.59 | 0.01 |
| 669 | (48) | | 10.46 | 10.36 | 0.10 | −0.49 |
| 670 | (49) | | 10.73 | 10.46 | 0.27 | −0.51 |
| 671 | (50) | | 8.02 | 7.39 | 0.63 | 0.24 |
| 672 | (51) | | 4.55 | 4.96 | −0.41 | 0.83 |
| 673 | (52) | | 7.68 | 7.47 | 0.21 | 0.22 |
| 674 | (53) | | 7.49 | 7.69 | −0.20 | 0.16 |
| 675 | (54) | | 10.22 | 10.25 | −0.03 | −0.46 |
| 676 | (55) | | 8.91 | 9.34 | −0.43 | −0.24 |
| 677 | (56) | | 10.39 | 10.24 | 0.14 | −0.46 |
| 678 | (57) | | 8.81 | 9.19 | −0.38 | −0.20 |
| 679 | (58) | | 8.53 | 9.19 | −0.66 | −0.20 |
| 680 | (59) | | 9.27 | 8.93 | 0.34 | −0.14 |
| 681 | (60) | | 10.66 | 10.34 | 0.32 | −0.48 |
| 682 | (61) | | 10.41 | 9.96 | 0.44 | −0.39 |
| 683 | (62) | | 10.09 | 10.15 | −0.06 | −0.43 |
| 684 | (63) | | 8.53 | 9.15 | −0.62 | −0.19 |
| 685 | (64) | | 8.75 | 9.68 | −0.93 | −0.32 |
| 686 | (65) | | 7.41 | 8.18 | −0.77 | 0.04 |
| 687 | (66) | | 8.23 | 8.88 | −0.65 | −0.13 |
| 688 | (67) | | 8.15 | 8.87 | −0.72 | −0.12 |
| 689 | (68) | | 9.54 | 9.42 | 0.12 | −0.26 |
| 690 | (69) | | 11.36 | 10.50 | 0.86 | −0.52 |
| 691 | (70) | | 10.46 | 10.31 | 0.14 | −0.48 |
| 692 | (71) | | 10.34 | 10.41 | −0.07 | −0.50 |
| 693 | (72) | | 10.86 | 10.43 | 0.42 | −0.50 |
| 694 | (73) | | 10.31 | 10.34 | −0.04 | −0.48 |
| 695 | (74) | | 6.73 | 7.23 | −0.50 | 0.27 |
| 696 | (75) | | 6.13 | 6.74 | −0.61 | 0.39 |
| 697 | (76) | | 6.07 | 6.64 | −0.57 | 0.42 |
| 698 | (77) | | 6.04 | 5.95 | 0.09 | 0.59 |
| 699 | (78) | | 6.05 | 6.40 | −0.35 | 0.48 |
| 700 | (79) | | 6.29 | 6.82 | −0.53 | 0.38 |
| 701 | (80) | | 7.20 | 8.03 | −0.83 | 0.08 |
| 702 | (81) | | 7.07 | 7.73 | −0.66 | 0.15 |
| 703 | (82) | | 7.67 | 8.67 | −1.00 | −0.08 |
| 704 | (83) | | 6.95 | 7.99 | −1.04 | 0.09 |
| 705 | (84) | | 6.68 | 8.10 | −1.42 | 0.06 |
| 706 | (85) | | 7.02 | 8.12 | −1.10 | 0.06 |
| 707 | (86) | | 7.38 | 8.83 | −1.45 | −0.12 |
| 708 | (87) | | 6.85 | 8.38 | −1.53 | 0.00 |
| 709 | (88) | | 10.95 | 10.06 | 0.89 | −0.41 |
| 710 | (89) | | 7.81 | 7.91 | −0.10 | 0.11 |
| 711 | (90) | | 9.40 | 9.07 | 0.33 | −0.17 |
| 712 | (91) | | 10.23 | 9.60 | 0.63 | −0.30 |
| 713 | ⁻OOCCH(CH₃)(C₂H₅)NH | | 10.22 | 10.17 | 0.05 | −0.44 |
| 714 | ⁻OOCC₂H₄(H₃C)₂N | | 9.85 | 10.25 | −0.40 | −0.46 |
| 715 | C₂H₅OOCC₂H₄(H₃C)₂N | | 8.54 | 10.10 | −1.56 | −0.42 |
| 716 | (C₂H₅)₂NC(O)CH₂(C₂H₅)NH | | 8.81 | 8.70 | 0.11 | −0.08 |
| 717 | ⁻OOCCH₂(C₂H₅)₂N | | 10.47 | 10.33 | 0.14 | −0.48 |
| 718 | ⁻OOCCH₂(H₃C)₂N | | 9.94 | 9.75 | 0.19 | −0.34 |
| 719 | —OOCCH₂NHC(O)CH₂(H₃C)₂N | | 8.09 | 7.99 | 0.10 | 0.09 |
| 720 | ⁻OOCCH₂NHC(O)CH(iso-C₄H₉)(C₂H₅)₂N | | 7.78 | 8.03 | −0.25 | 0.08 |
| 721 | ⁻OOCCH₂(C₂H₅)NH | | 10.23 | 10.03 | 0.20 | −0.41 |
| 722 | (C₂H₅)₂NC₂H₄NH₂ | | 10.02 | 10.37 | −0.35 | −0.49 |
| 723 | (CH₃)₂NC₂H₄NH₂ | | 9.53 | 9.95 | −0.42 | −0.39 |
| 724 | (C₂H₅)₂NC₂H₄(C₂H₅)₂N | | 9.55 | 10.06 | −0.51 | −0.41 |
| 725 | (C₂H₅)₂N⁺HC₂H₄(C₂H₅)₂N | | 6.18 | 6.42 | −0.24 | 0.47 |
| 726 | (H₃CCH(OH)CH₂)₂NC₂H₄(H₃CCH(OH)CH₂)₂N | | 8.84 | 8.66 | 0.18 | −0.07 |
| 727 | (H₃CCH(OH)CH₂)₂N⁺HC₂H₄(H₃CCH(OH)CH₂)₂N | | 4.33 | 4.29 | 0.04 | 0.99 |
| 728 | (H₃C)₂NC₂H₄(H₃C)₂N | | 9.02 | 9.73 | −0.72 | −0.33 |
| 729 | (H₃C)₂N⁺HC₂H₄(H₃C)₂N | | 5.66 | 5.87 | −0.22 | 0.61 |
| 730 | (H₅C₂)₂NC₂H₄OC₂H₄(H₅C₂)₂N | | 9.96 | 9.67 | 0.29 | −0.32 |
| 731 | (H₅C₂)₂N⁺HC₂H₄OC₂H₄(H₅C₂)₂N | | 8.49 | 9.01 | −0.52 | −0.16 |
| 732 | (H₃C)₂NC₂H₄OC₂H₄(H₅C₂)₂N | | 10.02 | 9.47 | 0.54 | −0.27 |
| 733 | (H₅C₂)₂N⁺HC₂H₄OC₂H₄(H₃C)₂N | | 8.26 | 8.55 | −0.29 | −0.05 |
| 734 | (H₃C)(C₂H₅)NC₂H₄OC₂H₄(H₅C₂)₂N | | 9.97 | 9.57 | 0.39 | −0.29 |
| 735 | (H₅C₂)₂N⁺HC₂H₄OC₂H₄(H₃C)(C₂H₅)N | | 8.34 | 8.55 | −0.21 | −0.05 |
| 736 | (H₃C)₂NC₂H₄OC₂H₄(H₃C)₂N | | 9.62 | 9.14 | 0.47 | −0.19 |
| 737 | (H₃C)₂N⁺HC₂H₄OC₂H₄(H₃C)₂N | | 8.07 | 8.34 | −0.27 | 0.00 |
| 738 | (H₃C)₂NC₂H₄N(CH₃)C₂H₄(H₃C)₂N | | 9.32 | 9.59 | −0.27 | −0.30 |
| 739 | (H₃C)₂N⁺HC₂H₄N(CH₃)C₂H₄(H₃C)₂N | | 8.33 | 8.80 | −0.48 | −0.11 |
| 740 | H₃C[(H₃C)₂N⁺HC₂H₄]₂N | | 2.39 | 2.12 | 0.27 | 1.52 |
| 741 | (H₃C)₂NC₂H₄OC₂H₄(H₅C₂)(H₃C)N | | 9.49 | 9.17 | 0.32 | −0.20 |
| 742 | (H₅C₂)(H₃C)N⁺HC₂H₄OC₂H₄(H₃C)₂N | | 7.82 | 8.06 | −0.24 | 0.07 |
| 743 | (H₃C)₂NC₂H₄SC₂H₄(H₃C)₂N | | 9.02 | 8.94 | 0.08 | −0.14 |
| 744 | (H₃C)₂N⁺HC₂H₄SC₂H₄(H₃C)₂N | | 7.93 | 8.29 | −0.36 | 0.02 |
| 745 | H₂N + C₃H₆N(CH₃)C₃H₆NH₂ | | 6.45 | 6.84 | −0.39 | 0.37 |
| 746 | (H₅C₂)₂NC₃H₆(H₅C₂)₂N | | 10.18 | 10.33 | −0.15 | −0.48 |
| 747 | (H₅C₂)₂N⁺HC₃H₆(H₅C₂)₂N | | 8.20 | 8.46 | −0.26 | −0.02 |
| 748 | (H₅C₂)₂NCH₂CH(OH)CH₂(H₅C₂)₂N | | 9.80 | 9.31 | 0.49 | −0.23 |
| 749 | (H₅C₂)₂N⁺HCH₂CH(OH)CH₂(H₅C₂)₂N | | 7.74 | 7.97 | −0.23 | 0.09 |
| 750 | (H₃C)₂NCH₂CH(CH₃)(CH₃)₂N | | 9.63 | 10.04 | −0.42 | −0.41 |
| 751 | (H₃C)₂N⁺HCH(CH₃)CH₂(CH₃)₂N | | 5.47 | 5.94 | −0.47 | 0.59 |
| 752 | (H₃C)₂NC₃H₆(H₃C)₂N | | 9.71 | 10.07 | −0.36 | −0.42 |
| 753 | (H₃C)₂N⁺HC₃H₆(H₃C)₂N | | 7.63 | 7.68 | −0.05 | 0.17 |
| 754 | (CH₃CH(OH)CH₂)₂NC₃H₆(H₃C)₂N | | 9.20 | 9.23 | −0.03 | −0.21 |
| 755 | (H₃C)₂N⁺HC₃H₆(CH₃CH(OH)CH₂)₂N | | 6.50 | 6.54 | −0.04 | 0.44 |
| 756 | (H₃C)₂NC₃H₆N(H₃C)C₃H₆(H₃C)₂N | | 9.91 | 10.10 | −0.20 | −0.42 |
| 757 | (H₃C)₂N⁺HC₃H₆N(H₃C)C₃H₆(H₃C)₂N | | 8.92 | 9.13 | −0.21 | −0.19 |
| 758 | [(H₃C)₂N⁺HC₃H₆]₂(H₃C)N | | 6.35 | 6.65 | −0.30 | 0.42 |
| 759 | H₂NC₄H₈(H₅C₂)₂N | | 9.20 | 9.25 | −0.05 | −0.22 |
| 760 | H₂NCH(CH₃)C₃H₆(H₅C₂)₂N | | 9.55 | 9.45 | 0.10 | −0.26 |
| 761 | C₆H₁₁(cyclo)(H₃C)₂N | | 10.72 | 10.41 | 0.31 | −0.50 |
| 762 | (92) | | 10.32 | 9.70 | 0.62 | −0.33 |
| 763 | (93) | | 10.37 | 10.06 | 0.31 | −0.41 |
| 764 | (94) | | 6.87 | 7.82 | −0.95 | 0.13 |
| 765 | (95) | | 9.58 | 9.85 | −0.28 | −0.36 |
| 766 | (96) | | 9.37 | 9.32 | 0.04 | −0.23 |
| 767 | (97) | | 9.70 | 9.52 | 0.17 | −0.28 |
| 768 | ⁻OOCCH(CH₂C(O)NH₂)NH₂ | | 8.80 | 8.80 | 0.00 | 0.26 |
| 769 | H₂NC₂H₄Si(CH₃)₂OSi(CH₃)₂C₂H₄NH₂ | | 10.74 | 10.48 | 0.26 | −0.15 |
| 770 | H₂NCH₂Si(CH₃)₂OSi(CH₃)₂CH₂NH₂ | | 10.30 | 10.31 | −0.01 | −0.11 |
| 771 | C₆H₁₁(cyclo)NHCH₂Si(CH₃)₂OSi(CH₃)₂CH₂[C₆H₁₁(cyclo)]NH | | 10.11 | 10.54 | −0.43 | −0.35 |
| 772 | iso-C₃H₇NHCH₂Si(CH₃)₂OSi(CH₃)₂CH₂(iso-C₃H₇)NH | | 10.40 | 10.40 | 0.00 | −0.31 |
| 773 | H₂N(C₂H₅)₂N | | 7.71 | 7.37 | 0.34 | 0.24 |
| 774 | (C₂H₅)₂N(C₂H₅)₂N | | 7.78 | 7.65 | 0.13 | 0.36 |
| 775 | H₂N(H₃C)₂N | | 7.21 | 7.39 | −0.18 | 0.24 |
| 776 | H₃CNH(H₃C)NH | | 7.52 | 7.46 | 0.06 | 0.40 |
| 777 | H₂N(C₂H₅)NH | | 7.99 | 7.53 | 0.46 | 0.38 |
| 778 | H₂N(H₃C)NH | | 7.87 | 7.59 | 0.28 | 0.37 |
| 779 | (H₃C)₂N(H₃C)₂N | | 6.30 | 7.47 | −1.17 | 0.22 |
| 780 | H₃CNH(H₃C)₂N | | 6.78 | 7.27 | −0.49 | 0.27 |
| 781 | (98) | | 10.00 | 9.81 | 0.19 | −0.35 |
| 782 | H₂NC(O)NHNH₂ | | 3.65 | 5.31 | −1.66 | 1.11 |
| 783 | ⁻OOCCH₂(H₅C₂)NH | | 10.23 | 9.97 | 0.26 | −0.21 |
| 784 | ⁻OOCCH(CH₃)(H₅C₂)NH | | 10.22 | 10.15 | 0.07 | −0.25 |
| 785 | C₆H₁₀(cyclo), 1-COO⁻, 1-NH₂ | | 10.03 | 10.37 | −0.34 | −0.12 |
| 786 | C₆H₁₀(cyclo), 1-COO⁻, 2-NH₂ | | 10.10 | 9.84 | 0.26 | 0.01 |
| 787 | C₆H₁₀(cyclo), 1-COO⁻, 3-NH₂ | | 10.50 | 10.54 | −0.04 | −0.17 |
| 788 | C₆H₁₀(cyclo), 1-COO⁻, 4-NH₂ | axial | 10.55 | 10.61 | −0.06 | −0.18 |
| 789 | C₆H₁₀(cyclo), 1-COO⁻, 4-NH₂ | ecvat | 10.62 | 10.60 | 0.02 | −0.18 |
| 790 | H₂NC(O)NHC₃H₆CH(COO⁻)NH₂ | | 9.41 | 9.86 | −0.45 | 0.00 |
| 791 | (⁻OOCCH₂)₂NH | | 9.12 | 8.80 | 0.32 | 0.07 |
| 792 | (⁻OOCCH₂)₂(H₃C)N | | 9.92 | 9.20 | 0.72 | −0.20 |
| 793 | (⁻OOCCH₂)₃N | | 10.23 | 9.23 | 1.00 | −0.21 |
| 794 | ⁻OOCCH₂(⁻OOCC₂H₄)NH | | 9.46 | 9.00 | 0.46 | 0.03 |
| 795 | (⁻OOCC₂H₄)₂NH | | 9.61 | 9.89 | −0.28 | −0.19 |
| 796 | ⁻OOCCH₂NHC₂H₄(⁻OOCCH₂)NH | | 9.46 | 9.33 | 0.13 | −0.05 |
| 797 | ⁻OOCC₉H₁₉SC₂H₄NH₂ | | 8.30 | 9.83 | −1.53 | 0.01 |
| 798 | ⁻OOCC₁₀H₂₁SC₂H₄NH₂ | | 9.60 | 9.16 | 0.44 | 0.17 |
| 799 | ⁻OOCC₁₀H₂₁NHC₂H₄SSC₂H₄(⁻OOCC₁₀H₂₁)NH | | 9.90 | 9.16 | 0.74 | −0.01 |
| 800 | H₂NOC₂H₄CH(COO⁻)NH₂ | | 9.20 | 8.74 | 0.46 | 0.27 |
| 801 | C₂H₅SCH₂CH(COO⁻)NH₂ | | 8.60 | 9.19 | −0.59 | 0.16 |
| 802 | NH₃ | | 9.25 | 10.61 | −1.36 | |

The numbers in the table correspond to the molecular structures from Scheme 2.

The examples and embodiments described in this patent are for illustrative purposes only and various modifications or changes will be suggested to persons skilled in the art and are to be included within the disclosure in this application and scope of the claims. All publications, patents and patent applications cited in this patent are hereby incorporated by reference in their entirety for all purposes to the same extent as if each individual publication, patent or patent application were specifically and individually indicated to be so incorporated by reference.

1. A method for calculating a characteristic property of a molecule, where the molecule has one or more measured properties and the molecule comprises one or more substituent parts, the method comprising
selecting one or more contributing substituent parts;
for each contributing substituent part, calculating the distance from the substituent part to a reaction center;
for each contributing substituent part, calculating a contribution of the substituent part to a characteristic property of the molecule, where the contribution is equal to a function of the distance of the substituent part to the reaction center multiplied by a weight factor for the substituent part, and the where the function has a functional form that is substantially the same for all substituent parts; and
calculating the characteristic property of the molecule by summing the contributions from the contributing substituent parts of the molecule plus a contribution comprising a value of a measured property of the molecule multiplied by a weight factor.

2. The method of claim 1, wherein the characteristic property is a chemical characteristic property.

3. The method of claim 1, wherein the characteristic property is any property related to the free energy of the molecule.

4. The method of claim 2, wherein the chemical characteristic property is selected from the group consisting of pKa, reaction rate constants, equilibrium constants, solubility, ionization potentials, atomization energy, evaporation energy, and energy of bonds.

5. The method of claim 1, wherein the molecule is selected from the group consisting of organic molecules, inorganic molecules, neutral molecules, radicals, anions, cations, ionic salts, metallo-organic compounds and coordination compounds.

6. The method of claim 1, wherein a substituent part of the molecule is an atom contained in the-molecule or a group of connected atoms contained in the molecule.

7. The method of claim 1, wherein the contributing substituent parts include all substituent parts of the molecule except one.

8. The method of claim 1, wherein the reaction center is a point in space.

9. The method of claim 1, wherein the reaction center is an atom contained in the molecule.

10. The method of claim 1, wherein the reaction center comprises a substituent parts of the molecule.

11. The method of claim 10, wherein the reaction center is one of the substituent parts of the molecule.

12. The method of claim 11, wherein the contributing substituent parts include all substituent parts in the molecule except the reaction center substituent part.

13. The method of claim 1, wherein the function of the distance is of the form of an inverse function of the distance.

14. The method-of claim 13 wherein the function of the distance is of the form of the inverse of the square of the distance.

15. The method of claim 13, wherein the function of the distance is of the form of sum the inverse of the square of the distance and the inverse of the cube of the distance.

16. The method of claim 13, wherein the function of the distance is of the form of the inverse of the cube of the distance.

17. The method of claim 1, wherein the weight factor is calculated as a regression coefficient for a multivariate regression analysis calculated for a series of molecules.

18. The method of claim 17, wherein for the multivariate regression analysis a dependent variable is the characteristic property for one of molecules in the series and there is an independent variable for each type of substituent part present in the series of molecules, and for a particular independent variable the value of the dependent variable corresponding to a particular substituent part is equal to a sum over all of the particular substituent parts in the molecule corresponding to the independent variable of the function of the distance from the reaction center to the particular substituent part.

19. The method of claim 17, wherein the series of molecules analogs of the molecule.

20. The method of claim 17, wherein the series of molecules that have the same reaction center as the molecule.

21. The method of claim 17, wherein the reaction center is a point in space or a substituent part of the molecule and the reaction center is identified by a method comprising
for a first reaction center, performing the multivariable regression analysis and determining a first characteristic of the multivariable regression analysis,
for a second reaction center, performing the multivariable regression analysis and determining a second characteristic of the multivariable regression analysis,
identifying the reaction center as that reaction center with the multivariable regression analysis characteristic satisfying a predetermined criteria.

22. The method of claim 21, wherein the characteristic of the multivariable regression analysis is the global regression coefficient and the predetermined criteria selects for the reaction center with the highest global regression coefficient.

23. The method of claim 21, wherein the characteristic of the multivariable regression analysis is the global standard error and the predetermined criteria selects for the reaction center with the lowest standard error.

24. The method of claim 1, wherein one of the measured properties of the molecule is the hydrophobicity of the molecule.

25. The method of claim 1, wherein the measured property weight factor is calculated as a regression coefficient for a multivariate regression analysis calculated for a series of molecules.

26. The method of claim 25, wherein for the multivariate regression analysis a dependent variable is the characteristic property for one of molecules in the series and the independent variables comprise a value for a measured property.

27. A method for calculating a characteristic property of a molecule, where the molecule has one or more measured properties and the molecule comprises one or more substituent parts, the method comprising
denominating one of the substituent parts as a reaction center;
for each substituent part other than the reaction center, calculating the distance from the substituent part to the reaction center;
for each substituent part other than the reaction center, calculating a contribution of the substituent part to the characteristic property of the molecule, where the contribution is equal to the inverse of the square of the distance of the substituent part to the reaction center multiplied by a weight factor for the substituent part, and where the weight factor is calculated as a regression coefficient for a multivariate regression analysis calculated for a series of molecules comprising analogs of the molecule;
for each measured property, calculating the contribution of the measured property, where the contribution is equal to the value of the measured property multiplied by a weight factor, and where the weight factor is calculated as a regression coefficient for a multivariate regression analysis calculated for a series of molecules comprising analogs of the molecule;
calculating the property of the molecule by summing the contributions from the contributing substituent parts of the molecule plus the contribution or contributions from the one or more measured properties.

28. The method of claim 27, wherein the characteristic property is a chemical characteristic property.

29. The method of claim 28 wherein the characteristic property is any property related to the free energy of the molecule.

30. The method of claim 28, wherein the chemical characteristic property is selected from the group consisting of pKa, reaction rate constants, equilibrium constants, solubility, ionization potentials, atomization energy, evaporation energy, energy of bonds.

31. The method of claim 27, wherein the molecule is selected from the group consisting of organic molecules, inorganic molecules, neutral molecules, radicals, anions, cations, ionic salts, metallo-organic compounds and coordination compounds.

32. The method of claim 27, wherein the one or more substituent parts of the molecule are atoms contained in the molecule or groups of connected atoms contained in the molecule.

33. The method of claim 27, wherein for the multivariate regression analysis a dependent variable is the characteristic property for one of molecules in the series and there is an independent variable for each type of substituent part present in the series of molecules, and for a particular independent variable the value of the dependent variable corresponding a particular substituent part is equal to a sum over all of the particular substituent parts in the molecule corresponding to the independent variable of the inverse square of the distance from the reaction center to the particular substituent part.

34. The method of claim 27, wherein the reaction center is identified by a method comprising
for a first reaction center, performing the multivariable regression analysis and determining a first characteristic of the multivariable regression analysis,
for a second reaction center, performing the multivariable regression analysis and determining a second characteristic of the multivariable regression analysis,
identifying the reaction center as that reaction center with the multivariable regression analysis characteristic satisfying a predetermined criteria.

35. The method of claim 34, wherein the characteristic of the multivariable regression analysis is the global regression coefficient and the predetermined criteria selects for the reaction center with the highest global regression coefficient.

36. The method of claim 34, wherein the characteristic of the multivariable regression analysis is the global standard error and the predetermined criteria selects for the reaction center with the lowest standard error.

37. The method of claim 27, wherein one of the measured properties of the molecule is the hydrophobicity of the molecule.

38. A method for calculating a chemical characteristic property of a molecule, where the molecule has a hydrophobicity and the molecule comprises one or more substituent parts and the substituent parts are atoms contained in the molecule or groups of connected atoms contained in the molecule, the method comprising
selecting one of the substituent parts as a reaction center;
for each substituent part other than the reaction center, calculating the distance from the substituent part to the reaction center;
for each substituent part other than the reaction center, calculating a contribution of the substituent part to the characteristic property of the molecule, where the contribution is equal to the inverse of the square of the distance of the substituent part to the reaction center multiplied by a weight factor for the substituent part, and where the weight factor is calculated as a regression coefficient for a multivariate regression analysis calculated for a series of molecules comprising analogs of the molecule;
calculating the contribution of the hydrophobicity as equal to the value of the hydrophobicity multiplied by a weight factor calculated as a regression coefficient for a multivariate regression analysis calculated for a series of molecules comprising analogs of the molecule;
calculating the characteristic property of the molecule by summing the contributions from the contributing substituent parts of the molecule plus the contribution from the hydrophobicity.

39. The method of claim 38, wherein the chemical characteristic property is selected from the group consisting of pKa, reaction rate constants, equilibrium constants, solubility, ionization potentials, atomization energy, evaporation energy, energy of bonds.

40. The method of claim 39, wherein the chemical characteristic is any property related to the free energy of the molecule.

41. The method of claim 38, wherein the molecule is selected from the group consisting of organic molecules, inorganic molecules, neutral molecules, radicals, anions, cations, ionic salts and metallo-organic compounds and coordination compounds.

42. The method of claim 41 wherein the molecule is an aniline mustard, nonsteroidal anti-inflammatory drug (NSAID), mytomycin, amine, or carboxylic acid.

43. The method of claim 38, wherein for the multivariate regression analysis a dependent variable is the characteristic property for one of molecules in the series and there is an independent variable for each type of substituent part present in the series of molecules, and for a particular independent variable the value of the dependent variable corresponding a particular substituent part is equal to a sum over all of the particular substituent parts in the molecule corresponding to the independent variable of the inverse square of the distance from the reaction center to the particular substituent part.

44. The method of claim 38, wherein the reaction center is selected by a method comprising the steps of
for a first reaction center, performing the multivariable regression analysis and determining a first characteristic of the multivariable regression analysis;
for a second reaction center, performing the multivariable regression analysis and determining a second characteristic of the multivariable regression analysis; and
selecting the reaction center as that reaction center with the multivariable regression analysis characteristic satisfying a predetermined criteria.

45. The method of claim 44, wherein the characteristic of the multivariable regression analysis is the global regression coefficient and the predetermined criteria selects for the reaction center with the highest global regression coefficient.

46. The method of claim 44, wherein the characteristic of the multivariable regression analysis is the global standard error and the predetermined criteria selects for the reaction center with the lowest standard error.

47. A method for calculating a chemical characteristic property of a molecule, where the molecule comprises one or more substituent parts and the chemical characteristic property is selected from the group consisting of pKa, reaction rate constants, equilibrium constants, solubility, ionization potentials, atomization energy, evaporation energy, and bond energy,
the method comprising the steps of
selecting one or more contributing substituent parts;
for each contributing substituent part, calculating a distance from the substituent part to a reaction center;
for each contributing substituent part, calculating the contribution of the substituent part to the characteristic property of the molecule, where the contribution is equal to a function of the distance of the substituent part to the reaction center multiplied by a weight factor for the substituent part and the function has a functional form that is substantially the same for all substituent parts; and
calculating the characteristic property of the molecule by summing the contributions from the contributing substituent parts of the molecule.

48. The method of claim 47, wherein the molecule is an organic molecule, inorganic molecule, neutral molecule, radical, anion, cation, ionic salt, metallo-organic compound or a coordination compound.

49. The method of claim 47, wherein the one or more substituent parts of the molecule are atoms contained in the molecule or groups of connected atoms contained in the molecule.

50. The method of claim 47, wherein the contributing substituent parts include all substituent parts of the molecule except one.

51. The method of claim 47, wherein the reaction center is a point in space.

52. The method of claim 47, wherein the reaction center is an atom contained within the molecule.

53. The method of claim 47, wherein the reaction center comprises a substituent part of the molecule.

54. The method of claim 53, wherein the reaction center is one of the substituent parts.

55. The method of claim 53, wherein the contributing substituent parts include all substituent parts in the molecule except the reaction center substituent part.

56. The method of claim 47, wherein the function of the distance is of the form of an inverse function of the distance.

57. The method of claim 56, wherein the function of the distance goes as the inverse of the square of the distance.

58. The method of claim 56, wherein the function of the distance is of the form of the sum of the inverse of the square of the distance and the inverse of the cube of the distance.

59. The method of claim 56, wherein the function of the distance is of the form of the inverse of the cube of the distance.

60. The method of claim 47, wherein the weight factor is calculated as a regression coefficient for a multivariate regression analysis calculated for a series of molecules.

61. The method of claim 60, wherein for the multivariate regression analysis a dependent variable is the characteristic property for one of molecules in the series and there is an independent variable for each type of substituent part present in the series of molecules, and for a particular independent variable the value of the dependent variable corresponding to a particular substituent part is equal to a sum over all of the particular substituent parts in the molecule corresponding to the independent variable of the function of the distance from the reaction center to the particular substituent part.

62. The method of claim 60, wherein the series of molecules comprise analogs of the molecule.

63. The method of claim 62, wherein the series of molecules comprise molecules that have the same reaction center as the molecule.

64. The method of claim 62, wherein the reaction center is a point in space or a substituent part of the molecule and the reaction center is selected by a method comprising
for a first reaction center, performing the multivariable regression analysis and determining a first characteristic of the multivariable regression analysis,
for a second reaction center, performing the multivariable regression analysis and determining a second characteristic of the multivariable regression analysis,
identifying the reaction center as that reaction center with the multivariable regression analysis characteristic satisfying a predetermined criteria.

65. The method of claim 64, wherein the characteristic of the multivariable regression analysis is the global regression coefficient and the predetermined criteria selects for the reaction center with the highest global regression coefficient.

66. The method of claim 64, wherein the characteristic of the multivariable regression analysis is the global standard error and the predetermined criteria selects for the reaction center with the lowest standard error.

67. The method of claim 47, wherein the molecule has one or more measured properties and wherein the characteristic property of the molecule is calculated by summing the contributions from the contributing substituent parts of the molecule plus a contribution comprising a measured property of the molecule multiplied by a weight factor.

68. The method of claim 67, wherein the one or more measured properties of the includes the hydrophobicity of the molecule.

69. The method of claim 67, wherein the measured property weight factor is calculated as a regression coefficient for a multivariate regression analysis calculated for a series of molecules.

70. A system for calculating a characteristic property of a molecule, where the molecule has one or more measured properties and the molecule comprises one or more substituent parts, the system comprising:
a processor; and
a computer readable medium having computer readable program code means embodied therein for causing the system to calculate a biological characteristic property of a molecule, the computer readable program code means comprising: (1) a computer readable program code means for causing a computer to carry out the step of selecting one or more contributing substituent parts; (2) a computer readable program code means for causing a computer to carry out the step of, for each contributing substituent part, calculating the distance from the substituent part to a reaction center; (3) a computer readable program code means for causing a computer to carry out the step of, for each contributing substituent part, calculating a contribution of the substituent part to a characteristic property of the molecule, where the contribution is equal to a function of the distance of the substituent part to the reaction center multiplied by a weight factor for the substituent part, and the where the function has a functional form that is substantially the same for all substituent parts; and (4) a computer readable program code means for causing a computer to carry out the step of calculating the characteristic property of the molecule by summing the contributions from the contributing substituent parts of the molecule plus a contribution comprising a value of a measured property of the molecule multiplied by a weight factor.

71. A system for calculating a characteristic property of a molecule, where the molecule has one or more measured properties and the molecule comprises one or more substituent parts, the system comprising:
a processor; and
a computer readable medium having computer readable program code means embodied therein for causing the system to calculate a biological characteristic property of a molecule, the computer readable program code means comprising: (1) a computer readable program code means for causing a computer to carry out the step of denominating one of the substituent parts as a reaction center; (2) a computer readable program code means for causing a computer to carry out the step of, for each substituent part other than the reaction center, calculating the distance from the substituent part to the reaction center; (3) a computer readable program code means for causing a computer to carry out the step of, for each substituent part other than the reaction center, calculating a contribution of the substituent part to the characteristic property of the molecule, where the contribution is equal to the inverse of the square of the distance of the substituent part to the reaction center multiplied by a weight factor for the substituent part, and where the weight factor is calculated as a regression coefficient for a multivariate regression analysis calculated for a series of molecules comprising analogs of the molecule; (4) a computer readable program code means for causing a computer to carry out the step of, for each measured property, calculating the contribution of the measured property, where the contribution is equal to the value of the measured property multiplied by a weight factor, and where the weight factor is calculated as a regression coefficient for a multivariate regression analysis calculated for a series of molecules comprising analogs of the molecule; and (5) a computer readable program code means for causing a computer to carry out the step of, calculating the property of the molecule by summing the contributions from the contributing substituent parts of the molecule plus the contribution or contributions from the one or more measured properties.

72. A system for calculating a chemical characteristic property of a molecule, where the molecule has a hydrophobicity and the molecule comprises one or more substituent parts and the substituent parts are atoms contained in the molecule or groups of connected atoms contained in the molecule, the system comprising:
a processor; and
a computer readable medium having computer readable program code means embodied therein for causing the system to calculate a biological characteristic property of a molecule, the computer readable program code means comprising: (1) a computer readable program code means for causing a computer to carry out the step of selecting one of the substituent parts as a reaction center; (2) a computer readable program code means for causing a computer to carry out the step of, for each substituent part other than the reaction center, calculating the distance from the substituent part to the reaction center; (3) a computer readable program code means for causing a computer to carry out the step of, for each substituent part other than the reaction center, calculating a contribution of the substituent part to the characteristic property of the molecule, where the contribution is equal to the inverse of the square of the distance of the substituent part to the reaction center multiplied by a weight factor for the substituent part, and where the weight factor is calculated as a regression coefficient for a multivariate regression analysis calculated for a series of molecules comprising analogs of the molecule; (4) a computer readable program code means for causing a computer to carry out the step of calculating the contribution of the hydrophobicity as equal to the value of the hydrophobicity multiplied by a weight factor calculated as a regression coefficient for a multivariate regression analysis calculated for a series of molecules comprising analogs of the molecule; and (5) a computer readable program code means for causing a computer to carry out the step of calculating the characteristic property of the molecule by summing the contributions from the contributing substituent parts of the molecule plus the contribution from the hydrophobicity.

73. A system for calculating a chemical characteristic property of a molecule, where the molecule comprises one or more substituent parts and the chemical characteristic property is selected from the group consisting of pKa, reaction rate constants, equilibrium constants, solubility, ionization potentials, atomization energy, evaporation energy, and bond energy, the system comprising:
a processor; and
a computer readable medium having computer readable program code means embodied therein for causing the system to calculate a biological characteristic property of a molecule, the computer readable program code means comprising: (1) a computer readable program code means for causing a computer to carry out the step of selecting one or more contributing substituent parts; (2) a computer readable program code means for causing a computer to carry out the step of, for each contributing substituent part, calculating a distance from the substituent part to a reaction center; (3) a computer readable program code means for causing a computer to carry out the step of, for each contributing substituent part, calculating the contribution of the substituent part to the characteristic property of the molecule, where the contribution is equal to a function of the distance of the substituent part to the reaction center multiplied by a weight factor for the substituent part and the function has a functional form that is substantially the same for all substituent parts; and (4) a computer readable program code means for causing a computer to carry out the step of calculating the characteristic property of the molecule by summing the contributions from the contributing substituent parts of the molecule.

74. An article of manufacture comprising a computer useable medium having computer readable program code means embodied therein for causing a computer to calculate a characteristic property of a molecule, where the molecule has one or more measured properties and the molecule comprises one or more substituent parts, the computer readable program code means comprising: (1) a computer readable program code means for causing a computer to carry out the step of selecting one or more contributing substituent parts; (2) a computer readable program code means for causing a computer to carry out the step of, for each contributing substituent part, calculating the distance from the substituent part to a reaction center; (3) a computer readable program code means for causing a computer to carry out the step of, for each contributing substituent part, calculating a contribution of the substituent part to a characteristic property of the molecule, where the contribution is equal to a function of the distance of the substituent part to the reaction center multiplied by a weight factor for the substituent part, and the where the function has a functional form that is substantially the same for all substituent parts; and (4) a computer readable program code means for causing a computer to carry out the step of calculating the characteristic property of the molecule by summing the contributions from the contributing substituent parts of the molecule plus a contribution comprising a value of a measured property of the molecule multiplied by a weight factor.

75. An article of manufacture comprising a computer useable medium having computer readable program code means embodied therein for causing a computer to calculate a characteristic property of a molecule, where the molecule has one or more measured properties and the molecule comprises one or more substituent parts, the computer readable program code means comprising: (1) a computer readable program code means for causing a computer to carry out the step of denominating one of the substituent parts as a reaction center; (2) a computer readable program code means for causing a computer to carry out the step of, for each substituent part other than the reaction center, calculating the distance from the substituent part to the reaction center; (3) a computer readable program code means for causing a computer to carry out the step of, for each substituent part other than the reaction center, calculating a contribution of the substituent part to the characteristic property of the molecule, where the contribution is equal to the inverse of the square of the distance of the substituent part to the reaction center multiplied by a weight factor for the substituent part, and where the weight factor is calculated as a regression coefficient for a multivariate regression analysis calculated for a series of molecules comprising analogs of the molecule; (4) a computer readable program code means for causing a computer to carry out the step of, for each measured property, calculating the contribution of the measured property, where the contribution is equal to the value of the measured property multiplied by a weight factor, and where the weight factor is calculated as a regression coefficient for a multivariate regression analysis calculated for a series of molecules comprising analogs of the molecule; and (5) a computer readable program code means for causing a computer to carry out the step of, calculating the property of the molecule by summing the contributions from the contributing substituent parts of the molecule plus the contribution or contributions from the one or more measured properties.

76. An article of manufacture comprising a computer useable medium having computer readable program code means embodied therein for causing a computer to calculate a chemical characteristic property of a molecule, where the molecule has a hydrophobicity and the molecule comprises one or more substituent parts and the substituent parts are atoms contained in the molecule or groups of connected atoms contained in the molecule, the computer readable program code means comprising: (1) a computer readable program code means for causing a computer to carry out the step of selecting one of the substituent parts as a reaction center; (2) a computer readable program code means for causing a computer to carry out the step of, for each substituent part other than the reaction center, calculating the distance from the substituent part to the reaction center; (3) a computer readable program code means for causing a computer to carry out the step of, for each substituent part other than the reaction center, calculating a contribution of the substituent part to the characteristic property of the molecule, where the contribution is equal to the inverse of the square of the distance of the substituent part to the reaction center multiplied by a weight factor for the substituent part, and where the weight factor is calculated as a regression coefficient for a multivariate regression analysis calculated for a series of molecules comprising analogs of the molecule; (4) a computer readable program, code means for causing a computer to carry out the step of calculating the contribution of the hydrophobicity as equal to the value of the hydrophobicity multiplied by a weight factor calculated as a regression coefficient for a multivariate regression analysis calculated for a series of molecules comprising analogs of the molecule; and (5) a computer readable program code means for causing a computer to carry out the step of calculating the characteristic property of the molecule by summing the contributions from the contributing substituent parts of the molecule plus the contribution from the hydrophobicity.

77. An article of manufacture comprising a computer useable medium having computer readable program code means embodied therein for causing a computer to calculate a chemical characteristic property of a molecule, where the molecule comprises one or more substituent parts and the chemical characteristic property is selected from the group consisting of pKa, reaction rate constants, equilibrium constants, solubility, ionization potentials, atomization energy, evaporation energy, and bond energy, the computer readable program code means comprising: (1) a computer readable program code means for causing a computer to carry out the step of selecting one or more contributing substituent parts; (2) a computer readable program code means for causing a computer to carry out the step of, for each contributing substituent part, calculating a distance from the substituent part to a reaction center; (3) a computer readable program code means for causing a computer to carry out the step of, for each contributing substituent part, calculating the contribution of the substituent part to the characteristic property of the molecule, where the contribution is equal to a function of the distance of the substituent part to the reaction center multiplied by a weight factor for the substituent part and the function has a functional form that is substantially the same for all substituent parts; and (4) a computer readable program code means for causing a computer to carry out the step of calculating the characteristic property of the molecule by summing the contributions from the contributing substituent parts of the molecule.

78. A molecule comprising one or more substituent parts chosen to affect a characteristic property of the molecule, where the effect of the one or more substituent parts is calculated by the method according to claim 1.

79. A molecule comprising one or more substituent parts chosen to affect a characteristic property of the molecule, where the effect of the one or more substituent parts is calculated by the method according to claim 27.

80. A molecule comprising one or more substituent parts chosen to affect a characteristic property of the molecule, where the effect of the one or more substituent parts is calculated by the method according to claim 38.

81. A molecule comprising one or more substituent parts chosen to affect a characteristic property of the molecule, where the effect of the one or more substituent parts is calculated by the method according to claim 47.

82. A molecule synthesized after determining a likely characteristic property of the molecule, where the effect of the characteristic property of the molecule is calculated by the method according to claim 1.

83. A molecule synthesized after determining a likely characteristic property of the molecule, where the effect of the characteristic property of the molecule is calculated by the method according to claim 27.

84. A molecule synthesized after determining a likely characteristic property of the molecule, where the effect of the characteristic property of the molecule is calculated by the method according to claim 38.

85. A molecule synthesized after determining a likely characteristic property of the molecule, where the effect of the characteristic property of the molecule is calculated by the method according to claim 47.
